(19) United States
(12) Patent Application Publication
(10) Pub. No.: US 2022/0275926 A1
(43) Pub. Date: Sep. 1, 2022

(54) LASER/PHOSPHOR, LED AND/OR DIFFUSER LIGHT SOURCES WITH LIGHT RECYCLING

(71) Applicant: Optonomous Technologies, Inc., Agoura Hills (US)

(72) Inventor: Kenneth Li, Agoura Hills, CA (US)

(21) Appl. No.: 17/625,265

(22) PCT Filed: Jul. 3, 2020
(86) PCT No.: PCT/US2020/040833

§ 371 Date: Jan. 6, 2022

Related U.S. Application Data
(60) Provisional application No. 62/911,937, filed on Oct. 7, 2019.
(60) Provisional application No. 62/895,367, filed on Sep. 3, 2019.
(60) Provisional application No. 62/881,927, filed on Aug. 1, 2019.
(60) Provisional application No. 62/871,498, filed on Jul. 8, 2019.

(51) Int. Cl. F21V 9/40; F21V 7/00; F21V 7/04; F21V 29/70; F21V 8/00

(52) U.S. Cl. CPC F21V 9/40; F21V 7/00; F21V 7/04; F21V 7/0033; F21V 29/70; G02B 6/0008

(57) ABSTRACT

Apparatus and method using a recycling light source. The source includes: a laser, a phosphor plate and/or diffuser plate that receives laser light and outputs wavelength-converted and/or diffused light, curved reflective surface(s) that collect the output light and reflect the light back to the plate to increase brightness of output light. An optional heatsink and vibrator can be used. Some embodiments include a plurality of parabolic reflectors to image the plate to an output aperture in one of the parabolic reflectors. Some embodiments include a diffuser arranged to diffuse laser light at the diffuser, and a first curved reflector located and configured to reflect diffused light back toward the diffuser in order to preserve a brightness of the laser light. Some embodiments include a laser-excited phosphor light source and method with light recycling.

### CROSS-REFERENCE TO RELATED APPLICATIONS

This application claims priority benefit, including under 35 U.S.C. § 119(e), of
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/911,937 titled “INCREASING THE BRIGHTNESS OF A LIGHT SOURCE BY LIGHT RECYCLING WITH OFFSET FOCUS REFLECTOR,” filed Oct. 7, 2019, by Kenneth Li;
   each of which is incorporated herein by reference in its entirety.

This application is related to:
P.C.T. Patent Application No. PCT/US2020/037669, filed Jun. 14, 2020 by Kenneth Li et al., titled “HYBRID LED/LASER LIGHT SOURCE FOR SMART HEADLIGHT APPLICATIONS,”
U.S. Provisional Patent Application 62/862,549 titled “ENHANCEMENT OF LED INTENSITY PROFILE USING LASER EXCITATION,” filed Jun. 17, 2019, by Kenneth Li;
U.S. Provisional Patent Application 62/874,943 titled “ENHANCEMENT OF LED INTENSITY PROFILE USING LASER EXCITATION,” filed Jul. 16, 2019, by Kenneth Li;
U.S. Provisional Patent Application 62/938,863 titled “DUAL LIGHT SOURCE FOR SMART HEADLIGHT APPLICATIONS,” filed Nov. 21, 2019, by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;
P.C.T. Patent Application No. PCT/US2020/034447, filed May 24, 2020 by Y. P. Chang et al., titled “LiDAR INTEGRATED WITH SMART HEADLIGHT AND METHOD,”
U.S. Provisional Patent Application No. 62/853,538, filed May 28, 2019 by Y. P. Chang et al., titled “LIDAR Integrated With Smart Headlight Using a Single DMD,”
U.S. Provisional Patent Application No. 62/857,662, filed Jun. 5, 2019 by Chun-Nien Liu et al., titled “Scheme of LIDAR-Embedded Smart Laser Headlight for Autonomous Driving,” and
U.S. Provisional Patent Application No. 62/950,080, filed Dec. 18, 2019 by Kenneth Li, titled “Integrated LIDAR and Smart Headlight using a Single MEMS Mirror,”
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);
U.S. patent application Ser. No. 16/509,196 titled “ILLUMINATION SYSTEM WITH HIGH INTENSITY PROJECTION MECHANISM AND METHOD OF OPERATION THEREOF,” filed Jul. 11, 2019, by Y. P. Chang et al. (published Jan. 23, 2020 as US 2020/0026170);
U.S. Provisional Patent Application 62/837,077 titled “LASER EXCITED CRYSTAL PHOSPHOR SPHERE LIGHT SOURCE,” filed Apr. 22, 2019, by Kenneth Li et al.;
U.S. Provisional Patent Application 62/853,538 titled “LIDAR INTEGRATED WITH SMART HEADLIGHT USING A SINGLE DMD,” filed May 28, 2019, by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/903,620 titled “RGB LASER LIGHT SOURCE FOR PROJECTION DISPLAYS,” filed Sep. 20, 2019, by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS”;
   each of which is incorporated herein by reference in its entirety.

### FIELD OF THE INVENTION

This invention relates to the field of light sources, and more specifically to a method and light source that includes lasers, laser-pumped phosphor light sources, LED-pumped phosphor light sources, and/or diffusers, along with optics to recycle light combined together to provide improved light-beam quality, higher beam intensity, and reduced speckle, and a method and apparatus to increase brightness of diffused light with focused recycling (some embodiments of which include light recycling with an offset-focus reflector that is particularly useful for high-power light applications).

### BACKGROUND OF THE INVENTION

Laser-pumped phosphor light sources provide higher luminance compared to light-emitting-diode (LED) light sources, and are important for applications such as projectors or spotlights. The fact that phosphor emissions are Lambertian in nature makes efficient collection and coupling very challenging.

Light diffusers are sometimes used with laser light sources, and also can output diffused light that is Lambertian in nature, similarly making efficient collection and coupling very challenging.

U.S. Pat. No. 5,907,436 entitled “Multilayer dielectric diffraction gratings” issued May 25, 1999 to Perry et al., and is incorporated herein by reference. U.S. Pat. No. 5,907,436 describes the design and fabrication of dielectric grating structures with high diffraction efficiency. The gratings have a multilayer structure of alternating index dielectric materials, with a grating structure formed on top of the multilayer, and obtain a diffraction grating of adjustable efficiency, and variable optical bandwidth.

U.S. Pat. No. 5,454,004 issued to Leger on Sep. 26, 1995 with the title “Phase grating and mode-selecting mirror for a laser”, and is incorporated herein by reference. U.S. Pat. No. 5,454,004 describes a method for making a custom phase-conjugating diffractive mirror for a laser resonator comprising the steps of: (a) choosing a specified beam mode profile ai (x,y) that will suit need of said designer, (b) calculating the mode profile b(x′,y′) which is a value of the specified ai (x,y) that is propagated to the reflection surface of the diffractive mirror and (c) calculating mirror reflectance t(x′,y′) which reflects phase conjugate of b(x′,y′). A method for fabricating such a mirror is shown. Another aspect of U.S. Pat. No. 5,454,004 is the addition of a phase-adjusting element having a random Cartesian pattern for the phase-adjustment element into a laser resonator, and compensating for the addition of a phase-adjusting element in the design of other phase-adjusting elements such as the mirrors.

U.S. Pat. No. 6,709,119 issued to Gillich et al. on Mar. 23, 2004 with the title “Resistant surface reflector”, and is incorporated herein by reference. U.S. Pat. No. 6,709,119 describes a reflector with high total reflection which is resistant to mechanical stresses. The reflector includes a reflector body and superimposed thereon (a) a functional coating such as a varnish, (b) a reflecting layer structure composed of a reflecting metallic layer and optionally arranged thereon one or several transparent ceramic layers, for example, layers having an optical depth of λ/2. The reflecting layer structure contains, as its surface layer, a protective layer. The protective layer is a silicon oxide of general formula SiOₓ, wherein x is a number from 1.1 to 2.0, or it is aluminum oxide of formula Al₂O₃, in a thickness of 3 nm or more. The protective layer protects the underlying layers from mechanical damages. In the DIN 58196 abrasion test the protected surface does not show any damages after 50 test cycles with 100 abrasion strokes.

U.S. Pat. No. 8,979,308 issued to Li on Mar. 17, 2015 with the title “LED illumination system with recycled light”, and is incorporated herein by reference. U.S. Pat. No. 8,979,308 describes an LED illumination system includes at least one LED element and a recycling reflector having a transmissive aperture through which emitted light passes. The recycling reflector has a curved surface adapted to reflect the impinging light back to the LED element for improved light output through the transmissive aperture.

U.S. Pat. No. 8,858,037 issued to Li on Oct. 14, 2014 with the title “Light emitting diode array illumination system with recycling”, and is incorporated herein by reference. U.S. Pat. No. 8,858,037 describes an LED illumination system includes a plurality of LED modules and a plurality of corresponding collimating lenses to provide increased brightness. Each LED module has at least one LED chip having a light emitting area that emits light and a recycling reflector. The reflector is positioned to reflect the light from the light emitting area back to the LED chip and has a transmissive aperture through which the emitted light exits. The collimating lenses are arranged to receive and collimate the light exiting from the LED modules.

U.S. Pat. No. 8,602,567 issued to Ouyang et al. on Dec. 10, 2013 with the title “Multiplexing light pipe having enhanced brightness”, and is incorporated herein by reference. U.S. Pat. No. 8,602,567 describes multi-color light sources mixed in a recycling housing to achieve high light output. Light from each color light source is multiplexed and a portion of the mixed light passes through an output aperture in the light pipe and a portion light is recycled back, for example, by a shaped reflective surface and/or a reflective coating adjacent the aperture. In one embodiment, the light is directed back from the output side of the housing to an input light source having the same color. In another embodiment, the light is directed back from the output side of the housing to a coating designed to reflect that color. The reflected light is then reflected back toward the output aperture and a portion of that reflected light is again reflected toward the input and impacts the original source for that color light. In this way, light theoretically recycles infinitely.

U.S. Pat. No. 8,388,190 issued to Li, et al. on Mar. 5, 2013 with the title “Illumination system and method for recycling light to increase the brightness of the light source”, and is incorporated herein by reference. U.S. Pat. No. 8,388,190 describes an illumination system for increasing the brightness of a light source that includes an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 8,317,331 issued to Li on Nov. 27, 2012 with the title “Recycling system and method for increasing brightness using light pipes with one or more light sources, and a projector incorporating the same”, and is incorporated herein by reference. U.S. Pat. No. 8,317,331 describes a recycling system and method for increasing the brightness of light output using at least one recycling light pipe with at least one light source the output end of the recycling light pipe reflects a first portion of the light back to the light source, a second portion the light to the input end of the recycling light pipe, and transmits the remaining portion of the light as output. The recycling system is incorporated into a projector to provide color projected image with increased brightness. The light source can be white LEDs, color LEDs, and dual paraboloid reflector (DPR) lamp.

U.S. Pat. No. 7,976,204 issued to Li et al. Jul. 12, 2011 with the title “Illumination system and method for recycling light to increase the brightness of the light source”, and is incorporated herein by reference. U.S. Pat. No. 7,976,204 describes an illumination system for increasing the brightness of a light source comprises an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 7,710,669 issued to Li on May 4, 2010 with the title “Etendue efficient combination of multiple light sources”, and is incorporated herein by reference. U.S. Pat. No. 7,710,669 describes a multi-colored illumination system including a beam combiner. The beam combiner includes two triangular prisms and a filter for transmitting a first light and reflecting a second light, each light having a different wavelength. The beam combiner combines the transmitted first light and the reflected light to provide a combined beam. The six surfaces of each of the triangular prism of the beam combiner are polished, thereby combining the lights without increasing etendue of the multi-colored illumination system.

U.S. Pat. No. 7,232,228 issued to Li on Jun. 19, 2007 with the title “Light recovery for projection displays”, and is incorporated herein by reference. U.S. Pat. No. 7,232,228 describes a light-recovery system for a projection display with a reflector having a first and a second focal points. A source of electro-magnetic radiation is disposed proximate to the first focal point of the reflector to emit rays of radiation that reflect from the reflector and converge substantially at the second focal point. A retro-reflector reflects at least a portion of the electromagnetic radiation that does not impinge directly on the reflector toward the reflector through the first focal point of the reflector to increase the flux intensity of the converging rays. A light pipe with an input surface and an output surface is disposed with the input surface proximate to the second focal point to collect and transmit substantially all of the radiation. A PBS is disposed proximate to the output surface to collect and polarize substantially all of the radiation into a radiation of a first polarization and a second polarization. Radiation of the first polarization is transmitted, while radiation of the second polarization is reflected toward the output surface. A wave plate is disposed in a path of the radiation of the second polarization.

U.S. Pat. No. 4,520,116 issued to Gentilman et al. on May 28, 1985 with the title “Transparent aluminum oxynitride and method of manufacture”, and is incorporated herein by reference. U.S. Pat. No. 4,520,116 describes a polycrystalline cubic aluminum oxynitride having a density of at least 98% of theoretical density, and being transparent to electromagnetic radiation in the wavelength range from 0.3 to 5 micrometers with an in-line transmission of at least 20% in this range. A method of preparing the optically transparent aluminum oxynitride is also provided including the steps of forming a green body of substantially homogeneous aluminum oxynitride powder and pressureless sintering said green body in a nitrogen atmosphere and in the presence of predetermined additives which enhance the sintering process. Preferred additives are boron and yttrium in elemental or compound form.

U.S. Pat. No. 4,686,070 issued to Maguire, et al. on Aug. 11, 1987 with the title “Method of producing aluminum oxynitride having improved optical characteristics”, and is incorporated herein by reference. U.S. Pat. No. 4,686,070 describes a method of preparing substantially homogeneous aluminum oxynitride powder that includes the steps of reacting gamma aluminum oxide with carbon in the presence of nitrogen, and breaking down the resulting powder into particles in a predetermined size range. A method of preparing a durable optically transparent body from this powder is also provided that includes the steps of forming a green body of substantially homogeneous cubic aluminum oxynitride powder and sintering said green body in a nitrogen atmosphere and in the presence of predetermined additives which enhance the sintering process. Preferred additives are boron, in elemental or compound form, and at least one additional element selected from the group of yttrium and lanthanum or compounds thereof. The sintered polycrystalline cubic aluminum oxynitride has a density greater than 99% of theoretical density, an in-line transmission of at least 50% in the 0.3- to 5-micron range, and a resolving angle of 1 mrad or less.

The Wikipedia internet website's entry for “speckle pattern” includes the following: “A speckle pattern is produced by the mutual interference of a set of coherent wavefronts. . . . Speckle patterns typically occur in diffuse reflections of monochromatic light such as laser light. Such reflections may occur on materials such as paper, white paint, rough surfaces, or in media with a large number of scattering particles in space, such as airborne dust or in cloudy liquids.” There remains a need in the art for methods and apparatus using lasers and laser-pumped phosphor light sources with recycled light combined together to provide improved intensity and reduced speckle.

### SUMMARY OF THE INVENTION

The present invention provides a method and apparatus for increasing brightness of diffused light along with reduction of speckling from laser light for high-power lighting applications. In some embodiments, the apparatus includes a diffuser system for use with laser light source and method. Some embodiments include a diffuser arranged to receive and diffuse laser light at a first location on the diffuser; and a first curved reflector located and configured to redirect at least some of the diffused laser light back toward the first location in order to preserve a brightness of the diffused laser light. Some embodiments further include a heatsink connected to the diffuser(s), laser(s), phosphor(s) and/or LED(s), and configured to spread and dissipate heat from the laser light at the first location. In some embodiments, the diffuser is a transmissive diffuser. In some embodiments, the diffuser is a reflective diffuser. In some embodiments, the diffuser includes a reflective diffuser. In some embodiments, the diffuser includes a phosphor that absorbs pump light from a laser and/or LED and emits emissive light having longer wavelengths than the wavelength(s) of the pump light. In some embodiments, the first curved reflector is a parabolic reflector.

In some embodiments, the present invention provides lasers and laser-pumped phosphor light sources with recycled light combined together to provide improved intensity and/or brightness and reduced speckle for high-power lighting applications.

Apparatus and method using a recycling light source. The recycling light source includes: one or more lasers that generate one or more laser beams, a phosphor plate and/or a diffuser plate that receive the one or more laser beams and emit wavelength-converted light and/or diffused light, one or more curved reflective surfaces that collect the wavelength-converted light and/or diffused light and reflect the collected light back to the phosphor plate and/or diffuser plate to increase brightness of output light. Some embodiments mount the phosphor plate and/or diffuser plate on a heatsink and optionally vibrate one or more of these structures. Some embodiments include a plurality of parabolic reflectors to image the phosphor plate and/or diffuser plate to an output aperture in one of the parabolic reflectors.

A diffuser system for use with laser light source and method. Some embodiments include a diffuser arranged to receive and diffuse laser light at a first location on the diffuser; and a first curved reflector located and configured to reflect at least some of the diffused laser back toward the first location in order to increase a brightness of the diffused laser light. Some embodiments further include a heatsink connected to the diffuser and configured to spread and dissipate heat from the laser light at the first location. In some embodiments, the diffuser is a transmissive diffuser. In some embodiments, the diffuser is a reflective diffuser. In some embodiments, the first curved reflector is a parabolic reflector. In some embodiments, the diffuser is a reflective diffuser. Some embodiments include a laser-excited phosphor light source and method with light recycling.

### BRIEF DESCRIPTION OF THE DRAWINGS

FIG. 1A is a side-view cross-sectional block diagram of a light-recycling light source 101 that uses a plurality of lasers 121 (e.g., in some embodiments, eight) and outputs it light through an aperture in a parabolic reflector, according to some embodiments of the present invention.

FIG. 1B is a bottom-view block diagram of light source 101, according to some embodiments of the present invention.

FIG. 1C is a top-view block diagram of heatsinked laser and phosphor assembly 110, according to some embodiments of the present invention.

FIG. 1D is a top-view block diagram of light source 101, according to some embodiments of the present invention.

FIG. 1E is a bottom-view block diagram of an alternative light-recycling light source 105 that uses sixteen lasers 121, according to some embodiments of the present invention.

FIG. 1F is a side-view cross-sectional block diagram of a light-recycling light source 106 that uses a plurality of lasers 121 (e.g., eight) and a blue-wavelength-transmissive and other-wavelengths-reflective planar reflector 167, according to some embodiments of the present invention.

FIG. 1G is a side-view cross-sectional block diagram of a light-recycling light source 107 that uses a plurality of lasers 121 (e.g., eight) and outputs its light into an optical waveguide 138, according to some embodiments of the present invention.

FIG. 2A is a side-view cross-sectional block diagram of a light source 201 that uses four lasers 121 according to some embodiments of the present invention.

FIG. 2B is a bottom-view block diagram of light source 201 according to some embodiments of the present invention.

FIG. 2C is a top-view block diagram of heatsinked laser and phosphor assembly 210, according to some embodiments of the present invention.

FIG. 2D is a top-view block diagram of light source 201, according to some embodiments of the present invention.

FIG. 3A is a side-view cross-sectional block diagram of a transmissive-reflective diffuser system 301 with a diffuser plate 312 that receives a laser beam 141, according to some embodiments of the present invention.

FIG. 3B is a side-view cross-sectional block diagram of a transmissive-reflective diffuser system 302 with a plurality of diffuser plates 312.1 . . . 312.2 that receive a laser beam 141, according to some embodiments of the present invention.

FIG. 4A is a side-view cross-sectional block diagram of a recycling transmissive-reflective diffuser assembly 401 with a diffuser plate 412, and a back-side dome-shaped (spherical) light-recycling reflector 416, according to some embodiments of the present invention.

FIG. 4B is a side-view cross-sectional block diagram of a recycling transmissive-reflective diffuser assembly 402 with a diffuser plate 412, and a back-side orthogonal-parabolic light-recycling reflector 426, according to some embodiments of the present invention.

FIG. 4C is a side-view cross-sectional block diagram of a recycling transmissive-reflective diffuser assembly 403 with a diffuser plate 412, a back-side dome-shaped (spherical) light-recycling reflector 416, and a front-side dome-shaped (spherical) light-recycling reflector 436, according to some embodiments of the present invention.

FIG. 4D is a side-view cross-sectional block diagram of a recycling transmissive-reflective diffuser assembly 404 with a diffuser plate 412 and a back-side orthogonal-parabolic light-recycling reflector 426, and a front-side orthogonal-parabolic light-recycling reflector 436, according to some embodiments of the present invention.

FIG. 5A is a side-view cross-sectional block diagram of a reflective diffuser system 501 having a reflective diffuser 514, according to some embodiments of the present invention.

FIG. 5B is a side-view cross-sectional block diagram of a reflective diffuser system 502 having a reflective diffuser 514 on a substrate 541, according to some embodiments of the present invention.

FIG. 5C1 is a side-view cross-sectional block diagram of a reflective diffuser system 503 having a reflective diffuser 514 on a heatsink substrate 511 and a spherical dome reflector 516, according to some embodiments of the present invention.

FIG. 5C2 is a side-view cross-sectional block diagram of a reflective diffuser system 503′ having a reflective diffuser 514 on a heatsink substrate 511 and a spherical dome reflector 516 with laser beam 141 impinging off center, according to some embodiments of the present invention.

FIG. 5D1 is a side-view cross-sectional block diagram of a reflective diffuser system 504 having a reflective diffuser 514 on a heatsink substrate 511 and an orthogonal-parabolic reflector 517, according to some embodiments of the present invention.

FIG. 5D2 is a side-view cross-sectional block diagram of a reflective diffuser system 504′ having a reflective diffuser 514 on a heatsink 511, one or more lasers 121 mounted to heatsink 511 to emit laser beams 141 through holes 525 in the heatsink 511, and an orthogonal parabolic recycling reflector 517 that reflects high-angle light 546 horizontally across as light 547 to the opposite side and reflects that as light 546 back to the focus location 549 on the diffuser 514 to complete light recycling, according to some embodiments of the present invention.

FIG. 5E is a side-view cross-sectional block diagram of a reflective diffuser system 505 having a reflective diffuser 514 on a heatsink substrate 511, a spherical dome reflector 516, and a small mirror 551 to direct the input beam 141 to the focus location 539 on the diffuser 514, according to some embodiments of the present invention.

FIG. 5F is a side-view cross-sectional block diagram of a reflective diffuser system 506 having a reflective diffuser 514 on a heatsink substrate 511, an orthogonal-parabolic reflector 517, and a small mirror 551 to direct the input beam 141 to the focus location 549 on the diffuser 514, according to some embodiments of the present invention.

FIG. 6A is a side-view cross-sectional block diagram of a reflective diffuser system 601 having a reflective diffuser 614 on a heatsink substrate 611, a parabolic reflector 616, a planar reflector 617 on the heatsink substrate 611 to reflect the initially diffused input light 652 back to the parabolic reflector 616, which the reflects that light 652 back to the focus location 609 on the diffuser 614, according to some embodiments of the present invention.

FIG. 6B is a side-view cross-sectional block diagram of a reflective diffuser system 602 having a reflective diffuser 614 on a heatsink substrate 611, a parabolic reflector 616, a planar reflector 617 on the heatsink substrate 611 to reflect the initially diffused input light 652 back to the parabolic reflector 616, which the reflects that light back to the focus location 609 on the diffuser, and one or more lasers 121 mounted to the heatsink substrate 611 to emit laser beams 141 through holes 625 in the substrate 611, according to some embodiments of the present invention.

FIG. 6C is a side-view cross-sectional block diagram of a reflective diffuser system 603 having a reflective diffuser 614 on a heatsink substrate 611, diffuser 614 being surrounded by a bottom-side secondary parabolic reflector 634, a top-side primary parabolic reflector 631, a planar reflector 617 on the heatsink substrate 611 to reflect the initially diffused input light 653 back to the top parabolic reflector 631, which the reflects that light 653 back to the focus location 609 on the diffuser, one or more lasers mounted to the heatsink substrate to emit light through holes 625 in the substrate 611, and an optional light guide 658 at the output aperture 632 through the parabolic reflector 631, according to some embodiments of the present invention.

FIG. 6D is a bottom-view block diagram of reflective diffuser system 603 having a heatsink substrate 611, one or more lasers 121 mounted to the heatsink substrate 611 to emit their respective laser beams 141 through holes 625 (see FIG. 6C) in the substrate 611, according to some embodiments of the present invention.

FIG. 7A is a block diagram of a system 701 having one or more lasers 121, one or more light-recycling diffuser systems 740 (each including one or more light-recycling diffuser system such as systems 301, 401, 402, 403, 404, 501, 502, 503, 503′, 504, 505, 506, 601, 602, or 603 of FIG. 3, 4A, 4B, 4C, 4D, 5A, 5B, 5C1, 5C2, 5D, 5E, 5F, 6A, 6B, or 6C respectively), one or more modulator and/or projection optics systems 750, one or more controllers 791, and/or a vehicle- or land-based system 798 onto which the other components are mounted, according to some embodiments of the present invention.

FIG. 7B is a block diagram of a system 702 having one or more lasers 121, one or more light-recycling phosphor and/or diffuser systems 760 (each including one or more light-recycling phosphor systems such as systems 101, 106, 107, or 201 of FIG. 1A, 1F, 1G, or 2A, respectively, and/or one or more light-recycling laser-phosphor, LED and/or diffuser systems such as systems 901, 902, 903, 904, 905, 906, 907, 908, 1001, 1002, 1101, 1102, or 1103 of FIG. 9A, 9B, 9C, 9D, 9E, 9F, 9G, 10A, 10B, 11A, 11B or 11C, respectively), one or more modulator and/or projection optics systems 770, one or more controllers 792, and/or a vehicle- or land-based system 799 onto which the other components are mounted, according to some embodiments of the present invention.

FIG. 8A is a block diagram of a reflective multi-layer dielectric diffuser system 801 having a lithographically-defined dielectric diffuser layer 810 formed on a dielectric-layer stack 820 operatively coupled to a heatsink 830, according to some embodiments of the present invention.

FIG. 8B is a block diagram of a reflective multi-layer dielectric diffuser system 802 having a ceramic diffuser layer 811 formed on a dielectric-layer stack 820 operatively coupled to a heatsink 830, according to some embodiments of the present invention.

FIG. 9A is a side-view cross-sectional block diagram of a system 901 having a compound recycling reflector 910 that includes a parabolic reflector 916 and a conical reflector 915 sharing the same optical axis 944 such that light is focused toward a central phosphor and/or diffuser plate 914, according to some embodiments of the present invention.

FIG. 9B is a side-view cross-sectional block diagram of a system 902 having a compound recycling reflector 910 that includes a parabolic reflector 916 and a conical reflector 915 along the same optical axis 944, also including a heatsink 911 with one or more laser diodes 121 that each emit a respective laser beam 141 through openings 925 in the heatsink 911 and through openings 919 in the conical reflector 915 to impinge on the parabolic reflector 916, reflecting toward a central phosphor plate, LED, and/or diffuser plate 914, according to some embodiments of the present invention.

FIG. 9C is a side-view cross-sectional block diagram of a system 903 having a compound recycling reflector 910 that includes a parabolic reflector 916 and a conical reflector 915 along the same optical axis 944, also including a heatsink 911 with one or more laser diodes 121 that emit a respective laser beam 141 through openings 925 in the heatsink 911 and through openings 919 in the conical reflector 915 to impinge on the parabolic reflector 916, reflecting toward a central phosphor plate, LED, and/or diffuser plate 914, and having an intermediate output 953 from projection lens 933 directed toward a scanning mirror 954 that scans in a one-dimensional (1D) or two-dimensional (2D) pattern 955 that forms a scanning output beam 956, according to some embodiments of the present invention.

FIG. 9D is a side-view cross-sectional block diagram of a system 904 having a scanning laser source 921 (such as system 903 shown in FIG. 9C or the like) that scans the scanning laser light 951 toward a phosphor plate, LED, and/or diffuser plate 914, and then the diffused light 949 from phosphor plate, LED, and/or diffuser plate 914 is shaped through a projection lens 933 to form projected light 948, according to some embodiments of the present invention.

FIG. 9E is a side-view cross-sectional block diagram of a system 905 having a scanning laser source 921 (such as system 903 shown in FIG. 9C or the like) that scans the scanning laser light 951 toward a central phosphor plate, LED, and/or diffuser plate 914 through an opening in a compound recycling reflector 910 (including a parabolic reflector 916 and a conical reflector 915 along the same optical axis) such that light 951 is scanned toward central phosphor plate, LED, and/or diffuser plate 914, and then the diffused light from plate 914 is shaped through projection lens 933, according to some embodiments of the present invention.

FIG. 9F is a side-view cross-sectional block diagram of a system 906 having an orthogonal parabolic recycling reflector 967 and a light source 921 with one or more laser beams 951 of one or more colors propagating through one or more openings 935 in the orthogonal parabolic recycling reflector 967, wherein the recycling light 966 goes through two reflections, which is an even number of reflections, producing an upright image, so as to allow the recycled spot(s) to coincide with the respective original stationary or scanned spot(s), producing a scanning beam 968, according to some embodiments of the present invention.

FIG. 9G is a side-view cross-sectional block diagram of a system 907 having an orthogonal parabolic recycling reflector 967 and one or more laser beams 141 of one or more colors propagating through one or more openings 935 in the orthogonal parabolic recycling reflector 967, wherein the recycling light goes through two reflections, wherein the system 907 also includes a projection lens 933 and a scanning mirror 954 to produce a scanning output beam 956, according to some embodiments of the present invention.

FIG. 9H is a side-view cross-sectional block diagram of a system 908 having a parabolic reflector 916 and a heatsink 911 with one or more laser diodes 121 that emit laser beams 141 through openings 925 in heatsink 911 to impinge on the parabolic reflector 916, reflecting toward a phosphor, LED and/or diffuser plate 914, the heatsink 911 having a planar reflector 917 that directs recycled light 952 from the central phosphor, LED and/or diffuser plate 914 back toward plate 914, the system 908 having an intermediate output beam 953 that has been formed by a projection lens 933 and directed toward a scanning mirror 954 that forms a scanning output beam 956, according to some embodiments of the present invention.

FIG. 10A is a side-view cross-sectional block diagram of a system 1001 having a dome (spherical) recycling reflector 1016 (optionally having a vibration mechanism), a heatsink 911 with a phosphor, LED and/or diffuser plate 914 mounted to heatsink 911 (optionally having a vibration mechanism 1021), and source(s) of one or more laser beams 141 coming through one or more openings 1015 in dome recycling reflector 1016 to impinge on the phosphor, LED and/or diffuser plate 914, the light from phosphor, LED and/or diffuser plate 914 reflecting off the dome recycling reflector 1016 toward phosphor, LED and/or diffuser plate 914, wherein system 1001 has an intermediate output 1053 from projection lens 1033 directed toward a scanning mirror 1054 that scans in a one-dimensional (1D) or two-dimensional (2D) pattern 1055 that forms a scanning output beam 1056, according to some embodiments of the present invention.

FIG. 10B is a side-view cross-sectional block diagram of a system 1002 having a compound recycling reflector 1010 that includes a first parabolic reflector 1035 and a conical reflector 1036 and a further second parabolic reflector 1034 on a heatsink 911, all centered along the same optical axis 1044, also including one or more laser diodes 121 that emit collimated laser light 141 through openings in the heatsink 1011 and through openings in the conical reflector 1036 to impinge on first parabolic reflector 1035, reflecting toward a central phosphor, LED and/or diffuser plate 914 surrounded by the second parabolic reflector 1034, that receives low-angle light collimated from first parabolic reflector 1035 and focuses an intermediate focused output light 1053 directed through the first parabolic reflector 1035 toward a light guide 1038, according to some embodiments of the present invention.

FIG. 11A is a side-view cross-sectional block diagram of a system 1101 having a compound recycling reflector 1110 (having a parabolic reflector 1116 and a planar reflector 1117), a phosphor, LED and/or diffuser plate 914 on a heatsink 1111 with optional vibration 1121 (not shown), according to some embodiments of the present invention.

FIG. 11B is a side-view cross-sectional block diagram of a system 1102 having a compound recycling reflector 1110 (having a parabolic reflector 1116 and a planar reflector 1117), a phosphor, LED and/or diffuser plate 914 on a heatsink 1111 with optional vibration 1121, and one or more lasers 121 that emit laser beams 141 through openings 1118 in planar reflector 1117, according to some embodiments of the present invention.

FIG. 11C is a side-view cross-sectional block diagram of a system 1103 having a compound recycling reflector 1130 (having a spherical (dome) reflector 1136 and a planar reflector 1137), a phosphor, LED and/or diffuser plate 914 on a heatsink 1111 with optional vibration 1121, and one or more lasers 121 that emit laser beams 141 through openings 1118 in planar reflector 1137 or dome reflector 1136, according to some embodiments of the present invention.

FIG. 12A is a cross-sectional elevation-view block diagram of a light source 1201, according to some embodiments of the present invention. In some embodiments, light source 1201 includes a spherical, toroidal, or elliptical concave reflector 1210, an LED 1214, and a planar specular reflector 1212 (such as a flat mirror coated with metal or multi-layer dielectric coating of the proper wavelengths under consideration or to be emphasized).

FIG. 12B is a cross-sectional top-view block diagram of light source 1201 (which is shown in a cross-section side view in FIG. 12A), according to some embodiments of the present invention. In some embodiments, the high-angle portion of the light output of LED 1214 is reflected by the spherical concave reflector 1210 and imaged onto specular reflector 1212. LED 1214 and specular reflector 1212 are placed symmetrically on opposite sides of the center of curvature of spherical concave reflector 1210.

FIG. 12C is a cross-sectional elevation-view block diagram of a light source 1203, according to some embodiments of the present invention, where the LED 1214 of light source 1201 is replaced by a laser-excited phosphor plate 1216, such that when the phosphor in phosphor plate 1216 is excited by laser beam 114 from laser 121, light of one or more longer wavelengths will be emitted from the phosphor in phosphor plate 1216. In some embodiments, emitted and diffused light from phosphor plate 1216 appears to the human eye to be very similar to the output of the LED 1214, although the laser pump light 114 diffused from phosphor plate 1216 has a much narrower linewidth that pump light from a blue LED such as in system 1201.

FIG. 12D is a cross-sectional elevation-view block diagram of a light source 1204, according to some embodiments of the present invention, wherein one or more excitation lasers 121 is/are placed on, in, and/or under heatsink 1211 with an opening for each laser 121 in heatsink 1211 through which the laser beam(s) from the laser(s) propagates such that the laser beams reflect from the dome 1210 or other laser reflector on or under the dome towards one or more phosphor structures and/or diffusive structures 1216.

FIG. 12E is a cross-sectional elevation-view block diagram of a light source 1205, according to some embodiments of the present invention.

FIG. 12F is a cross-sectional elevation-view block diagram of a light source 1206 having a plurality of phosphor structures 1213 . . . 1214, each emitting light of a different selected color when pumped by a suitable laser beam 114, according to some embodiments of the present invention.

FIG. 13A is a cross-sectional top-view block diagram of a light source 1301, according to some embodiments of the present invention, with the specular reflector 1313 made larger than the image 1312 of the LED.

FIG. 13B is a top-view diagram of a four-color LED assembly 1324 that includes a red-light-emitting LED 1325, a green-light-emitting LED 1326, a blue-light-emitting LED 1327 and a white-light-emitting LED 1328, according to some embodiments of the present invention.

FIG. 14A is a cross-sectional top-view block diagram of a light source 1401, according to some embodiments of the present invention, where a set of red, green, and blue (RGB) LEDs 1412, 1413, and 1414, respectively, each individually packaged, are used.

FIG. 14B is a cross-sectional side-view block diagram of light source 1401, according to some embodiments of the present invention, where the outputs 1431, 1432, and 1433, of the RGB LEDs 1412, 1413, and 1414, respectively, exiting the apertures 1428 above the LEDs are collimated using three individual collimating lenses 1438 outside the spherical concave reflector 1410, providing three colored beams of light with increased brightness due to light recycling by internal reflections in spherical concave reflector 1410.

FIG. 14C is a cross-sectional top-view block diagram of a light source 1403, according to some embodiments of the present invention, in which the three RGB LEDs 1442, 1443, and 1444, respectively are placed triangularly (in some embodiments, each LED at the same distance from the center of curvature 1441 of the spherical dome reflector 1410), with the specular reflectors 1440 placed symmetrically opposite to the respective LEDs (in some embodiments, each specular reflector 1440 is located at the same distance from the center of curvature 1441 of the spherical dome reflector 1410).

FIG. 15A is a cross-sectional top-view block diagram of a light source 1501, according to some embodiments of the present invention, where the colored beams are combined into a single beam 1556 (going toward the right in FIG. 15A) using an X-Cube 1521.

FIG. 15B is a cross-sectional side-view block diagram of light source 1501, according to some embodiments of the present invention, in which the three beams exiting the spherical concave reflector 1510 through the apertures are collimated, reflected by their respective 45-degree mirrors 1544, 1545, and 1546, enter the X-Cube, and exit as a combined single beam 1556 (coming toward the viewer in FIG. 15B).

FIG. 16A is a cross-sectional side-view block diagram of a light source 1601, according to some embodiments of the present invention, where the spherical concave reflector (e.g., reflector 1210 of FIG. 12A) is replaced by a parabolic reflector 1616 and large specular reflector 1617.

FIG. 16B is a cross-sectional side-view block diagram of a light source 1602, according to some embodiments of the present invention, where the spherical concave reflector (e.g., reflector 1210 of FIG. 12A) is replaced by a parabolic reflector 1616 and large specular reflector 1617, and where the LED (e.g., LED 1214 of FIG. 12A) is replaced by a laser-excited phosphor plate 1624, with the excitation laser 121 placed under the specular reflector 1617 and heatsink 1611.

FIG. 17 is a block diagram of a vehicle 1701 that includes a LED/laser-pumped-phosphor light source 1711, according to some embodiments of the present invention.

FIG. 18A is a side-cross-sectional-view block diagram of an LED/laser-pumped-phosphor light source assembly 1801. In some embodiments, LED/laser-pumped-phosphor light source assembly 1801 is substituted in place of any of the LEDs, diffusers, phosphor plates, or diffuser (PLD) structures described herein.

FIG. 18B is a plan-view block diagram of LED/laser-pumped-phosphor light source assembly 1801, according to some embodiments.

### DETAILED DESCRIPTION OF PREFERRED EMBODIMENTS OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

Laser-pumped phosphor light sources provide higher luminance compared to LED light sources and are important for applications such as projectors or spotlights. The fact that laser-pumped phosphor emissions are Lambertian in nature, makes efficient collection and coupling of the emitted light very challenging. At the same time, the easiest way to use a laser-phosphor system is to use the transmissive mode, in which the laser beam enters from one side of a phosphor plate and emission exits the opposite side. The optical configuration for such transmissive mode is simple. One major disadvantage of this mode is the difficulty in providing efficient heatsinking of the phosphor plate, which cannot be mounted on an opaque heatsink.

On the other hand, a reflective-mode laser-phosphor system allows more efficient heatsinking of the phosphor plate, as the phosphor plate can be mounted directly on a reflective face of an opaque heatsink. One major disadvantage of a reflective-mode laser-phosphor system is that a more complicated optical system has to be used because light from the pump laser source enters, and the emission light leaves, through the same face of the phosphor plate. In some embodiments, the present invention provides a laser-pumped phosphor system in which the phosphor plate is mounted on a heatsink and used in a reflective mode. In some embodiments, low-angle laser-pumped phosphor-emission light (light at small angles to the central-axis normal (right-angle) vector of the face of the phosphor plate) is output directly. In addition, high-angle light (light at large angles to the central-axis normal vector of the phosphor plate's face) emitted from the phosphor plate is recycled back to the phosphor plate for added brightness. The total light, including the light initially emitted at low angles, plus the recycled light that, once it is recycled, leaves at low angles, can be coupled efficiently using standard optics such as lenses and reflectors.

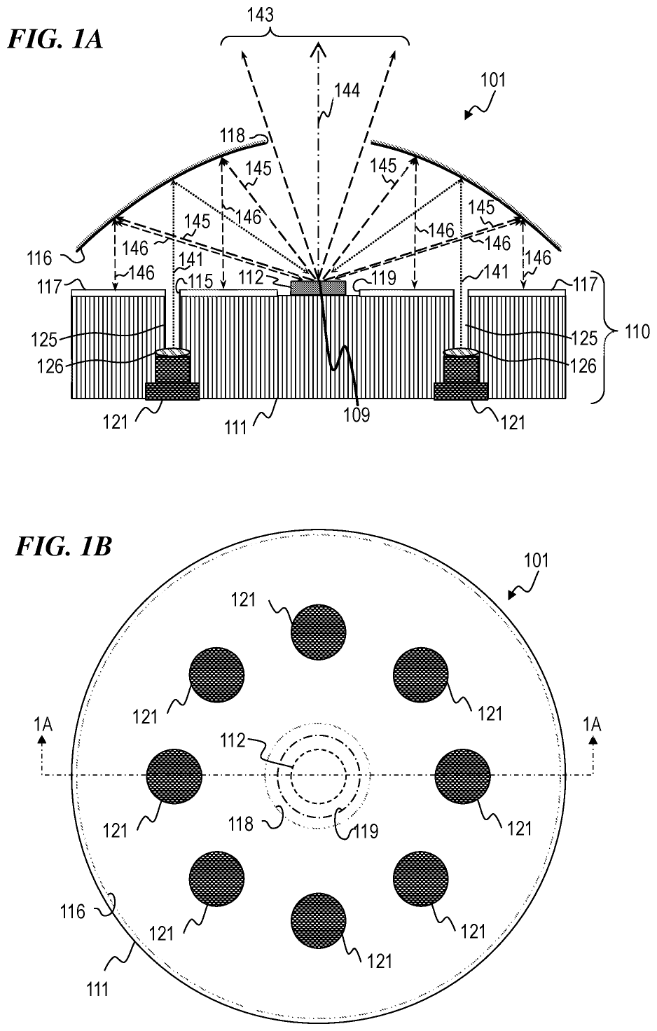

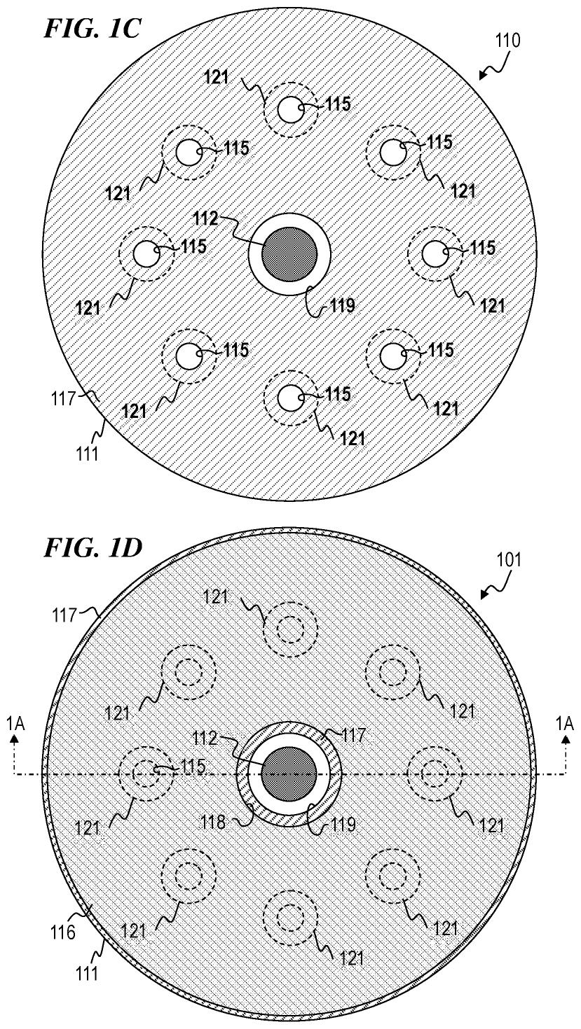

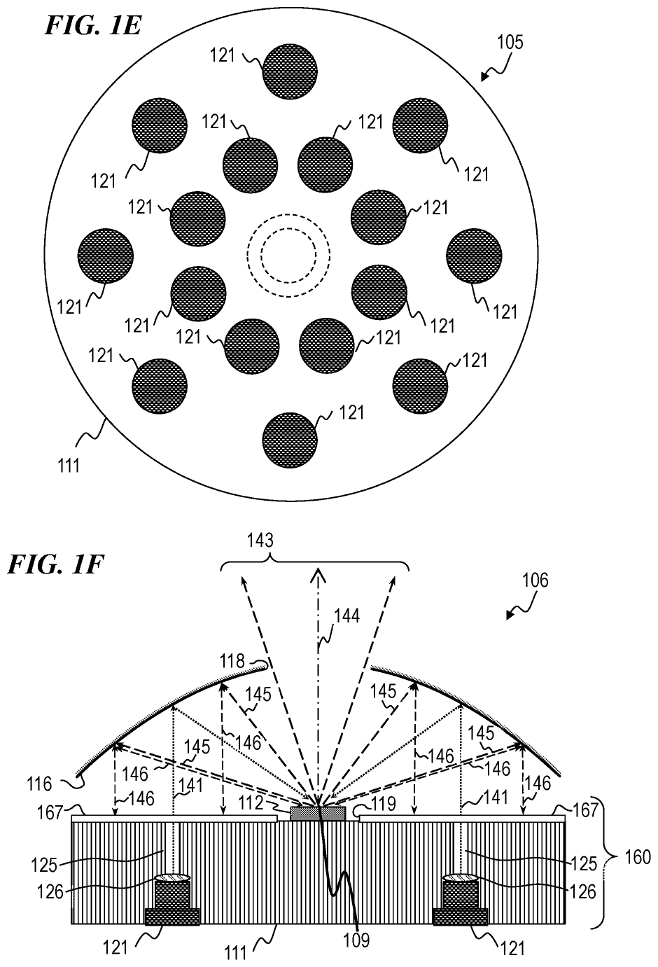

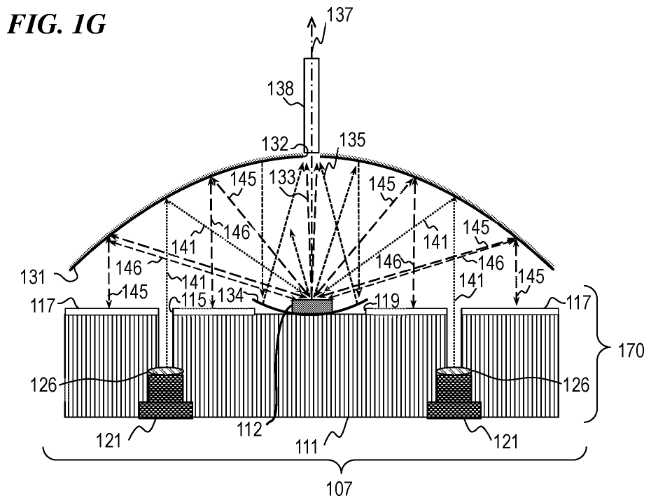

FIG. 1A is a side-view cross-sectional block diagram of a light source 101 that uses a plurality of lasers 121 (e.g., in some embodiments, eight), according to some embodiments of the present invention. In some embodiments, light source 101 includes a heatsinked laser and phosphor assembly 110 having a heatsink 111, phosphor plate 112, flat planar reflector 117, and a plurality of lasers 121 each having a collimating lens 126 such that the emitted beams 141 are collimated and parallel to the center axis 144 of the parabolic reflector 116. In some embodiments, phosphor plate 112 includes, or is, a thin layer of silicone phosphor, glass phosphor, ceramic phosphor, and/or crystal phosphor, mounted on a surface of heatsink 111 (the top surface in FIG. 1A). In some embodiments, phosphor plate 112 is placed proximal to the focus 109 of the parabolic reflector 116. One or more lasers 121 (two of which are shown in FIG. 1A), each with collimated laser beam outputs 141, are mounted on the heatsink 111 such that the output beams pass through the openings 125 through the heatsink 111. In some embodiments, holes 115 through the reflective layer 117 are aligned with openings 125 to allow laser beams 141 to pass therethrough. Dashed lines with single arrows with reference number 145 represent the initially emitted high-angle light from phosphor plate 112 to parabolic reflector 116, and dashed lines with double arrows with reference number 146 represent recycling light. Diffused light 145 from different locations on phosphor plate 112 will impinge on different locations of parabolic reflector 116 and be reflected to different locations on planar reflector 117, and the same in the reverse direction with recycled light 146. In other embodiments (see FIG. 1F), reflective layer 117 is replaced by wavelength-selective reflector 167 that is configured to transmit the wavelengths of the laser beams 141 but to reflect the emitted light of phosphor plate 112. The laser beams 141 are reflected by parabolic reflector 116 and directed towards the phosphor plate 112 at the focus 109 of parabolic reflector 116. In some embodiments, the laser-pumped excited phosphor in laser-pumped phosphor plate 112 emits longer-wavelength light (the emissive light) in substantially all directions, generally in a Lambertian angular distribution.

In some embodiments, phosphor plate 112 absorbs much of the laser light 141 and re-emits light (sometimes herein called “emissive light”) of a longer wavelength (e.g., in some embodiments, absorbing blue laser light in the range of about 420 nm to about 490 nm and re-emitting many wavelengths (i.e., a broad spectral bandwidth) centered at generally yellow wavelengths, such as having a peak center wavelength in a range of about 520 nm to about 660 nm). In some embodiments, some of the light from laser beam(s) 141 that is not absorbed is reflected, diffused and/or scattered by phosphor plate 112 and is recycled and/or output in light 143, which results in output light 143 having a combination of shorter and longer wavelengths (e.g., in some embodiments, “white” light).

The lower-angle emissive light 143 (light emitted at small angles to the central-axis surface normal vector 144 of the phosphor plate 112) exits through aperture 118 in parabolic reflector 116, contributing to the output of the light source 101. The high-angle portion 145 of the emissive light is collected for recycling by parabolic reflector 116 and collimated (in a downward vertical direction in FIG. 1A) towards planar reflector 117. The recycling light 146 is then retro-reflected back (in an upward vertical direction in FIG. 1A) to parabolic reflector 116 which reflects and focuses recycling light 146 back to focus location 109 on phosphor plate 112, completing the recycling process. A portion of this recycling light 146 is then emitted (in a generally upward direction in FIG. 1A) at small angles relative to the central-axis surface normal vector 144 of phosphor plate 112 (called small-angle light), exiting through aperture 118 and contributing to an increase in brightness of output light 143. The high-angle portion 145 of this recycling light (the portion at a large angle to the central-axis surface normal vector 144) is again recycled (reflecting from parabolic reflector 116, planar reflector 117 and again by parabolic reflector 116 back toward the focus 109), and the process repeats, contributing further to the output light 143 of light source 101. (Note that reference number 145 refers to one part of the high-angle portion of light initially emitted from phosphor plate 112 due to laser pump light, while reference number 146 refers to recycling light that is repeatedly reflected by parabolic reflector 116 and planar reflector 117 to go back to phosphor plate 112 so that some eventually is added to the output light 143. The light initially emitted, diffused and/or reflected from phosphor plate 112 will come out at all angles, typically in a Lambertian pattern, and examples of the high-angle portion (the light that does not initially exit through aperture 119) are indicated by reference number 145, and all of this light, regardless of emission angle, will be reflected as collimated light indicated by reference number 146 by parabolic reflector 116 toward planar reflector 117, and then retroreflected, again as collimated light by planar reflector 117 toward parabolic reflector 116 and all will then be reflected and focused toward phosphor plate 112—indicated by reference number 146 to show exemplary recycling paths.) In one embodiment, planar reflector 117 reflects all wavelengths of light.

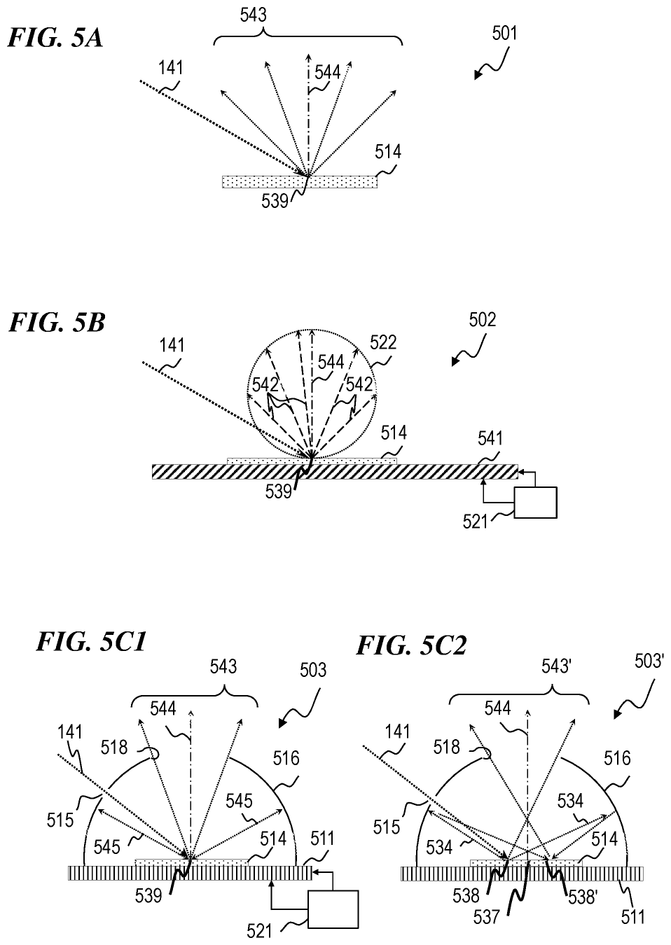

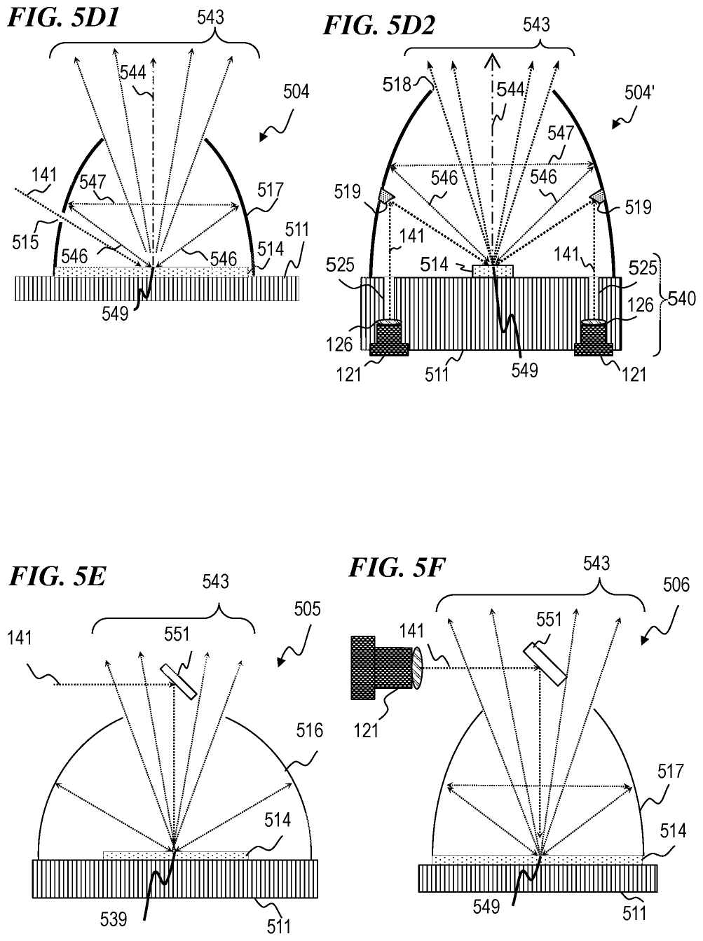

In some embodiments, the inner and outer diameters of the parabolic reflector 116 and the inner and outer diameters of the planar reflector 117 (both of which, in some embodiments, are circular in overall shape, as may be appreciated in the bottom view of FIG. 1B) are designed to optimize (i.e., a designer-chosen compromise for a given application) between maximizing the total recycling efficiency and minimizing the physical dimensions of light source 101. In some such embodiments, the outer diameter of the parabolic reflector 116 is the same size as the outer diameter of planar reflector 117 and the inner diameter (the size of aperture 118) of the parabolic reflector 116 is the same size as the inner diameter (the size of aperture 119) of planar reflector 117. With the phosphor-emission outputs of phosphor plate 112 being Lambertian (e.g., see FIG. 5B), most of the output will be within a half angle of about 70 degrees. In this case, the diameters of parabolic reflector 116 and planar reflector 117 can be made smaller to reduce the overall dimensions of the system of light source 101. In another embodiment (not explicitly shown, but substantially similar to FIG. 1A), the upper-face surface of the phosphor plate 112 is coated with a photonic-crystal layer and/or a diffraction grating such that the output angular distribution is narrower than Lambertian, and in this case, the diameter of the parabolic reflector(s) can be even smaller. In some embodiments, since both the phosphor plate 112 and the lasers 121 are mounted on the same heatsink 111, a single heat-dissipating structure (i.e., heatsink 111) is used, simplifying the design and reducing the cost of the system using light source 101.

FIG. 1B is a bottom-view block diagram of light source 101, according to some embodiments of the present invention. In FIG. 1B, the large-circle dash-dot-dot line outlines the outer circumference of parabolic reflector 116 on the top of FIG. 1A (which is not directly visible from this bottom view), and the smaller-circle dash-dot-dot line outlines the circumference of aperture 118 in parabolic reflector 116. The small-dash-dot cross-section indicator 1A indicates the location of the cross-section plane for the diagram of FIG. 1A.

FIG. 1C is a top-view block diagram of heatsinked laser and phosphor assembly 110, according to some embodiments of the present invention. In this view, the diameter of holes 115 in planar reflector 117, and the diameter of openings 125 through the heatsink 111 are the same, so openings 125 are not separately labeled. In some embodiments (not shown here in order to clarify the drawing), the outer diameter of phosphor plate 112 and the size of aperture 119 in planar reflector 117 are the same in order to maximize light recycling and also maximize the thermal contact between phosphor plate 112 and heatsink 111.

FIG. 1D is a top-view block diagram of light source 101, according to some embodiments of the present invention. In some embodiments (not shown here in order to clarify the drawing), the outer diameter of parabolic reflector 116 and the outer diameter of planar reflector 117 are the same size, and the size of aperture 118 in parabolic reflector 116, the outer diameter of phosphor plate 112, and the size of aperture 119 in planar reflector 117 are all the same in order to maximize light recycling.

FIG. 1E is a bottom-view block diagram of an alternative light-recycling light source 105 that uses more lasers 121 (e.g., in some embodiments, sixteen), according to some embodiments of the present invention. In some embodiments, recycling light source 105 arranges the plurality of lasers 121 in two or more circumferential rings around the center of phosphor plate 112 (or other patterns, such as patterns of approximately even spacing across the surface of heatsink 111).

FIG. 1F is a side-view cross-sectional block diagram of a light-recycling light source 106 that uses a plurality of lasers 121 (e.g., in some embodiments, eight) and a blue-wavelength-transmissive and other-wavelengths-reflective planar reflector 167, according to some embodiments of the present invention. In some embodiments, the wavelength-selective planar reflector 167 is coated (e.g., in some embodiments, with a plurality of dielectric layers) such that only blue light from the lasers 121 passes through (is transmitted) and other wavelengths (particularly the wavelengths emitted by the phosphor plate 112 when excited by blue pump light from lasers 121) are reflected. In contrast to FIG. 1A, in some such embodiments, the wavelength-selective reflector planar reflector 167 covers the whole, or at least most of heatsink 111, outside the diameter of the phosphor plate 112, without the need for making matching holes 115 corresponding to the openings 125 in heatsink 111, as were shown in FIG. 1A. Other aspects of FIG. 1F are as described above for FIG. 1A.

FIG. 1G is a side-view cross-sectional block diagram of a light-recycling light source 107 that uses a plurality of lasers 121 (e.g., in some embodiments, eight) and that outputs its light into an optical waveguide 138 (or a light pipe, as described below), according to some embodiments of the present invention. In some embodiments, optical waveguide 138 includes a glass optical fiber or rod, optionally coated with a material having a lower index of refraction than the glass optical fiber or rod, such that light propagating in the waveguide is contained by total internal reflection (TIR). When light is confined by an internally reflective pipe or coatings such as metal on a transparent rod, rather than by TIR, structure 138 may be referred to as a light pipe rather than a waveguide. In some embodiments, light source 107 includes two parabolic reflectors—parabolic reflector 131 at the top of FIG. 1G and parabolic reflector 134 at the surface of heatsink 111, such that the output is not merely a divergent beam from the phosphor plate 112. Instead, an image of the laser-excited light-emission spot at the phosphor plate 112 is transferred from the physical location of phosphor plate 112 to the aperture 132 of the parabolic reflector 131 through reflection from the first and second parabolic reflectors, 131 and 134, respectively. The phosphor plate 112 is placed at the focus of the first parabolic reflector 131 and the aperture 132 in parabolic reflector 131 (which, in some embodiments, is smaller than the aperture 118 of parabolic reflector 116 of FIG. 1A) is placed at the focus of the second parabolic reflector 134. In some embodiments, the image of the spot on the phosphor plate 112 at the aperture 132 is used for direct coupling into fiber optics, light pipes of projection systems (such as light pipe 138 shown here), and the like. The use of two parabolic reflectors—parabolic reflector 131 and parabolic reflector 134—eliminates the need for high-numerical-aperture (high-NA) coupling lenses, which are expensive, inefficient, and do not focus well. The light-recycling portion (that portion outside of parabolic reflector 134) of light source 107 is similar to that of FIG. 1A, as described above. In some embodiments, the output light 137 from light pipe 138 is coupled to further output optics (not shown).

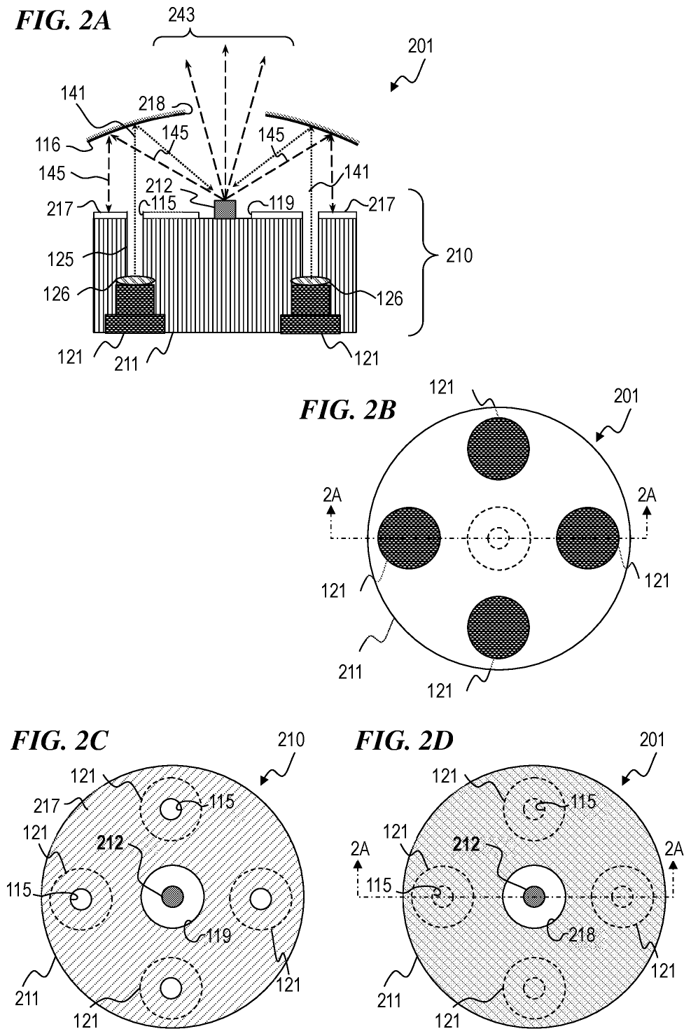

FIG. 2A is a side-view cross-sectional block diagram of a light source 201 that uses a plurality of lasers 121 (e.g., in some embodiments, four), according to some embodiments of the present invention. In some embodiments, light source 201 includes a heatsinked laser and phosphor assembly 210 having a heatsink 211, phosphor plate 212, flat planar reflector 217, and a plurality of lasers 121 each having a collimating lens 126 such that the emitted beams 141 are collimated and parallel to the center axis 144 of the parabolic reflector 116. In some embodiments, phosphor plate 212 includes, or is, a thin layer of silicone phosphor, glass phosphor, and/or crystal phosphor, mounted on a surface of heatsink 211 (the top surface in FIG. 2A). In some embodiments, phosphor plate 212 is placed proximal to the focus 109 of the parabolic reflector 116. One or more lasers 121 (two of which are shown in FIG. 2A), each with collimated laser beam outputs 141, are mounted on the heatsink 211 such that the output beams pass through the openings 125 through the heatsink 211. In some embodiments, holes 115 through the reflective layer 217 are aligned with openings 125 to allow laser beams 141 to pass therethrough. In other embodiments (see FIG. 1E), reflective layer 217 is replaced by a wavelength-selective reflector 167 that is configured to transmit the wavelengths of the laser beams 141 but to reflect the emitted light of phosphor plate 212. The laser beams 141 are reflected by parabolic reflector 116 and directed towards the phosphor plate 212 at the focus 109 of parabolic reflector 116. In some embodiments, the laser-pumped excited phosphor in laser-pumped phosphor plate 212 emits longer-wavelength light (the emissive light) in substantially all directions, typically in a Lambertian angular distribution.

FIG. 2B is a bottom-view block diagram of light source 201 according to some embodiments of the present invention. The descriptions for many of the reference numbers in FIG. 2B are set forth above in the descriptions of FIG. 1A and FIG. 2A. In some embodiments, heatsink 211 is smaller than heatsink 111 of FIG. 1A (e.g., in some embodiments, heatsink 211 has a 25-mm diameter) and phosphor plate 212 is smaller than phosphor plate 112 of FIG. 1A (e.g., in some embodiments, phosphor plate 212 has a 2-mm diameter).

FIG. 2C is a top-view block diagram of heatsinked laser and phosphor assembly 210, according to some embodiments of the present invention. The descriptions for many of the reference numbers in FIG. 2C are set forth above in the descriptions of FIG. 1A and FIG. 2A. In some embodiments, openings 115 each have a 2-mm diameter.

FIG. 2D is a top-view block diagram of light source 201, according to some embodiments of the present invention. The descriptions for the reference numbers in FIG. 2D are set forth above in the descriptions of FIG. 1A and FIG. 2A.

In some embodiments, the present invention provides a light source that includes a heatsink; a plurality of lasers, each mounted to a respective opening in the heatsink, wherein each of the plurality of lasers emits laser light of one or more first wavelengths through its respective opening in the heatsink; a phosphor mounted to a reflective surface on the heatsink; a parabolic reflector arranged to reflect the light from the plurality of lasers toward the phosphor mounted to the reflective surface on the heatsink and arranged such that the laser light from the plurality of lasers passes through the phosphor die twice to the reflective surface on the heatsink and then back through the phosphor toward the parabolic reflector.

In some embodiments, the phosphor converts the laser light of one or more first wavelengths to a set of one or more second wavelengths. In some embodiments, the parabolic reflector includes an aperture opposite the phosphor. In some embodiments, the heatsink includes a planar reflector facing the parabolic reflector. In some embodiments, the excited phosphor emits light in many directions toward the parabolic reflector. In some embodiments, lower-angle light exits through the aperture, contributing to output of the light source, a high-angle portion of the light from the phosphor and any unconverted laser light is collected by the parabolic reflector and collimated back towards the planar reflector, and the light from the parabolic reflector is then reflected by the planar reflector back to the parabolic reflector and focused back to the phosphor plate by the parabolic reflector, completing a light-recycling process.

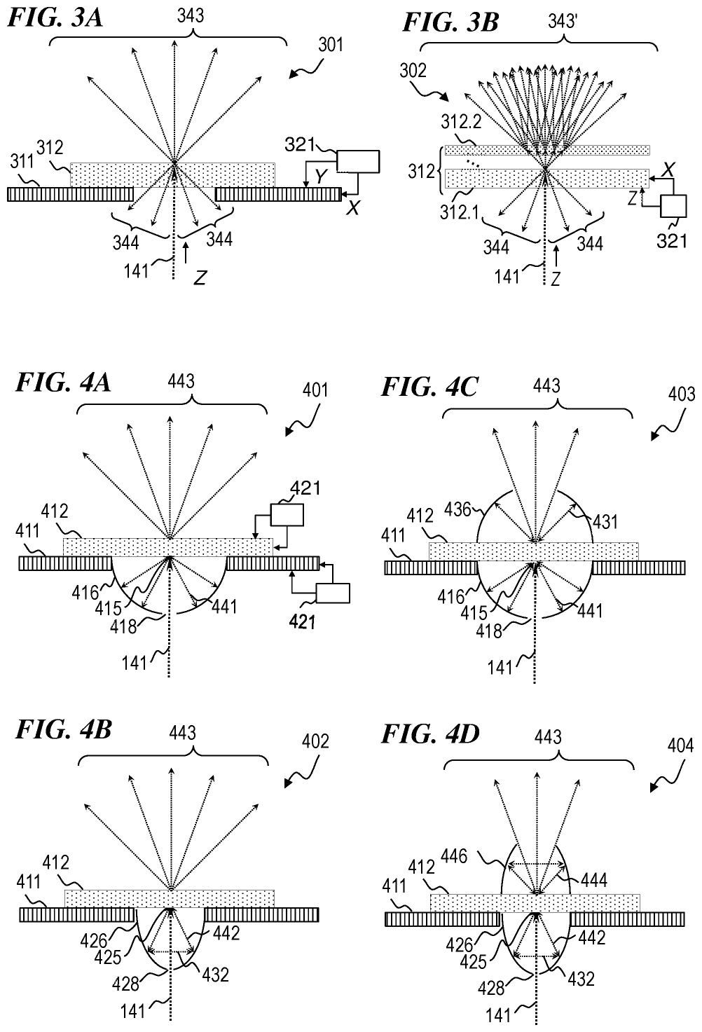

FIG. 3A is a side-view cross-sectional block diagram of a transmissive-reflective diffuser system 301 with a diffuser plate 312 that receives a laser beam 141, according to some embodiments of the present invention. In some embodiments, the transmissive diffuser 312 is attached to a heatsink 311 having a very small hole therethrough (shown larger here for clarity) to permit substantially all of the laser beam 141, which is incident from the bottom side (i.e., from the bottom in this FIG. 3A), to pass through heatsink 311 to the diffuser 312. In some embodiments, not shown, the bottom of the transmissive diffuser plate 312 is coated with a wavelength-selective optical filter, e.g., in some embodiments, a multi-layer dielectric reflective coating, such that the wavelength-selective optical filter transmits the laser light for excitation of the phosphor, but reflects any downward phosphor emission back to the top side, adding to the output light of the system, thus increasing the efficiency. In some embodiments, the transmissive diffuser 312 (optionally including the heatsink 311) is attached to a vibrational actuator 321 that vibrates the diffuser in one or more transverse directions (e.g., in the X and/or Y direction shown schematically here in FIG. 3A, which is/are orthogonal to the Z direction of the incident incoming laser beam 141). In some other embodiments, the vibration 321 is applied to the diffuser 312 (such as shown in FIG. 3B, applied of diffuser 312.1), alternatively or additionally, in the Z-direction. In some embodiments, the direction of incident laser beam 141 is orthogonal to the plane of the exit face (the top face in FIG. 3A) of the diffuser 312, while in other embodiments, the incident laser direction is not orthogonal to the face of diffuser plate 312 (as shown in FIG. 3A), but instead is incident at an acute angle, which is useful, for example, when using multiple incoming laser beams (e.g., in some embodiments, using a plurality of different wavelengths or colors—e.g., red, green, blue (RGB), cyan, yellow, violet, orange, infrared (IR), ultraviolet (UV) and/or the like). The laser beam 141 is incident to the diffuser 312 from one side (from the bottom in this FIG. 3A) and the diffused output light 343 is collected from the other side of the diffuser 312 (out the top in this FIG. 3A). In some such embodiments, some of the diffused light 344 also exits the same face through which the incident laser beam 141 entered, which reduces the efficiency of system 301. In some embodiments, laser beam 141 is focused onto diffuser plate 312 using an appropriate optical system (not shown), with the smallest or the desired spot size.

FIG. 3B is a side-view cross-sectional block diagram of a transmissive-reflective diffuser system 302 with a plurality of diffuser plates 312.1 . . . 312.2 that receive a laser beam 141, according to some embodiments of the present invention. In some embodiments, the diffuser 312 includes a plurality of diffusive layers 312.1 . . . 312.2. In both FIG. 3A and FIG. 3B, the angle and spread of diffusion depend on the properties of the diffusive layer(s), such as the bulk features (e.g., bubbles or particulates), the surface features of the top and/or bottom faces, such as roughness, etc., and/or spacing between layers (312.1 . . . 312.2) if a plurality of spaced layers are used. The basic properties of most of these features diffuses the light both in the forward direction (upward in the FIG. 3A) as diffused output 343, and backward direction (downward in the FIG. 3A) as diffused output 344 as shown. If the backward diffused light 344 is not collected, it contributes to the losses of the system, thus reducing the efficiency. In some embodiments, an optional vibration actuator 321 applies a vibration to the diffuser 312, reducing the amount of speckles in the output light.

FIG. 4A is a side-view cross-sectional block diagram of a recycling transmissive-reflective diffuser assembly 401, according to some embodiments of the present invention. In some embodiments, assembly 401 includes a transmissive diffuser 412 and a dome-shaped (spherical) light-recycling reflector 416, added to the back side (the side through which laser beam 141 enters) of the diffuser 412, with an aperture 418 through reflector 416 such that the incident laser beam 141 passes through the aperture 418. In some embodiments, the dome-recycling reflector 416 is preferably spherical with the center of curvature 415 located at, or proximal to, the laser entry spot (the location where the incoming laser beam is incident onto diffuser bottom face), such that all the back-diffusion light is reflected back from reflector 416 to the laser entry spot, increasing the output of diffused light from the top face of the diffuser. In some embodiments, an optional vibration is applied (e.g., by vibration actuator 421) to diffuser 412 and/or to reflector 416. In some embodiments, the vibration is applied to reduce the amount of speckles. In some embodiments, the recycling reflector 416 is an orthogonal parabolic reflector as shown in FIG. 4B.

In some embodiments (not shown) of assembly 401 of FIG. 4A, the input aperture 418 of the dome reflector 416 is off-center, such that the input laser beam 141 is not incident on the diffuser 412 at an orthogonal angle, so as to reduce retroreflection back toward the input aperture 418 in order to reduce light loss out the input aperture 418. In some embodiments, a plurality of such off-center input apertures are provided to receive, at one or more acute angles and/or directions toward the input face of diffuser 412, a plurality of laser beams of the same wavelength, or to increase the number of colors by receiving a plurality of laser beams of different wavelengths.

FIG. 4B is a side-view cross-sectional block diagram of a recycling transmissive-reflective diffuser assembly 402 with a diffuser plate 412 and a back-side orthogonal-parabolic light-recycling reflector 426, according to some embodiments of the present invention. In some embodiments, assembly 402 includes diffuser plate 412, an optional heatsink 411, and an orthogonal parabolic reflector 426 that serves as the recycling reflector. The laser beam 141 enters the system 402 through input aperture 428 in the orthogonal-parabolic light-recycling reflector 426, arriving at the laser entry spot at the focus location 425 on the back face of the diffuser 412 (which includes one or more layers of diffusion material, for example, as shown in FIG. 3B), and the light 442 diffused backward (downward in FIG. 4B) from the laser spot at the focus 425 of the reflector 426 is reflected from one side of the reflector, and horizontally directed as light 432 towards the opposite side of the reflector 426 in a direction orthogonal to the center axis of the orthogonal parabolic reflector 426, and is there reflected back to the focus location 425, completing the light-recycling process and increasing the output of the assembly 402. Again, in some embodiments, an optional vibration is applied to diffuser 412 (e.g., by a vibration actuator 421 as shown in FIG. 4A) and/or to the reflector 426, reducing the amount of speckles.

In some embodiments of system 402 of FIG. 4B, the input aperture 428 of the orthogonal parabolic reflector 426 is off-center such that the input laser beam 141 is angled so as to not be incident on the diffuser 412 at an orthogonal angle, in order to reduce retroreflection back toward the input aperture 428, thus reducing backscattered light loss out the input aperture 428. In some embodiments, a plurality of such off-center input apertures are provided receive, at one or more acute angles and/or directions toward the input face of diffuser 412, to accommodate a plurality of laser beams of the same wavelength to increase power, or to increase the number of colors by receiving a plurality of laser beams of different wavelengths.

FIG. 4C is a side-view cross-sectional block diagram of a recycling transmissive-reflective diffuser assembly 403 with a diffuser plate 412, a back-side dome-shaped (spherical) light-recycling reflector 416, and a front-side dome-shaped (spherical) light-recycling reflector 436, according to some embodiments of the present invention. In some embodiments, system 403 is substantially similar to system 401, but with the addition of front-side dome reflector 436 that recycles high-angle light 431 back to a center location on diffuser plate 412.

FIG. 4D is a side-view cross-sectional block diagram of a recycling transmissive-reflective diffuser assembly 404 with a diffuser plate 412 and a back-side orthogonal-parabolic light-recycling reflector 426, and a front-side orthogonal-parabolic light-recycling reflector 446, according to some embodiments of the present invention. In some embodiments, system 404 is substantially similar to system 403, but with the addition of orthogonal-parabolic light-recycling reflector 446 that recycles high-angle light 444 back to a center location on diffuser plate 412.

FIG. 5A is a side-view cross-sectional block diagram of a reflective diffuser system 501 having a reflective diffuser 514, according to some embodiments of the present invention. Incoming laser beam 141 is incident to laser spot 539 on a surface of diffuser 514. The central-axis surface normal vector 544 from laser spot 539 is orthogonal to the surface of diffuser 514, and the diffused reflected light 543 comes off at a plurality of directions. In contrast to transmissive diffusers (as shown in FIGS. 3A, 4B, 4A, and 4B), system 501 uses a reflective diffuser 514. In some embodiments, reflective diffuser 514 is mounted on top of a substrate (e.g., such as shown in FIG. 5B) having a high heat conduction, which provides a heatsinking function, allowing a higher power operation of system 501. In the systems 301, 302, 401, and 402 of FIGS. 3A, 4B, 4A, and 4B, respectively, with the need for passing the laser beam through the transmissive diffuser 312 or 412, heatsinking becomes difficult (though not impossible since, as described above, some embodiments include a heatsink substrate 311 or 411 having a small through-hole), which limits the ultimate power-handling capacity of the transmissive systems 301, 302, 401, and 402. Another limit is caused by the light passing through the diffuser material, which inherently absorbs some of the laser light. In contrast, in some embodiments, reflective diffuser 514 is made so that very little of the laser light passes through the diffusive material. In some embodiments, reflective diffuser materials used for reflective diffuser 514 that handle high power include a ceramic such as aluminum nitride, aluminate silicate, etc. An example of these materials is Accuratus's Accuflect® Light-Reflecting Ceramic (available from www.accuratus.com), which reflects 95% to 99% of incident light from 450 nm to 2500 nm, and the reflectivity is essentially non-specular with nearly perfect Lambertian behavior across the entire spectrum. Accuratus's Accuflect® Light-Reflecting Ceramic (see, e.g., www.accuratus.com/accuflprods.html) is a porous ceramic usable to 1100° C. that is used in some embodiments of the present invention. When a laser beam 141 is focused into a small spot on such a ceramic, the laser light will be scattered into the output directions with a Lambertian distribution emitted from a very small area, which provides a very-small-etendue light source, as shown in FIG. 5B. In addition, to reduce the speckles, in some embodiments, the reflective diffuser is mounted on a vibrating substrate (such as substrate 541 of FIG. 5B or heatsink substrate 511 of FIGS. 5C1 and 5D). In some embodiments, with proper amplitude and frequency of the vibration from vibration actuator 521, illumination without visible speckles is obtained. In some embodiments, with the high reflectivity of these diffusing ceramics used for reflective diffuser 514, together with the high reflectivity of the recycling reflector (e.g., reflector 516 of FIG. 5C1 or reflector 517 of FIG. 5D), the brightness-increase factor is very high. For one particular case that includes reflectors such as shown in FIG. 5C1, 5D or 5E, where the output angle is +/−20 degrees, diffuser reflectivity is 98%, and recycling-reflector reflectivity is 99%, the brightness of the system increases by a factor of up to 6.4 times.

FIG. 5B is a side-view cross-sectional block diagram showing the Lambertian reflection-intensity pattern 522 of a reflective diffuser system 502 having a reflective diffuser 514 on a substrate 541, according to some embodiments of the present invention. The dotted-line circle of reflection-intensity pattern 522 illustrates the Lambertian distribution, wherein the lengths of the arrows 542 from the laser spot 539 on the front face of diffuser 514 to the circle 522 represent the relative intensities in the various output directions in the plane of the paper. In some embodiments, the Lambertian distribution is substantially spherical. In some embodiments, a single input laser beam 141 is used. In some other embodiments, a plurality of input laser beams 141 (in some embodiments, all of the same wavelength for greater intensity, while in other embodiments, of a plurality of different wavelengths for more colors) are incident from a plurality of three-dimensional (3D) directions surrounding the location of the laser spot 539 on the surface of diffuser 514. In some embodiments, the plurality of 3D directions for the incoming laser beams 141 also vary in the angle of incidence toward the surface of diffuser 514. Depending on the type of diffusers used, in some embodiments, the output distribution has a smaller divergence angle. For example, instead of +/−90 degrees, in some embodiments, the divergence angle is made smaller by diffuser design, such as +/−30 degrees or other range of angles, or other non-circularly symmetric shape of the intensity. In addition, in various other embodiments, the intensity profile is flat top, concave in shape (i.e., less intensity in the center and more intensity at some distance from the center optical axis), or other desired shapes, instead of the convex shape (i.e., more intensity in the center) exhibited in the Lambertian distribution.

FIG. 5C1 is a side-view cross-sectional block diagram of a reflective diffuser system 503 having a reflective diffuser 514 on a heatsink substrate 511 and a spherical dome reflector 516, according to some embodiments of the present invention. In some embodiments, system 503 includes a dome-shaped light-recycling reflector 516 (in some embodiments, spherical reflector 516 having a center of curvature at the location of the laser spot 539) with one or more input apertures 515 to pass one or more input laser beams 141 toward the focus spot location 539 on diffuser 514 at the center of curvature of the reflector 516. In some embodiments, the light-output angle is determined by the size of output aperture 518 and the distance from the laser spot 539 on the diffuser 514 to output aperture 518. In some embodiments, a laser-beam-input aperture 515 of the recycling reflector 516 is made for each one of a plurality of input laser beams 141 such that each laser beam passes through and is incident onto the diffuser 514 at the desired laser spot location 539. In some embodiments, the input laser emits a single-color laser beam 141, while in other embodiments, a combination of several colors from one or more lasers is combined into a single input laser beam 141. In yet another embodiment, a plurality of laser-input apertures 515 are made (such as spaced circumferentially around reflector 516) such that a plurality of laser beams 141 with the same color (or, in other embodiments, having a plurality of different colors) pass through the respective apertures 515 and are incident onto the diffuser 514 at the same spot 539 (or, in other embodiments, at different spots on diffuser 514 (see FIG. 5C2), depending on the designer's desired application). When using the spherical dome-shaped recycling reflector 516, the light 534 diffused toward the dome reflector 516 from the incident spot 539 at the center of curvature will be reflected back to the same spot 539 at the center of curvature of recycling reflector 516. In some such embodiments, it is important that at the assembly process, the dome-shaped light-recycling reflector 516 is aligned accurately such that the input laser beam is incident to the location 539 at the center of curvature. In other embodiments (see FIG. 5C2, described below), the incoming laser beam 141 is directed to a laser spot 538 located off to one side of the center of curvature 537 and will have its diffused light 534 reflected back to the diffuser 514 to a location 538′ at the opposite side of the center of curvature 537 from laser spot 538. In some embodiments, an optional vibration is applied to the heatsink 511 and/or to the dome-shaped light-recycling reflector 516 in order to reduce the amount of speckles.

FIG. 5C2 is a side-view cross-sectional block diagram of a reflective diffuser system 503′ having a reflective diffuser 514 on a heatsink substrate 511 and a spherical dome reflector 516, according to some embodiments of the present invention. In this embodiment, the incoming laser beam 141 is directed to a laser spot 538 located off to one side of the center of curvature 537 and has its diffused light 534 reflected back to the diffuser 514 to a location 538′ at the opposite side of the center of curvature 537 from laser spot 538. Light from the secondary location 538′ will then reflect from dome reflector 516 to get recycled back to the original laser spot 538.

FIG. 5D1 is a side-view cross-sectional block diagram of a reflective diffuser system 504 having a reflective diffuser 514 on a heatsink substrate 511 and an orthogonal-parabolic reflector 517, according to some embodiments of the present invention. In order to overcome the alignment requirements needed by some embodiments of FIG. 5C1, an orthogonal parabolic recycling reflector 517 is used in some embodiments, as shown in FIG. 5D1. This orthogonal parabolic recycling reflector 517 has the property that when the location of the laser spot 549 is off to one side of the center of the parabola, the light 546 emitted (i.e., the light diffused from the incident laser spot) will be reflected from one side of the reflector 517, then the reflected light 547 propagates to the opposite side of the reflector 517, and then back to the same location of the original laser spot 549. As a result, the stringent requirements in alignment (such as for FIG. 5C1) are reduced, since the mis-aligned laser spot 549 will be reflected back to the same spot for light recycling. Again, in some embodiments, the laser beam 141 is single-color (e.g., single wavelength), while in other embodiments, a combination of several colors from one or more lasers is combined into a single beam 141. In some embodiments, a plurality of laser-input apertures 515 are made such that a plurality of laser beams 141, each with the same color, or the plurality of laser beams 141 having a plurality of different colors, pass through the respective apertures 515 and are incident onto the diffuser 514 at the same spot 549 or at different spots, depending on applications. Again, in some embodiments, an optional vibration is applied to the heatsink 511, diffuser 514 and/or the orthogonal parabolic recycling reflector 517, reducing the amount of speckles.

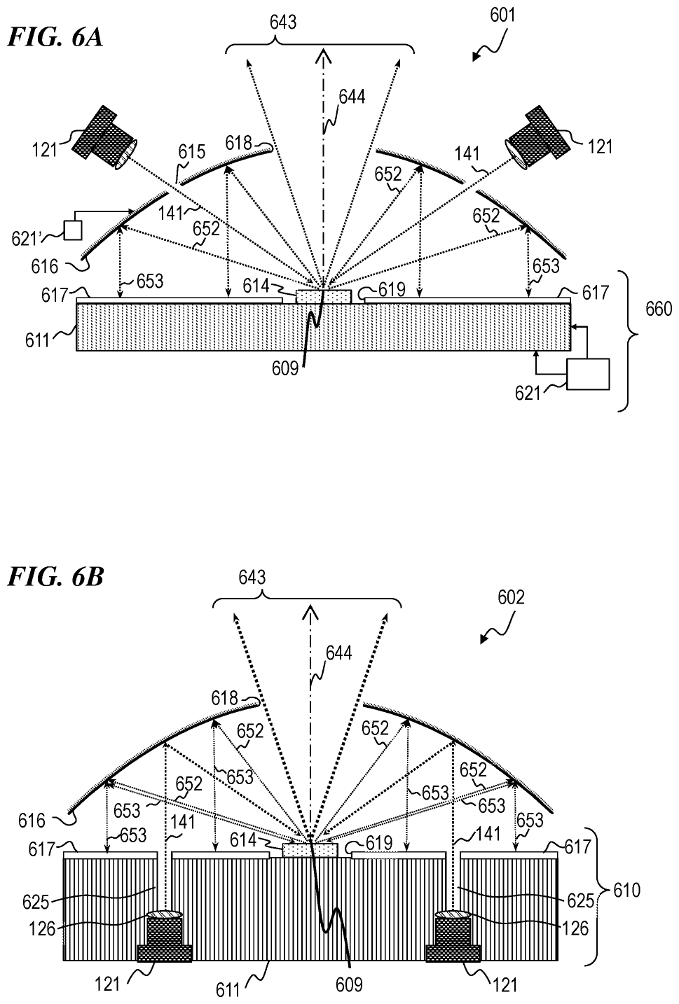

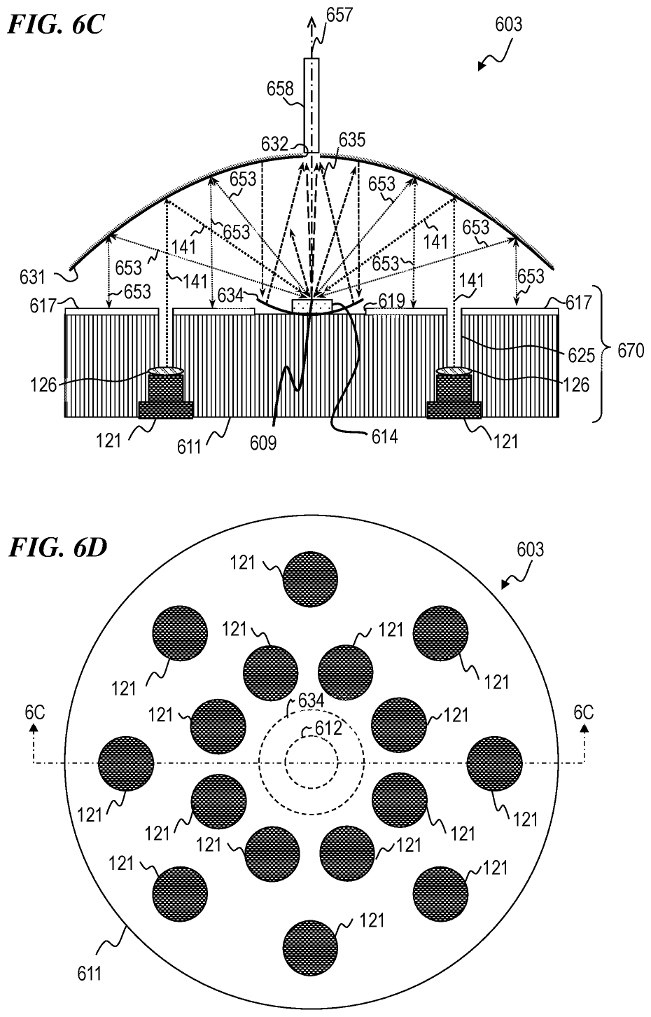

FIG. 5D2 is a side-view cross-sectional block diagram of a reflective diffuser system 504′ having a reflective diffuser 514 on a heatsink 511, one or more lasers 121 mounted to heatsink 511 to emit laser beams 141 through holes 525 in the heatsink 511, and an orthogonal parabolic recycling reflector 517 that reflects high-angle light 546 horizontally across as light 547 to the opposite side and reflects that as light 546 back to the focus location 549 on the diffuser 514 to complete light recycling, according to some embodiments of the present invention. In order to overcome the alignment requirements needed by some embodiments of FIG. 6B or FIG. 6C described below, system 504′ uses includes one or more parabolic reflector portions 519 of a parabolic reflector (such as portions of parabolic reflector 616 of FIG. 6B) on the top but only directly above the lasers 121 to direct the laser beams 141, and uses orthogonal parabolic recycling reflector 517 for the remainder of the top-side light-recycling, to reduce some of the need for precise alignment of all laser beams 141 to point to the same location. In some embodiments of system 504′, laser beams 141 come from one or more lasers 121 (with collimating lenses 126) mounted on heatsink 511 and propagate through the openings 525 through the heatsink 511 toward parabolic reflector portions 519, which focuses the laser light to location 549 on reflective diffuser 514. The low-angle initially diffused light exits into output light 543 directly through output aperture 518, and the high-angle initially diffused light 546 is recycled by two reflections at orthogonal parabolic recycling reflector 517 back to diffuser 514, increasing the amount of output light 543 of system 504′. In some embodiments, to remove speckles, vibrations with the appropriate frequencies and amplitudes are applied to orthogonal parabolic recycling reflector 517, heatsink 511, and/or diffuser 514. In some embodiments, the diffuser 514 and lasers 121 are mounted on different heatsinks (not shown) in order that vibrations can be applied to one or the other or, independently, to both, using separate vibration actuators.

FIG. 5E is a side-view cross-sectional block diagram of a reflective diffuser system 505 having a reflective diffuser 514 on a heatsink substrate 511, a spherical dome reflector 516, and a small mirror 551 to direct the input beam 141 to the focus location 539 on the diffuser 514, according to some embodiments of the present invention. The mirror 551 is made small and the mounting bracket (not shown) of mirror 551 is made thin, such that obstruction of the output light 534 is minimal. Other aspects and reference numbers are as described above for FIG. 5C1. In some embodiments, an optional vibration is applied to diffuser 514, heatsink 511 and/or dome 516, reducing the amount of speckles.

FIG. 5F is a side-view cross-sectional block diagram of a reflective diffuser system 506 having a reflective diffuser 514 on a heatsink substrate 511, an orthogonal-parabolic reflector 517, and a small mirror 551 to direct the input beam 141 to the focus location 549 on the diffuser 514, according to some embodiments of the present invention. Other aspects and reference numbers are as described above for FIG. 5D. In some embodiments, an optional vibration is applied to diffuser 514, heatsink 511 and/or orthogonal parabolic recycling reflector 517, reducing the amount of speckles.

In some embodiments, each of the reflectors set forth in the description of the present invention includes a plurality of layers of material (such as transparent dielectric material) of different refraction indices, with appropriate thicknesses for one or more of the wavelengths used by the various embodiments, and optionally diffraction gratings (see, e.g., U.S. Pat. No. 5,907,436 entitled “Multilayer dielectric diffraction gratings,” which describes the design and fabrication of dielectric grating structures with high diffraction and/or reflection efficiency).

FIG. 6A is a side-view cross-sectional block diagram of a reflective diffuser system 601 having a reflective diffuser 614 on a heatsink substrate 611, a parabolic reflector 616, a planar reflector 617 on the heatsink substrate 611 to reflect the initially diffused input light 652 back to the parabolic reflector 616, which the reflects that light 652 back to the focus location 609 on the diffuser 614, according to some embodiments of the present invention. In some embodiments, the recycling of reflective diffuser system 601 is achieved using a parabolic reflector 616 and a planar reflector 617. In some embodiments, each laser beam 141 passing through opening 615 in parabolic reflector 616 is incident onto reflective diffuser 614 at a location proximal to the focus location 609 of parabolic reflector 616. In some embodiments, heatsinked diffuser assembly 660 includes heatsink 611, reflective diffuser 614, planar reflector 617, and optionally vibration actuator 621. The portion of the diffused light with smaller diffusion-reflection angles (called small-angle diffused light) exits as a portion of output light 643 through the output aperture 618. The portion of the diffused light 652 with larger angles (called high-angle diffused light) is reflected by parabolic reflector 616 as collimated light 653 incident on the planar reflector 617, as shown, wherein it is retroreflected back to the parabolic reflector 616, and reflectively focused back onto the initial laser spot location 609 on the diffuser 614, completing the cycle of recycling. This recycled light 652 will be combined with the laser light 141 at location 609 and diffused all over again by the diffuser 614. In some embodiments, to remove speckles, vibrations with the appropriate frequencies and amplitudes are applied by an optional vibration actuator 621 indirectly through heatsink 611, and/or directly to diffuser 614 and/or planar reflector 617. In some embodiments, to remove speckles, vibrations with the appropriate frequencies and amplitudes are also or alternatively applied by an optional vibration actuator (not shown) to the parabolic reflector 616. In some embodiments, the diffuser 614 and the planar reflector 617 are mounted on different heatsinks (not shown) in order that vibrations can be applied to one or the other or, independently, to both, using separate vibration actuators. In some embodiments, diffuser 614 includes a reflective phosphor plate and laser 121 is a blue laser. In some embodiments, the output appears white in color including longer-wavelength emission from the phosphor.

FIG. 6B is a side-view cross-sectional block diagram of a reflective diffuser system 602 having a reflective diffuser 614 on a heatsink substrate 611, a parabolic reflector 616, a planar reflector 617 on the heatsink substrate 611 to reflect the initially diffused input light 652 back to the parabolic reflector 616, which the reflects that light back to the focus location 609 on the diffuser, and one or more lasers 121 mounted to the heatsink substrate 611 to emit laser beams 141 through openings 625 in the substrate 611, according to some embodiments of the present invention. In some embodiments, heatsinked diffuser and laser assembly 610 includes heatsink 611, reflective diffuser 614, planar reflector 617, one or more lasers 121, and optionally a vibration actuator (such as vibration actuator 621 shown in FIG. 6A). In some embodiments of system 602, laser beams 141 come from one or more lasers 121 (with collimating lenses 126) mounted on heatsink 611. In some embodiments, laser beams 141 from the one or more lasers 121 propagate through the openings 625 through the heatsink 611 from the back (bottom in FIG. 6B) to the front (top in FIG. 6B) of heatsink 611. The laser beams 141 are directed at parabolic reflector 616 and focused onto location 609 on reflective diffuser 614. Other aspects and reference numbers of FIG. 6B are as described above for FIG. 6A. Similar to that of FIG. 6A, the diffused light partly exits directly through output aperture 618 and partly is recycled by reflection at parabolic reflector 616 and planar reflector 617 on heatsink 611, increasing the amount of output 643 of system 602. In some embodiments, to remove speckles, vibrations with the appropriate frequencies and amplitudes are applied to parabolic reflector 616. In some embodiments, to remove speckles, vibrations with the appropriate frequencies and amplitudes are applied to heatsink 611, diffuser 614 and/or planar reflector 617. In some embodiments, the diffuser 614 and the planar reflector 617 are mounted on different heatsinks (not shown) in order that vibrations can be applied to one or the other or, independently, to both, using separate vibration actuators.

FIG. 6C is a side-view cross-sectional block diagram of a reflective diffuser system 603 having a reflective diffuser 614 on a heatsink substrate 611, diffuser 614 being surrounded by a bottom-side secondary parabolic reflector 634, a top-side primary parabolic reflector 631, a planar reflector 617 on the heatsink substrate 611 to reflect the initially diffused input light 652 back to the top parabolic reflector 631, which the reflects that light 652 back to the focus location 609 on the diffuser, one or more lasers mounted to the heatsink substrate to emit light through holes in the substrate, and an optional light guide at the output aperture through the parabolic reflector, according to some embodiments of the present invention. In some embodiments, heatsinked diffuser and laser assembly 670 includes heatsink 611, reflective diffuser 614, planar reflector 617, parabolic reflector 634, one or more lasers 121, and optionally a vibration actuator (such as vibration actuator 621 shown in FIG. 6A). Other aspects and reference numbers of FIG. 6C are as described above for FIG. 6A. In some embodiments of system 603, the diffused light from the reflective diffuser is partly recycled in a similar manner as in FIG. 6A. In some embodiments, the smaller-angle diffused light is reflected and collimated by the first (primary) parabolic reflector 631 on the top of FIG. 6C. The light is collimated and directed toward the second (secondary) parabolic reflector 634 on the bottom of FIG. 6C. That light 635 is then reflected by the second parabolic reflector and focused to the center aperture 632 of the first parabolic reflector 631, as shown, where aperture 632 is provided for the light 635 to exit—in some embodiments, entering into light guide 658 and later exit as output light 657, or, in other embodiments, simply exiting through aperture 632 as a divergent beam diverging from a spot size the same as the laser spot at location 609 on the diffuser 614. In this arrangement, the laser spot at location 609 on the diffuser 614 is at the focus of the first parabolic reflector 631 and aperture 632 of the first parabolic reflector 631 is at the focus of the second parabolic reflector 634. Similar to the other embodiments of the other figures, in some embodiments, an optional vibration is applied to the first parabolic reflector 631, reducing the amount of speckles.

FIG. 6D is a bottom-view block diagram of reflective diffuser system 603 having a heatsink substrate 611, one or more lasers 121 mounted to the heatsink substrate 611 to emit their respective laser beams 141 through holes 625 (see FIG. 6C) in the substrate 611, according to some embodiments of the present invention. In some embodiments, the plurality of lasers 121 is arranged as one or more rings of lasers 121 spaced around a center of the substrate 611.

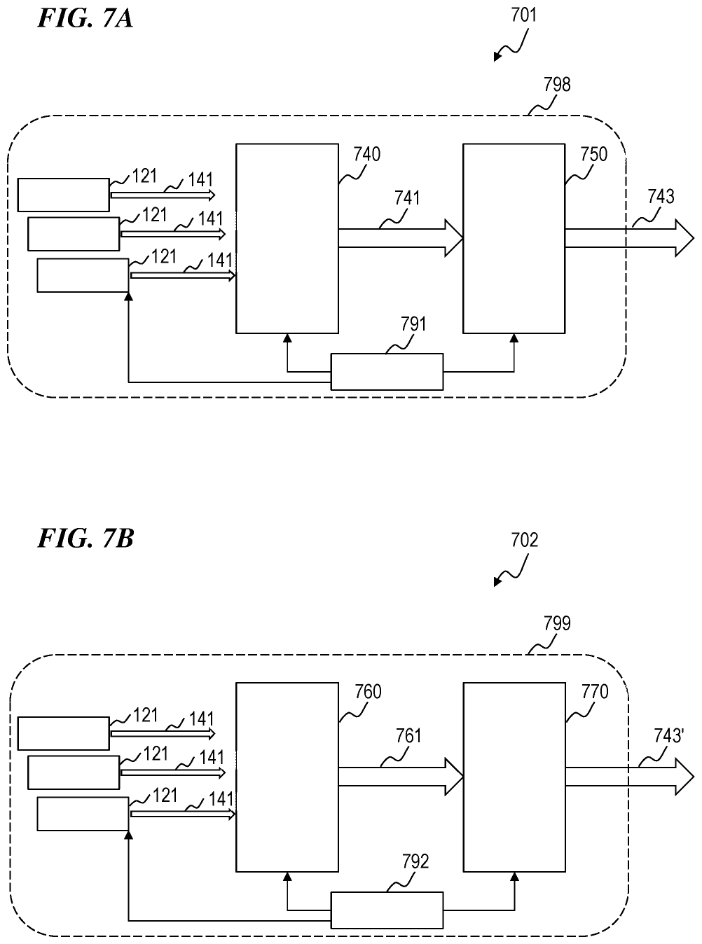

FIG. 7A is a block diagram of a system 701 having one or more lasers 121 that output a plurality of laser beams 141, respectively, into one or more diffuser systems 740 (each including a diffuser system such as systems 301, 401, 402, 501, 502, 503, 503′, 504, 505, 506, 601, 602, or 603 of FIGs. 3, 4A, 4B, 5A, 5B, 5C1, 5C2, 5D, 5E, 5F, 6A, 6B, or 6C respectively), wherein the one or more diffuser systems 740 form intermediate light output 741 into one or more modulator and/or projection optics systems 750. In other embodiments, LED-based or other light sources are used in addition to, or in place of, lasers 121. In some embodiments, one or more controllers 791 control operation of the one or more lasers 121, the one or more diffuser systems 740 and/or the one or more modulator and/or projection optics systems 750. In some embodiments, system 701 includes a vehicle- or land-based system 798 onto which the other components are mounted.

FIG. 7B is a block diagram of a system 702 having one or more lasers 121, one or more phosphor and/or diffuser systems 760 (each including a diffuser system such as systems 101, 106, 107, or 201 of FIG. 1A, 1F, 1G, or 2A respectively), wherein the one or more phosphor and/or diffuser systems 760 form intermediate light output 761 into one or more modulator and/or projection optics systems 770. In some embodiments, one or more controllers 792 control operation of the one or more lasers 121, the one or more phosphor and/or diffuser systems 760 and/or the one or more modulator and/or projection optics systems 770. In some embodiments, system 702 includes a vehicle (such as an automobile, battleship, aircraft or boat) or land-based system (such as a movie theater or advertisement billboard) 799 onto which the other components are mounted. In some embodiments, the present invention includes some or all of the systems of FIG. 7A or FIG. 7B. In some embodiments, some or all features of the various embodiments herein are combined with features of other embodiments.

To summarize some main points, some embodiments of the invention provide the following features: In some laser-illumination systems, it is desirable to lower the coherent properties of the laser beam so that speckles, which are viewed as optical noise, and focusing properties, which may cause eye damage, are diminished. While trying to achieve these, in some embodiments, it is desirable to preserve the brightness of the laser beam as much as possible. One practical method for reducing speckles is to use a moving diffuser. The major parameters of the diffusers include diffusion angles, power-density limitations, absorption coefficients, heat-dissipation capacities, and other properties. One of the important parameters is the diffusion angle. Larger angles imply a larger amount of diffusion. Larger diffusion amounts allow slower diffuser movement to achieve the same amount of speckle reduction. On the other hand, a larger amount of diffusion increases the diffusion angle, thus increasing the etendue, and lowering the brightness of the system. Therefore, in some embodiments, it is desirable to provide a system with large diffusion angles, but with reduced etendue.

In some embodiments, the present invention includes a laser illumination system in which a diffuser with optional movement and/or vibration is used to reduce speckles associated with the coherent properties of the laser, and a focusing optical recycling system is used to reduce the etendue.

In some embodiments, the present invention provides an apparatus that includes: a first light-diffuser structure; a first laser that generates a first laser beam having a first wavelength, wherein the first laser beam is directed toward the first light-diffuser structure; and a light-recycling reflector assembly, wherein the light-recycling reflector assembly includes an exit aperture through which output light from the light-diffuser structure is emitted, and wherein light-recycling reflector assembly reflects, back toward the first light-diffuser structure, at least some light from the first light-diffuser structure that does not exit through the exit aperture.

Some embodiments further include a vibration actuator operatively coupled to impart a vibration to at least one of the first light-diffuser structure, the first laser and the light-recycling reflector assembly. Some embodiments further include a heatsink thermally coupled to at least one of the first light-diffuser structure, the first laser and the light-recycling reflector assembly. Some embodiments further include a second light-diffuser structure; and a second laser that generates a second laser beam having a second wavelength that is different than the first wavelength, wherein the second laser beam is directed toward the second light-diffuser structure. Some embodiments further include a second laser that generates a second laser beam having a second wavelength that is different than the first wavelength, wherein the second laser beam is directed toward the first light-diffuser structure. Some embodiments further include a second laser that generates a second laser beam having the first wavelength, wherein the second laser beam is directed toward the first light-diffuser structure.

In some embodiments, the first light-diffuser structure includes a ceramic light diffuser. In some embodiments, the first light-diffuser structure includes a plurality of spaced-apart light-diffusing layers. In some embodiments, the first light-diffuser structure includes an LED assembly that includes a phosphor wavelength-conversion layer. In some embodiments, the first light-diffuser structure includes a transmissive phosphor plate. In some embodiments, the first light-diffuser structure includes a reflective phosphor plate. In some embodiments, the first light-diffuser structure includes a ceramic diffuser. In some embodiments, the first light-diffuser structure includes a metal diffuser. In some embodiments, the first light-diffuser structure includes a glass diffuser. In some embodiments, the first light-diffuser structure includes a polymer diffuser. In some embodiments, the first light-diffuser structure includes a multi-layer dielectric reflector. In some embodiments, the light-recycling reflector assembly is made with metal. In some embodiments, the light-recycling reflector assembly is made with a polymer. In some embodiments, the light-recycling reflector assembly is made with a glass. In some embodiments, the light-recycling reflector assembly is made with fused silica. In some embodiments, the light-recycling reflector assembly includes a flat reflector, and a first parabolic reflector facing the flat reflector. In some embodiments, the light-recycling reflector assembly includes a flat reflector, a first parabolic reflector facing the flat reflector, and a second parabolic reflector facing the first parabolic reflector. In some embodiments, the light-recycling reflector assembly includes a conical reflector, and a first parabolic reflector facing the conical reflector. In some embodiments, the light-recycling reflector assembly includes a conical reflector, a first parabolic reflector facing the conical reflector, and a second parabolic reflector facing the first parabolic reflector. In some embodiments, the first laser includes a semiconductor diode laser. In some embodiments, the first laser includes an optical fiber laser. In some embodiments, the first laser includes a crystal-rod laser.

In some embodiments the present invention is used in applications such as projectors, automotive headlights, spot lights, entertainment spot lights, GOBO projectors (a “gobo” (which stands for ‘goes before optics’) “is a stencil or template placed inside or in front of a light source to control the shape of the emitted light. Lighting designers typically use them with stage lighting instruments to manipulate the shape of the light cast over a space or object—for example to produce a pattern of leaves on a stage floor.” [Wikipedia]), general lighting, and architectural lighting.

In various embodiments, the present invention includes one or more reflector optics and/or diffusers from FIGS. 1A-1G and/or 2A-2D, combined with one or more reflector optics and/or phosphor plates from FIGS. 5A-5F and/or 6A-6D. For example, in some embodiments, a phosphor plate such as described in FIGS. 5A-5F and/or 6A-6D is substituted for or added to a diffuser in one of the embodiments such as described in FIGS. 1A-1G and/or 2A-2D. In some embodiments, the phosphor plate is used for, or added to, the transmissive diffuser of the embodiments of FIGS. 3A-3B and/or 4A-4B. In some other embodiments, the phosphor plate is used for, or added to, the reflective diffuser of the embodiments of FIG. 4A, 4B, 5A-5F or 6A-6C 8A, 8B, 9A-9H, 10A, 10B, or 11A-11C.

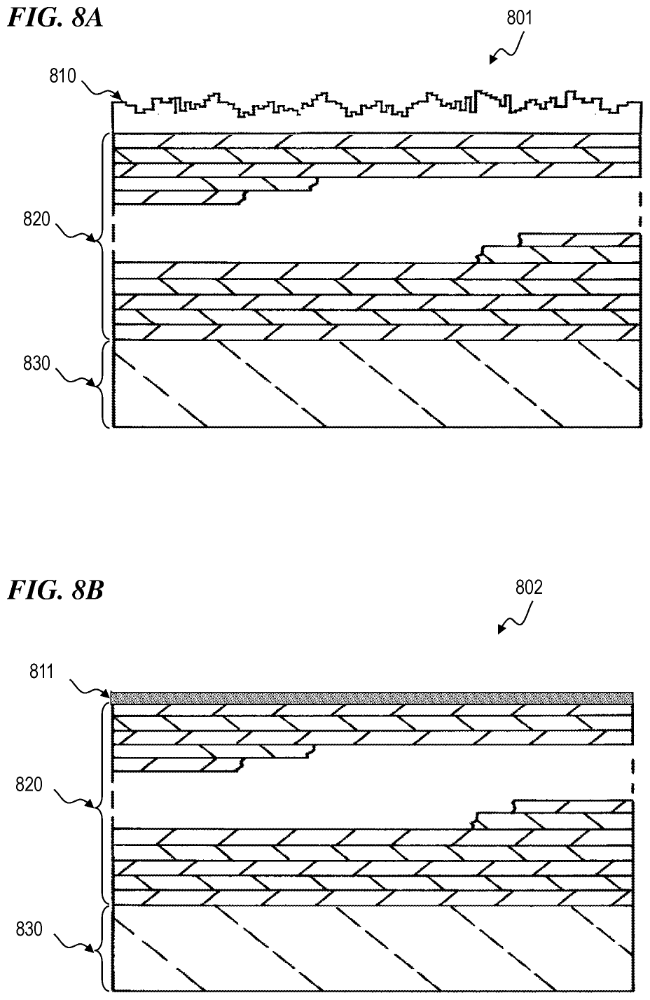

FIG. 8A is a block diagram of a reflective multi-layer dielectric diffuser system 801 having a lithographically-defined dielectric diffuser layer 810 formed on a dielectric-layer stack 820 operatively coupled to a heatsink 830, according to some embodiments of the present invention. In some embodiments, the dielectric multi-layer stack 820 is formed using one or more of the methods for creating highly reflective optics such as described in U.S. Pat. No. 5,907,436 to Perry et al. titled “Multilayer dielectric diffraction gratings”, and/or U.S. Pat. No. 6,709,119 to Gillich et al. titled “Resistant surface reflector”. Rather than forming a diffraction-grating structure as the top layer as described in U.S. Pat. No. 5,907,436 to Perry et al. and/or U.S. Pat. No. 6,709,119 to Gillich et al., some of the embodiments for the reflective diffuser 514 or 614 such as shown in FIG. 5A-5F or 6A-6C, respectively, used in the present invention instead form a random or pseudo-random two-dimensional pattern of phase-shifting (e.g., in some embodiments, a Cartesian array or other pattern of varying heights/thicknesses of the dielectric top layer 810) in the top lithographically-defined dielectric diffuser layer 810 (such as pseudo-random phase-shift grating element 129 of FIG. 4 of U.S. Pat. No. 5,454,004 to Leger, titled “Phase grating and mode-selecting mirror for a laser”) in order to define a designed non-Lambertian pattern for the diffused-reflected light.

FIG. 8B is a block diagram of a reflective multi-layer dielectric diffuser system 802 having a ceramic diffuser layer 811 formed on a dielectric-layer stack 820 operatively coupled to a heatsink 830, according to some embodiments of the present invention. Again, in some embodiments, the dielectric multi-layer stack 820 is formed using one or more of the methods for creating highly reflective optics such as described in U.S. Pat. No. 5,907,436 to Perry et al. titled “Multilayer dielectric diffraction gratings”, and/or U.S. Pat. No. 6,709,119 to Gillich et al. titled “Resistant surface reflector” which are both incorporated herein by reference. Rather than forming a diffraction-grating structure as the top layer as described in U.S. Pat. Nos. 5,907,436 and/or 6,709,119, some of the embodiments for the reflective diffuser 514 or 614 such as shown in FIG. 5A-5F or 6A-6C, respectively, used in the present invention instead use a thin layer of ceramic for diffuser layer 811, such as Accuflect® Light-Reflecting Ceramic described above.

In some embodiments, reflective multi-layer dielectric diffuser system 801 or 802 is used for any of the diffuser elements described herein. In some embodiments, the diffuser plate or structure of reflective diffuser 514 or 614 or 914 such as shown in FIG. 5A-5F or 6A-6C or 9A-11C, respectively, includes either reflective multi-layer dielectric diffuser system 801 of FIG. 8A or reflective-ceramic multi-layer dielectric diffuser system 802 of FIG. 8B. Still other embodiments further include a phosphor layer (not shown) on top of layer 810, or between layer 810 and layer stack 820 of system 901 of FIG. 8A, or on top of layer 811, or between layer 810 and layer stack 820 of system 802 of FIG. 8B.

In some embodiments, the reflective surfaces of the dome reflectors, the orthogonal-parabolic reflectors, the parabolic reflectors and/or the planar reflectors described herein include multi-layer dielectric stacks such as described in U.S. Pat. No. 5,907,436 to Perry et al.

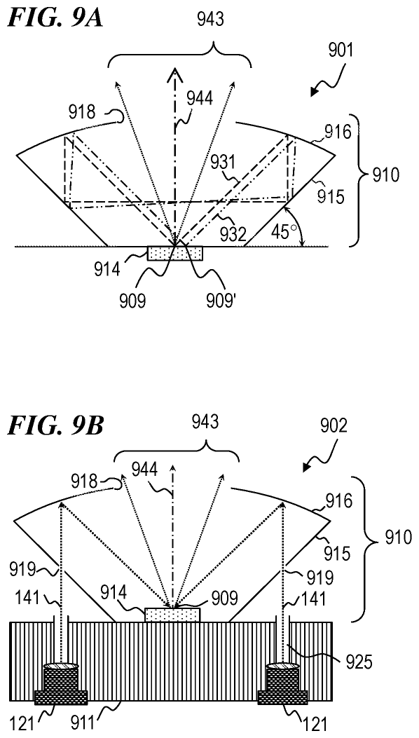

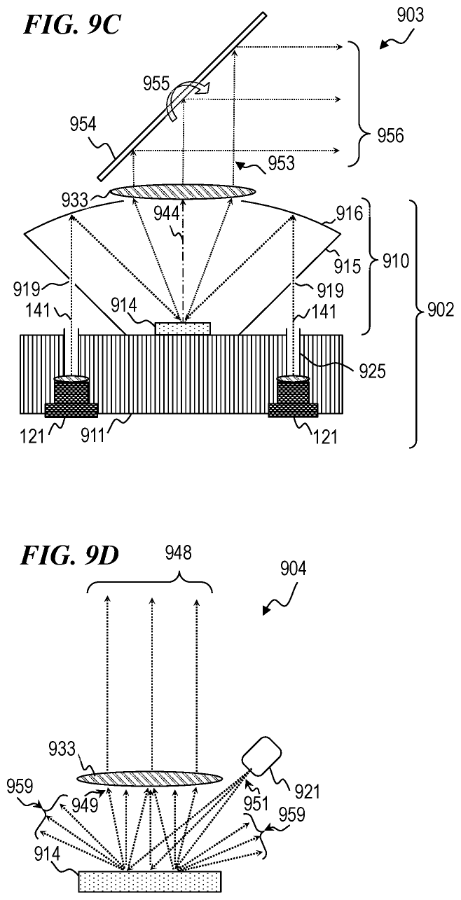

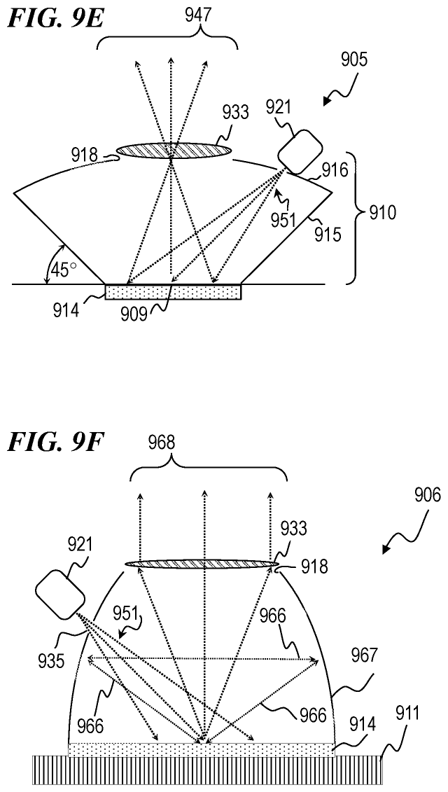

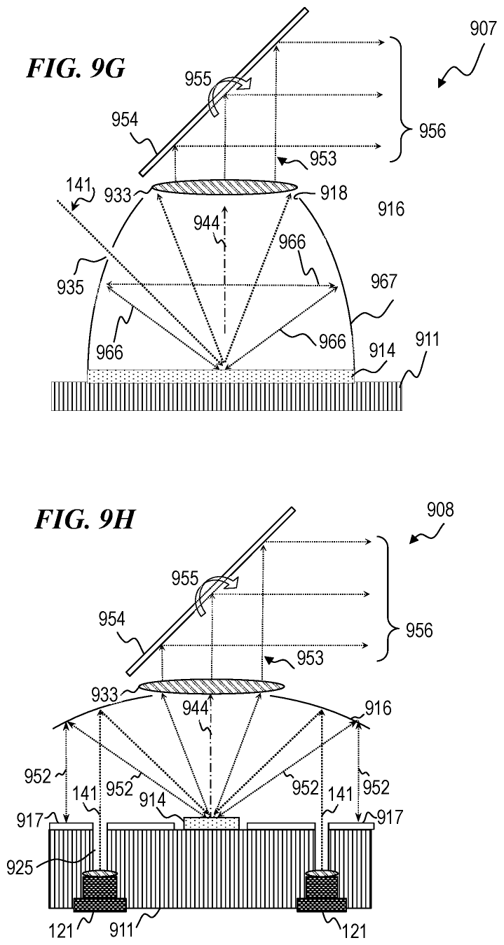

FIG. 9A is a side-view cross-sectional block diagram of a system 901 having a compound recycling reflector 910 that includes a parabolic reflector 916 and a conical reflector 915 along the same optical axis 944 such that light is focused toward a central phosphor and/or diffuser plate 914, according to some embodiments of the present invention. Recycling light increases the brightness of a light source. When laser light is diffused, recycling of the diffused light also increases the brightness of the diffused light output. To understand the operation of system 901, consider recycling ray 931 from the focus 909 of the parabolic reflector 916 and reflected by parabolic reflector 916 (vertically downward in FIG. 9A) towards conical reflector 915. The 45-degree conical reflector 915 changes the path of the light from vertical to horizontal as shown. The light is then reflected (vertically upward in FIG. 9A) by the opposite side of conical reflector 915 and reflected by parabolic reflector 916 again towards focus 909, completing the recycling process. Since there are a total of four reflections (an even number of reflections), if one considers this as an imaging system, the image will be “upright” in the same orientation of the object. This can be demonstrated by considering recycling ray 932 starting from the off-focus point 909′ next to the focus 909. Following the path and reflections of recycling ray 932, it can be shown that recycling ray 932 ends up at the same off-focus point 909′. From a given point within a certain distance from the focus 909, any light emitted from that point is recycled back to the same point. This shows that efficient recycling can be obtained even if the incoming laser spot is not at the focus 909 of parabolic reflector 916, allowing much larger tolerance in the assembly process. The small-angle light (i.e., light within a small angle to center axis 944) will exit the aperture 918 contributing to the output light 943 of system 901.

In some embodiments, the phosphor, LED, and/or diffuser (PLD) plate 914 (of FIGS. 9A-9H), includes a phosphor plate that is excited (pumped) by a laser beam 141 and the phosphor in the phosphor plate emits light of one or more wavelengths that are longer than the wavelength of the pump laser beam 141. In some embodiments, the PLD plate 914 includes a light-emitting-diode (LED) assembly that includes a short-wavelength LED covered with a phosphor layer that is excited (pumped) by light from the short-wavelength LED from underneath and by a short-wavelength laser beam 141 from above, and the excited phosphor in the phosphor layer emits light of one or more longer wavelengths. In some embodiments, the PLD plate 914 includes one or more diffuser layers that diffuses light from a laser beam 141 and/or an LED assembly. In some embodiments, the PLD plate 914 includes one or more diffuser layers and an LED assembly. In some embodiments, the PLD plate 914 includes one or more diffuser layers and a phosphor plate. In some embodiments of the systems of FIG. 5A-5F or 6A-6D, any of the PLD plates described in this paragraph are substituted for reflective diffuser plates 514 or 614 in the systems of FIG. 5A-5F or 6A-6D, respectively. In some embodiments of the systems of FIG. 1A, 1F, 1G, or 2A, any of the PLD plates described in this paragraph are substituted for reflective phosphor plates 112.

FIG. 9B is a side-view cross-sectional block diagram of a system 902 having a compound recycling reflector 910 that includes a parabolic reflector 916 and a conical reflector 915, both along the same optical axis 944. System 902 also includes a heatsink 911 with one or more laser diodes 121 that each emit a respective laser beam 141 through openings 925 in the heatsink 911 and through openings 919 in the conical reflector 915 to impinge on the parabolic reflector 916, reflecting toward phosphor plate, LED, and/or diffuser plate 914 located at focus 909 of parabolic reflector 916, according to some embodiments of the present invention. Although two lasers 121 are shown here, in various embodiments, the number of lasers is one or more, such as the arrangements shown in FIG. 1B, FIG. 1E or FIG. 2B.

FIG. 9C is a side-view cross-sectional block diagram of a system 903 having a compound recycling reflector 910 that includes a parabolic reflector 916 and a conical reflector 915 along the same optical axis 944, also including a heatsink 911 with one or more laser diodes 121 that emit a respective laser beam 141 through openings 925 in the heatsink 911 and through openings 919 in the conical reflector 915 to impinge on the parabolic reflector 916, reflecting toward a central phosphor plate, LED, and/or diffuser plate 914, and having an intermediate output 953 from collimating optics 933 such as a projection lens (in other embodiments (not shown), a collimating reflector is used) directed toward a scanning mirror 954 that scans in a one-dimensional (1D) pattern or a two-dimensional (2D) pattern 955 that forms a scanning output beam 956, according to some embodiments of the present invention. In embodiments that use a mirror 954 that scans a 1D pattern, the output light 956 is scanned along a line, while in other embodiments that use a mirror 954 that scans a 2D pattern, the output light 956 is scanned across an area (such as a raster-scanned area).

In various embodiments, collimating optics 933 and scanning mirror 954 are used as additional output optics for any of the other embodiments describe herein.

FIG. 9D is a side-view cross-sectional block diagram of a system 904 having a scanning laser source 921 (such as, for example, system 903 shown in FIG. 9C or the like) that scans the scanning laser light 951 (in various embodiments, having one or more laser beams of one or more colors/wavelengths) across a phosphor plate, LED, and/or diffuser plate 914, and then the low-angle diffused light 949 from phosphor plate, LED, and/or diffuser plate 914 is collected and shaped through a projection lens 933 to form projected a scanning light beam 948, according to some embodiments of the present invention. In some embodiments, projection lens 933 projects light collected from the scanned focused spot as a beam 948. As shown in FIG. 9D, without light recycling, all the high-angle light 959 not collected by the projection lens 933 is lost, lowering the efficiency of the system 904.

FIG. 9E is a side-view cross-sectional block diagram of a system 905 having a scanning laser source 921 (such as system 903 shown in FIG. 9C or the like) that scans the scanning laser light 951 from laser source 921 toward a central phosphor plate, LED, and/or diffuser plate 914 through an opening in a compound recycling reflector 910 (including a parabolic reflector 916 and a conical reflector 915 along the same optical axis) such that light 951 is scanned toward central phosphor plate, LED, and/or diffuser plate 914, and then the diffused light from plate 914 is shaped through projection lens 933, forming the output scanning beam 947, according to some embodiments of the present invention. In some embodiments, the use of compound recycling reflector 910 recycles the high-angle light (e.g., light 959 of FIG. 9D that leaks out of that system 904) back to be added to the moving laser spot of scanned light 951, increasing the efficiency of system 905. In some embodiments, one of the useful features of such a system (such as system 905) is that the recycling reflectors produce upright images so that the recycled spot coincides with the original spot.

FIG. 9F is a side-view cross-sectional block diagram of a system 906 having an orthogonal parabolic recycling reflector 967 and a light source 921 with one or more stationary or scanning laser beams 951 of one or more colors propagating through one or more openings 935 in the orthogonal parabolic recycling reflector 967 (although one opening 935 is shown here, other embodiments include a plurality of such openings 935 spaced around the reflector 967 to allow a plurality of scanning laser beams 951 to enter), wherein the recycling light 966 goes through two reflections, which is an even number of reflections, producing an upright image, so as to allow the recycled spot(s) to coincide with the respective original stationary or scanned spot(s), producing an output scanning beam 968, according to some embodiments of the present invention. This means the recycled spot coincides with the original spot, producing the enhanced-brightness scanning beam 968.

FIG. 9G is a side-view cross-sectional block diagram of a system 907 having an orthogonal parabolic recycling reflector 967 and one or more laser beams 141 of one or more colors propagating through one or more openings 935 in the orthogonal parabolic recycling reflector 967, wherein the recycling light goes through two reflections, wherein the system 907 also includes a projection lens 933 and a scanning mirror 954, (which, in some embodiments, is a 1D or 2D scanning mirror that rotates around line or point 955) to produce a scanning output beam 956, according to some embodiments of the present invention. In some embodiments, system 907 is a similar system to system 906, except that in system 907 the recycling is performed using orthogonal parabolic reflector 967, which is also an upright image recycling reflector.

FIG. 9H is a side-view cross-sectional block diagram of a system 908 having a parabolic reflector 916 and a heatsink 911 with one or more laser diodes 121 that emit laser beams 141 through openings 925 in heatsink 911 to impinge on the parabolic reflector 916, reflecting toward a phosphor, LED and/or diffuser plate 914, the heatsink 911 having a planar reflector 917 that directs recycled light 952 from the central phosphor, LED and/or diffuser plate 914 (light diffused from this source that has not exited the recycling system, but rather has been reflected by parabolic reflector 916 to planar reflector 917, from whence back to parabolic reflector 916) back toward plate 914. In some embodiments, system 908 has an intermediate output beam 953 formed by projection lens 933 and directed toward scanning mirror 954 that forms a scanning output beam 956, according to some embodiments of the present invention. In system 908, the light recycling is performed by the combination of parabolic reflector 916 and planar reflector 917.

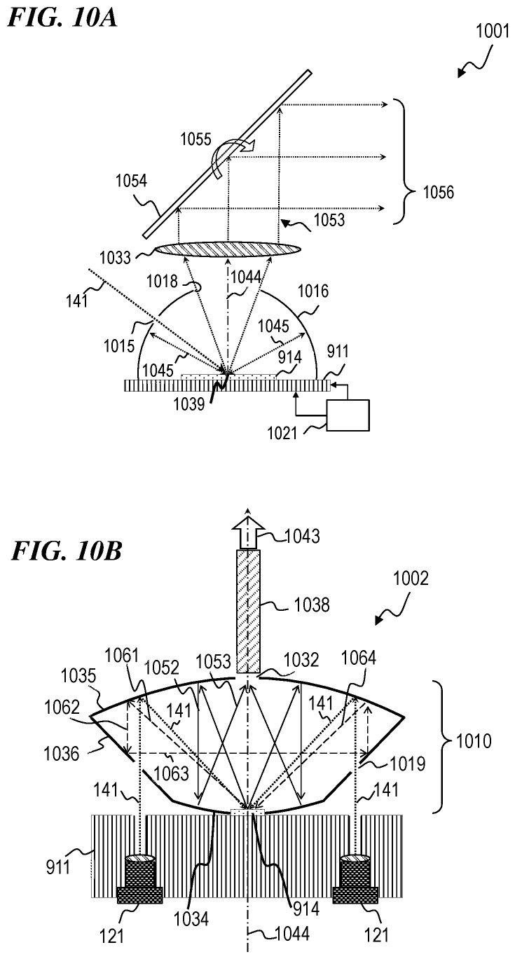

FIG. 10A is a side-view cross-sectional block diagram of a system 1001 having a dome (spherical) recycling reflector 1016 (optionally having a vibration mechanism), a heatsink 911 with a phosphor, LED and/or diffuser plate 914 mounted to heatsink 911 (optionally having a vibration mechanism 1021), and source(s) of one or more laser beams 141 coming through one or more openings 1015 in dome recycling reflector 1016 to impinge on the phosphor, LED and/or diffuser plate 914, with the light from laser-excited phosphor, LED and/or diffuser plate 914 reflecting off the dome recycling reflector 1016 toward phosphor, LED and/or diffuser plate 914, wherein system 1001 has an intermediate output 1053 from projection lens 1033 directed toward a scanning mirror 1054 that scans in a one-dimensional (1D) or two-dimensional (2D) pattern 1055 that forms a scanning output beam 1056, according to some embodiments of the present invention.

FIG. 10B is a side-view cross-sectional block diagram of a system 1002 having a compound recycling reflector 1010 that includes a first parabolic reflector 1035 and a conical reflector 1036 and a further second parabolic reflector 1034 on a heatsink 911, all along the same optical axis 1044, also including one or more laser diodes 121 that emit collimated laser light 141 through openings in the heatsink 911 and through openings 1019 in the conical reflector 1036 to impinge on first parabolic reflector 1035, reflecting toward a central phosphor, LED and/or diffuser (PLD) plate 914 surrounded by the second parabolic reflector 1034. The second parabolic reflector 1034 receives low-angle light 1052 collimated from first parabolic reflector 1035 and reflects and focuses intermediate focused output light 1053 directed through aperture 1032 in the first parabolic reflector 1035 toward a light guide 1038, according to some embodiments of the present invention. The high-angle light 1061 is reflected by first parabolic reflector 1035 and collimated as light 1062 (in a downward vertical direction in FIG. 10B) to conical reflector 1036, which reflects the light horizontally as light 1063 to the opposite side of conical reflector 1036, where it reflects (in an upward vertical direction in FIG. 10B) and reflects from first parabolic reflector 1035 as light 1064 back to PLD plate 914. The low-angle light reflected by first parabolic reflector 1035 is collimated as light 1052 (in a downward vertical direction in FIG. 10B) back to second parabolic reflector 1034 that, in some embodiments, has the same focal length as first parabolic reflector 1035 and that is used to reflect such collimated light 1052 back in an upward focused direction such that the light 1053 is focused at the aperture 1032 in first parabolic reflector 1035 for outputting the light. In some embodiments, as shown, the focused output light 1053 upon reaching the focus of the second parabolic reflector 1034 is coupled into a light guide 1038, which then outputs light 1043. Such arrangement provides an efficient way of collecting, recycling, and coupling light from a large-angle source (e.g., PLD plate 914) into a light guide 1038 with a small numerical aperture without the use of any lenses. In some embodiments, system 1002 is more efficient and cost-effective as compared to an equivalent lens-based system, since highly accurate and efficient lenses are expensive.

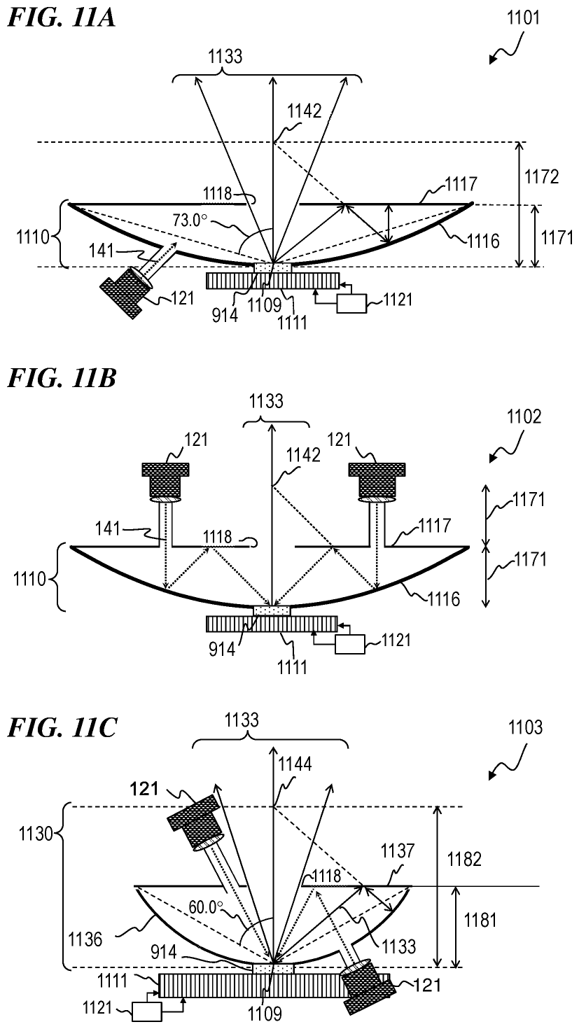

FIG. 11A is a side-view cross-sectional block diagram of a system 1101 having a compound recycling reflector 1110 (having a parabolic reflector 1116 and a planar reflector 1117), a phosphor, LED and/or diffuser plate 914 on a heatsink 1111 with optional vibration 1121, according to some embodiments of the present invention. In system 1101, the recycling of light is done by using two reflectors—parabolic reflector 1116 and planar reflector 1117. In some embodiments, the light source (PLD plate 914) is an LED, a diffuser and/or a phosphor plate excited by a laser beam, that is placed at the apex of parabolic reflector 1116. In some embodiments, planar reflector 1117 is placed in the middle (i.e., half way at distance 1171) between the apex and the focus location 1142 of parabolic reflector 1116 (which has a focal length 1172). The planar reflector 1117 has an aperture 1118 where the output 1133 from the light source exits system 1101 within the cone angle determined by the diameter of aperture 1118 and the focal length 1172. When the high-angle output from PLD plate 914 (the diffused-light source) is reflected by planar reflector 1117, the reflected light is at the same angle as if it were coming from the focus 1142, and as a result it will be reflected by parabolic reflector 1116 into the direction of the optical axis, which is also perpendicular to planar reflector 1117. Upon reflection by planar reflector 1117, the beam retraces itself back to the parabolic reflector 1116, the planar reflector 1117, and then back to PLD plate 914, completing the recycling process. The recycled light will be scattered by PLD plate 914 with a percentage of light directed toward the aperture 1118, increasing the output intensity. The rest of the scattered light will be recycled again, together with the light from PLD plate 914. In some embodiments, laser light 141 from one or more lasers 121 is directed through openings in parabolic reflector 1116 (as shown here) and/or through openings in planar reflector 1117 (as shown in FIG. 11B) and directed either directly onto PLD plate 914, or indirectly via one or more reflections from parabolic reflector 1116 and/or planar reflector 1117 onto PLD plate 914. In some embodiments, laser beam 141 is focused to as small a spot as desired at location 1109 using the appropriate optical system—for example, one or more lenses adjacent to laser 121. In some embodiments, heatsink 1111 is in thermal contact with some or all of the outer surface of parabolic reflector 1116 and/or bottom-side lasers 121. In some embodiments, a further heatsink (not shown) is in thermal contact with some or all of the outer surface of planar reflector 1117 and/or top-side lasers 121 that are shown in FIG. 11B without showing heatsinks.

FIG. 11B is a side-view cross-sectional block diagram of a system 1102 having a compound recycling reflector 1110 (having a parabolic reflector 1116 and a planar reflector 1117), a phosphor, LED and/or diffuser (PLD) plate 914 on a heatsink 1111 with optional vibration 1121, and one or more lasers 121 that emit laser beams 141 through openings 1118 in planar reflector 1117, according to some embodiments of the present invention. The laser beam 141 in this case is collimated and is focused onto the diffuser plate 914 by the parabolic reflector 1116. In system 1102, the light source is excited using laser diodes. One or more laser diodes 121 each generate a respective collimated output beam 141 parallel to the optical axis that is directed through small apertures in the planar reflector 1117 such that beam 141 is reflected by parabolic reflector 1116 and focused onto the focus 1142 of reflector 1116. Since planar reflector 1117 is placed between the apex and the focus 1142 of the parabolic reflector 1116 (“blocking” the beam reflected from reflector 1116 from reaching the focus 1142), planar reflector 1117 redirects the beam to PLD plate 914 at the apex, which is the “reflector image” of the focus. The rest of the operation is the same as that of FIG. 11A.

FIG. 11C is a side-view cross-sectional block diagram of a system 1103 having a compound recycling reflector 1130 (having a spherical (dome) reflector 1136 and a planar reflector 1137), a phosphor, LED and/or diffuser plate 914 on a heatsink 1111 with optional vibration 1121, and one or more lasers 121 that emit laser beams 141 through openings 1118 in planar reflector 1135 and/or dome reflector 1137, according to some embodiments of the present invention. In some embodiments, laser beam 141 is focused to as small a spot as desired at location 1109 using the appropriate optical system, for example one or more lenses adjacent to laser 121. System 1103 includes a spherical reflector 1136 and planar reflector 1137 that is placed at a distance 1181 equal to half the radius of curvature of the spherical reflector 1136 from the focus 1144 and the bottom. The planar reflector 1137 has an aperture 1118 where the output from the diffuse-light source 914 exits the system within the cone angle determined by the diameter of the aperture 1118 and the focal length 1182. When the output from diffuse-light source 914 is reflected by the planar reflector 1137, the angle of the reflected light will be the same as if it were coming from the focus 1144 and as a result, it will be reflected by the spherical reflector 1136 back to the direction of the focus 1144, retracing itself back to the light source, completing the recycling process. The recycled light will be scattered by diffuse-light source 914 with a percentage of light directed toward aperture 1118, increasing the output intensity. The rest of the scattered light will be recycled again together with the light from light source 914. Similar to the arrangement shown in FIG. 11B but not shown here, one or more lasers 121 can be used to excite diffused-light source 914 with the same arrangement of lasers 121 and apertures 1118 in the planar reflector 1137 shown in FIG. 11B.

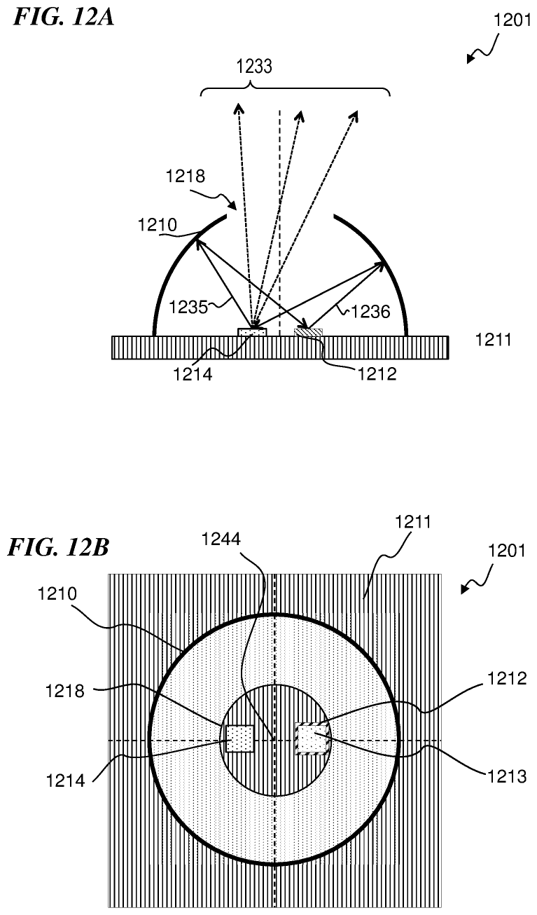

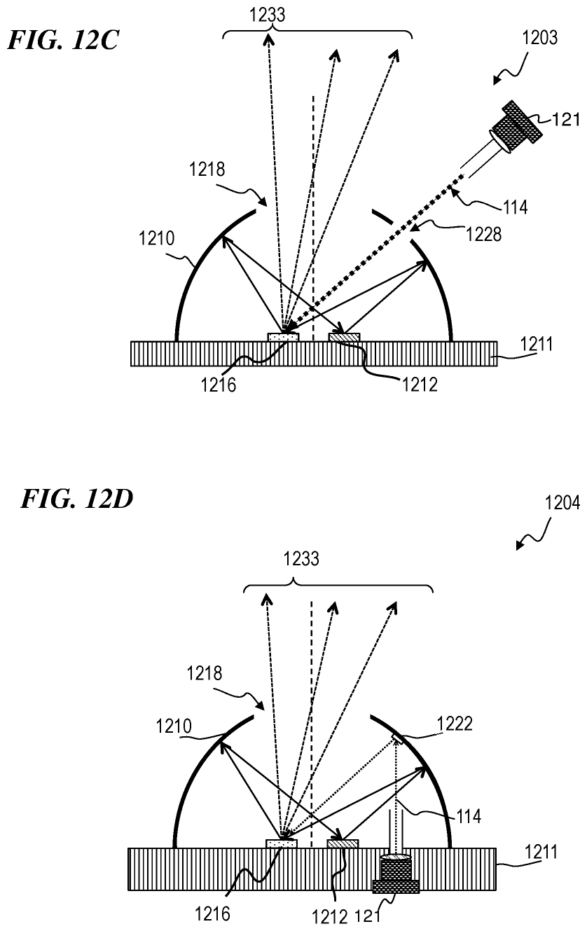

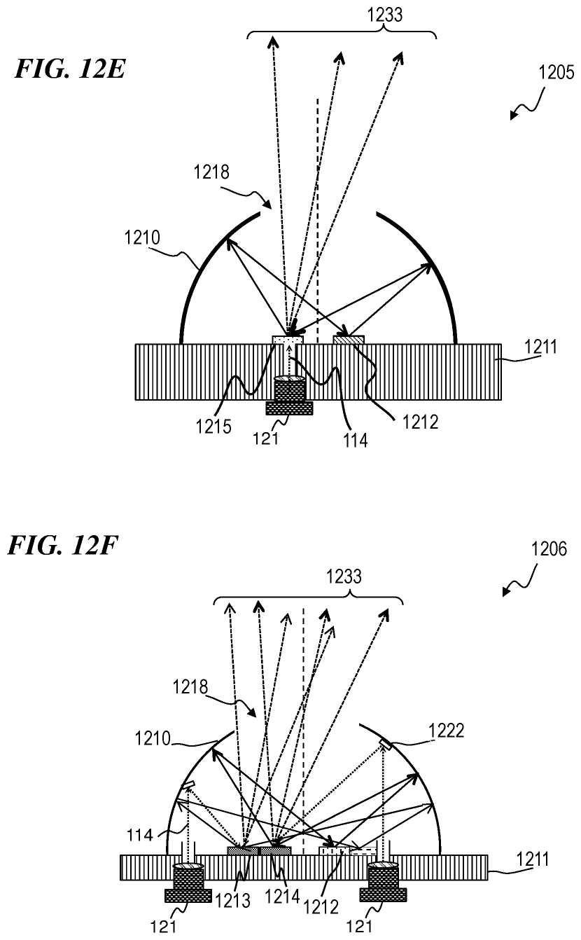

FIG. 12A is a cross-sectional elevation-view block diagram of a light source 1201, according to some embodiments of the present invention. In some embodiments, light source 1201 includes a includes a spherical concave reflector 1210 (in other embodiments, a toroidal or elliptical concave reflector is used), an LED 1214, and a planar specular reflector 1212 (such as a flat mirror coated with metal or multi-layer dielectric coating of the proper wavelengths under consideration or to be emphasized). In some embodiments, the low-emission-angle portion 1233 of the light output of LED 1214 (that portion of the emitted light that is along the emission axis perpendicular to the top face of the LED die or at relatively small angles to that emission axis) is directed out of the aperture 1218 (the opening at the top of the dome reflector shown in FIG. 12A) as the primary output. The remaining high-angle portion 1235 of the LED light output (that portion of the emitted light that is at larger angles to the emission axis perpendicular to the top face of the LED die) is reflected by spherical concave reflector 1210 and imaged onto the specular reflector 1212, wherein the LED 1214 and the specular reflector 1212 are placed symmetrically on opposite sides of the center of curvature of the spherical concave reflector 1210. The reflected light 1236 from specular reflector 1212 is reflected by spherical concave reflector 1210 and imaged back onto the LED 1214. Since there is no scattering in the reflected light from specular reflector 1212, the high-angle rays remain at a high angle and will be reflected by specular reflector 1212 back to the spherical concave reflector 1210, and not through the aperture 1218, and refocused by spherical dome reflector 1210 back onto LED 1214 itself, completing the first cycle of the light recycling. Part of the recycled light is scattered by LED 1214 and redirected to smaller angles closer to the emission axis that is perpendicular to the top face of LED 1214, adding to the output through aperture 1218 of system 1201. The rest of the scattered light will be recycled again and the cycle of light recycling repeats. In some embodiments, LED 1214 includes a phosphor, that is excited by pump light from a blue LED that is part of LED 1214, and also by pump wavelengths in an unconverted portion of the blue pump light in the recycled light.

FIG. 12B is a top-view block diagram of light source 1201 (which is shown in a cross-section side view in FIG. 12A), according to some embodiments of the present invention. In some embodiments, the high-angle portion of the light output of LED 1214 is reflected by spherical concave reflector 1210 and imaged onto specular reflector 1212. LED 1214 and specular reflector 1212 are placed symmetrically on opposite sides of the center of curvature of spherical concave reflector 1210. In the case shown in FIG. 12A and FIG. 12B, specular reflector 1212 is shown to have the same dimensions as LED 1214. In other embodiments, the sizes of LED 1214 and specular reflector 1212 differ.

FIG. 12C is a cross-sectional elevation-view block diagram of a light source 1203, according to some embodiments of the present invention, where the LED 1214 of light source 1201 of FIGS. 12A and 12B is replaced by a laser-excited phosphor plate 1216, such that when the phosphor in phosphor plate 1216 is excited by laser beam 114 from laser 121, light of one or more longer wavelengths will be emitted from the phosphor in phosphor plate 1216. In some embodiments, emitted and diffused light from phosphor plate 1216 appears to the human eye to be very similar to the output of the LED 1214 of FIGS. 12A and 12B, although the laser pump light 114 diffused from phosphor plate 1216 has a much narrower linewidth that pump light from a blue LED such as in system 1201. The operation of the system 1203 is similar to that of system 1201 described for FIG. 12A. As shown in FIG. 12C, the excitation laser beam 114 enters system 1203 through a small aperture 1228 in concave reflector 1210. In other embodiments, other optical arrangements for directing the laser beam 114 onto phosphor plate 1216 are used, depending on the desired arrangement of system 1203. In some embodiments, more than one laser 121 is used (e.g., in some embodiments, laser beams 114 from a plurality of lasers 121 are directed though a plurality of apertures 1218 onto one or more phosphor plates 1216 for higher-power operations). In some embodiments, phosphor plate 1216 is replaced by, or combined with, a diffusive structure. In some embodiments, a plurality of phosphor plates and/or diffusive structures 1216 is provided (along with a corresponding set of specular reflectors 1212 each located on an opposite side of the center axis from the respective phosphor plate 1216), each phosphor plate or diffusive structure 1216 emitting and/or diffusing one or more different colors of light, and each being pumped by one or more laser beams 114 (see, for example, FIG. 12F described below).

FIG. 12D is a cross-sectional elevation-view block diagram of a light source 1204, according to some embodiments of the present invention, wherein one or more excitation lasers 121 is/are placed on, in, and/or under heatsink 1211 with a through-opening for each laser 121 in heatsink 1211 through which the laser beams 114 from the one or more lasers 121 propagate such that the laser beams 114 reflect from the dome reflector 1210 or other laser reflector 1222 located on or under dome reflector 1210 towards a corresponding one or more phosphor structures or diffusive structures 1216. Light source 1204 also includes a specular reflector 1212, having functions as described above for FIG. 12A.

FIG. 12E is a cross-sectional elevation-view block diagram of a light source 1205, according to some embodiments of the present invention. In some embodiments, phosphor plate 1215 is a transmissive type and placed over the aperture through which the laser beam 114 propagates, in order to capture the output of the laser beam for the emission of light of longer wavelengths than the wavelength of the laser beam, where the wavelength-converted light is emitted at the top of the transmissive phosphor plate 1215. Other aspects of the operation of the system 1205 are similar to comparable operations of other embodiments (e.g., as shown in FIG. 12C and FIG. 12D).

FIG. 12F is a cross-sectional elevation-view block diagram of a light source 1206 having a plurality of phosphor structures 1213 . . . 1214, each emitting light of a different selected color when pumped by a suitable laser beam 114, according to some embodiments of the present invention. Other aspects of the operation of the system 1206 are similar to comparable operations of other embodiments (e.g., as shown in FIG. 12C, FIG. 12D, and FIG. 12E).

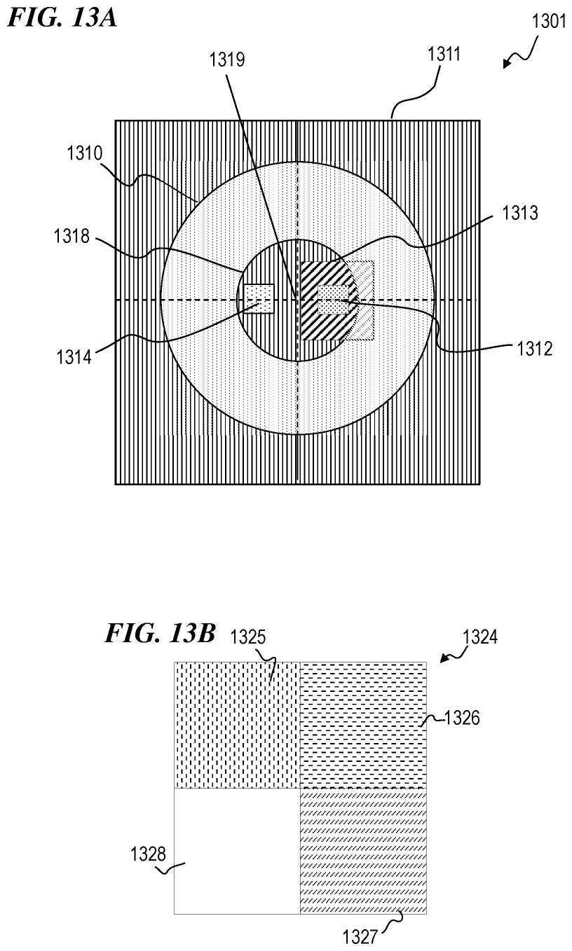

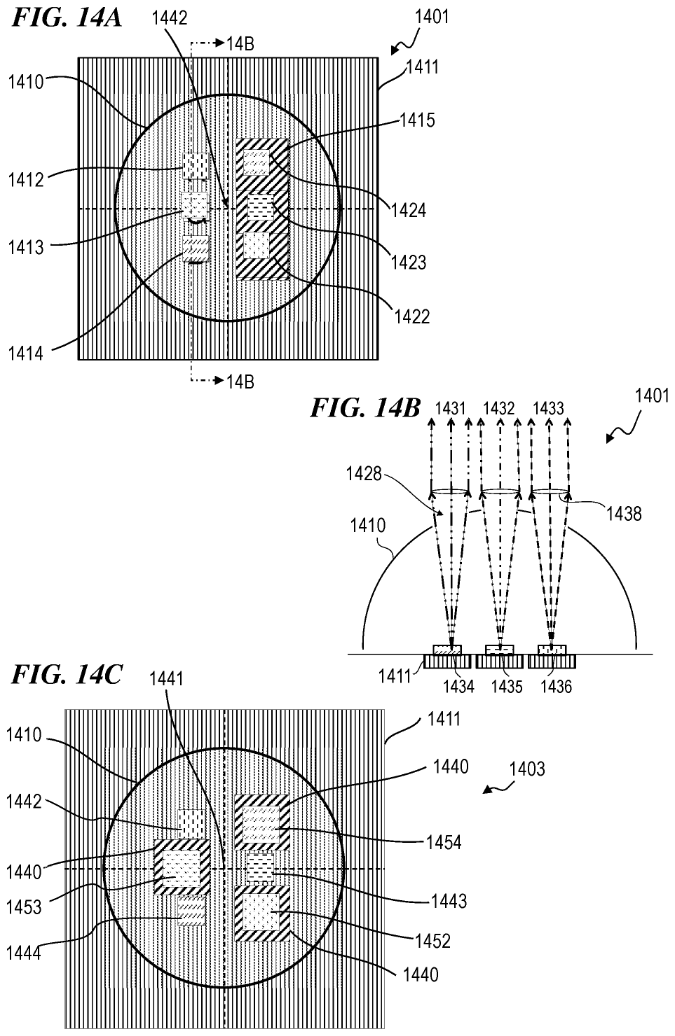

FIG. 13A is a top-view block diagram of light source 1301 according to some embodiments of the present invention. In some embodiments, light source 1301 includes a heatsink 1311, a spherical dome reflector 1310 having a centrally located top aperture 1318, an LED or phosphor plate 1314 that emits light reflected by spherical dome reflector 1310 to form an image 1312 on specular reflector 1313. In actual implementations of some embodiments of light sources 1201, 1203, 1204, 1205 and 1206, each specular reflector 1212 is replaced by a larger reflector 1313 that is larger than the expected image 1312 of LED 1314 (or reflective phosphor plate 1216 of FIG. 12C or transparent phosphor plate 1215 of FIG. 12E) formed by high-angle reflections from the inner surface of spherical dome reflectors 1210 toward the specular reflectors 1212, as shown in FIG. 14A, such that light will not be lost due to misalignment of respective specular reflector 1212 with respect to the image of LED 1214 or phosphor plate 1216, which may be caused by imprecise placement of LED 1214 or phosphor plate 1216 and/or the respective specular reflector 1212 relative to their respective desired locations.

FIG. 13B is a top-view diagram of a four-color LED assembly 1324 that includes a red-light-emitting LED 1325, a green-light-emitting LED 1326, blue-light-emitting LED 1327 and white-light-emitting LED 1328, according to some embodiments of the present invention. In some embodiments, the flat chip-type LED 1214 shown in FIGS. 12A and 12B described above is replaced by a composite LED package with one or more different-colored LED chips, such as a red-green-blue-white (RGBW) LED assembly 1324 with four colored chips, packaged together as shown in FIG. 13B (note that the particular arrangement of the four chips, next to each other, may vary). In some embodiments, four-color LED assembly 1324 is substituted for LED or phosphor plate 1314 of FIG. 13A, and in this case, the output light from each chip LED 1325, 1326, 1327 and 1328 is imaged at the specular reflector 1313 and then reflected back to itself after reflections from the specular reflector 1313 and the concave reflector dome 1310.

FIG. 14A is a cross-sectional top-view block diagram of a light source 1401, according to some embodiments of the present invention, where a set of red, green, and blue (RGB) LEDs 1412, 1413, and 1414, respectively, each individually packaged, are used. In some embodiments, light source 1401 includes dome reflector 1410 mounted on heatsink 1411, along with red LED 1412, green LED 1413 and blue LED 1414, whose respective images 1422, 1423, and 1424 are formed on specular reflectors 1415. For higher-power applications, where heat dissipation is of the utmost importance, in some embodiments, the LEDs that emit red, green, blue, and/or white-colored light (e.g., see FIG. 13B) are packaged individually such that they can be heat sunk independently such as shown in FIG. 14A and FIG. 14C, with larger heatsinks (and/or spaced further apart from one another on a larger heatsink area on a common heatsink 1411) for each LED. By the imaging properties of the spherical concave reflector 1410, the corresponding images of the RGB LEDs on the left are shown on the right with reversed orders (note that top-to-bottom on the left, the LED colors are red-green-blue, while top-to-bottom on the right, the images on the specular reflectors are blue-green-red). In some embodiments, the specular reflector 1415 is made large enough to cover all three images 1422, 1423, and 1424 of the RGB LEDs. In some embodiments, the recycling process is similar to descriptions stated above for FIGS. 12A-12F. The end result is that each colored RGB LED is used for recycling its own light output independently, without interacting with the other LEDs or their images.

FIG. 14B is a cross-sectional side-view block diagram of light source 1401 shown in FIG. 14A, according to some embodiments of the present invention, where the outputs 1431, 1432, and 1433, respectively, of the RGB LEDs 1412, 1413, and 1414, respectively, exiting the apertures 1428 above the LEDs are collimated using three individual collimating lenses 1438 outside the spherical concave reflector 1410, providing three colored beams of light with increased brightness due to light recycling by internal reflections in spherical concave reflector 1410.

FIG. 14C is a cross-sectional top-view block diagram of a light source 1403, according to some embodiments of the present invention, in which the three RGB LEDs 1442, 1443, and 1444, respectively are placed triangularly (in some embodiments, each LED at the same distance from the center of curvature 1441 of the spherical dome reflector 1410), with the specular reflectors 1440 placed symmetrically opposite to the respective LEDs (in some embodiments, each specular reflector 1440 is located at the same distance from the center of curvature 1441 of the spherical dome reflector 1410). As shown by this embodiment, in general, any number of LEDs can be placed at any positions desired, as long as there is a matching location opposite to the locations of the LEDs for the placement of the specular reflectors 1440. In practice, it is preferred to have the LEDs 1442 . . . 1444 in close proximity to the center of curvature 1441 such that the imaging of the LEDs by the spherical concave reflector 1410 will have minimal distortion, since distortion will lower the efficiency of the system. In some embodiments, when large spacing between the LEDs is needed, a spherical concave reflector with larger diameter is used, such that the distortions of the images remain acceptable. In addition to spherical reflectors such as 1410, other embodiments use toroidal or elliptical reflectors to minimize distortion and maximize the recycling efficiency of the system. Similar to that shown in FIG. 14B, in some embodiments, apertures and collimating lenses are added to provide three collimated different-colored beams of light. In general, any suitable number of beams of light can be created using various colored LEDs.

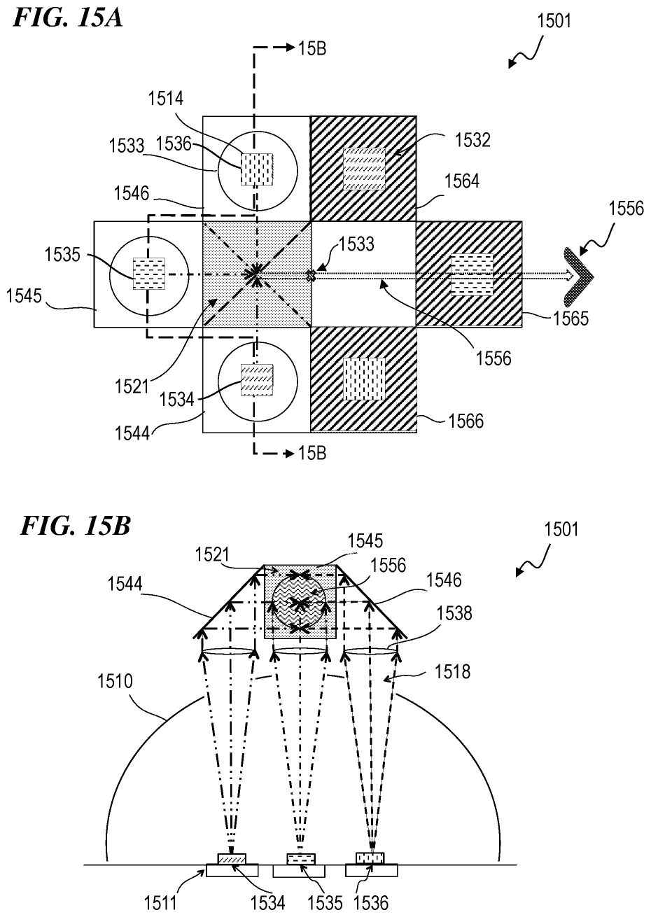

FIG. 15A is a cross-sectional top-view block diagram of a light source 1501, according to some embodiments of the present invention, where the three colored beams from red LED 1536, green LED 1535 and blue LED 1534 are combined into a single output beam 1556 (propagating toward the right in FIG. 15A) using a X-Cube 1521. In some embodiments, the red LED 1536, green LED 1535 and blue LED 1534 are arranged such that their path lengths are the same for all colors when they exit the X-Cube 1521.

FIG. 15B is a cross-sectional side-view block diagram of light source 1501, according to some embodiments of the present invention, in which the three beams exiting spherical concave reflector 1510 through apertures 1518 are collimated, reflected by their respective 45-degree mirrors, enter the X-Cube, and exit as a combined single beam 1556 (coming toward the viewer in FIG. 15B). In some embodiments, light source 1501 includes spherical concave dome reflector 1510 that reflects high-angle light from the red LED 1536, green LED 1535 and blue LED 1534 and images that light onto specular reflectors as images 1554, 1555 and 1556, respectively, and those images are recycled back to the red LED 1536, green LED 1535 and blue LED 1534, respectively to add to the combined output light 1556.

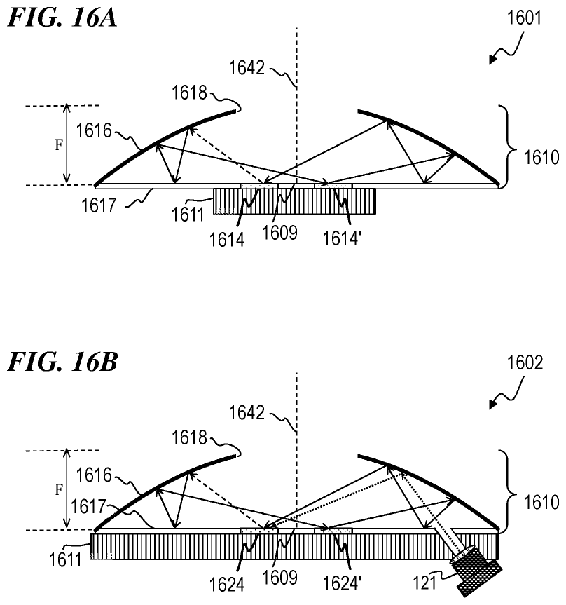

FIG. 16A is a cross-sectional side-view block diagram of a light source 1601, according to some embodiments of the present invention, where the spherical concave reflector (e.g., reflector 1210 of FIG. 12A) is replaced by a parabolic reflector 1616 and large specular reflector 1617. In some embodiments, light source 1601 includes a combined recycling reflector assembly 1610 that includes parabolic reflector 1616 and large specular reflector 1617, and LED 1614 is placed on heatsink 1611 on one side of the optical axis of rotation 1642 and the image 1614′ will be formed on specular reflector 1617 at the opposite side of the axis of rotation. The initial high-angle light for recycling is shown as a light ray represented by the broken-line arrow. By following the path of the light shown by solid-line arrows, the high-angle output light of the LED 1614 whose image 1614′ is formed on specular reflector 1617, as shown, is being redirected back to the LED 1614 itself, completing the process of light recycling. In some embodiments, LED 1614 includes a phosphor, that is excited by pump light from a blue LED, and also by pump wavelengths in an unconverted portion of the blue pump light in the recycled light.

FIG. 16B is a cross-sectional side-view block diagram of a light source 1602, according to some embodiments of the present invention, where the spherical concave reflector (e.g., reflector 1210 of FIG. 12A) is replaced by combined recycling reflector assembly 1610 that includes parabolic reflector 1616 and large specular reflector 1617, and where the LED (e.g., LED 1614 of FIG. 16A) is replaced by a laser-excited phosphor plate 1624 whose image 1624′ is formed on specular reflector 1617 as shown, with the excitation laser 121 placed under the specular reflector 1617 and heatsink 1611. In other embodiments, laser 121 is otherwise situated.

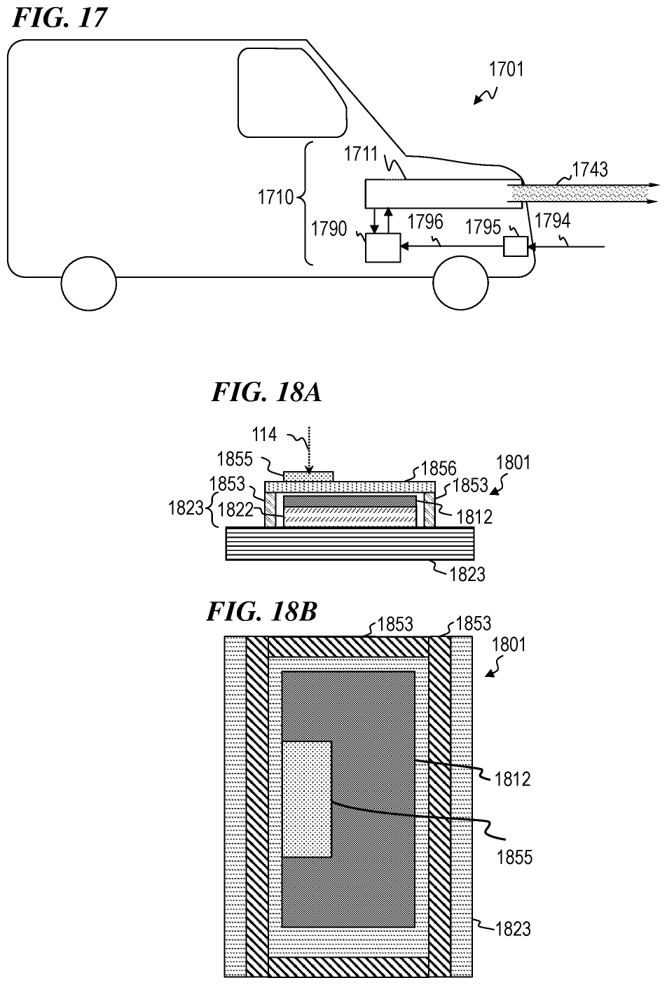

FIG. 17 is a block diagram of a vehicle 1701 that includes a smart headlight system 1710 having an LED/laser-pumped-phosphor light source 1711, according to some embodiments of the present invention. In some embodiments, light source 1711 outputs a headlight beam 1743, and signals 1794 are received by sensor 1795 are processed to signals 1796 that are coupled to controller 1790 that controls LED/laser-pumped-phosphor light source 1711, In some embodiments, LED/laser-pumped-phosphor light source 1711 includes one or more of the light sources described herein in order to take advantage of the light recycling of the present invention to improve headlight beam 1743.

In another aspect, FIG. 17 is a block diagram of a vehicle 1701 that includes an LED/laser-pumped-phosphor light source 1711, according to some embodiments of the present invention. In some embodiments, a scene sensor 1795 is configured to actively (e.g., using LiDAR or the like) and/or passively (using a camera or the like) sense the environment around the vehicle 1701 in which LED/laser-pumped-phosphor light source 1711 is housed, and the received signals or data 1794 received by sensor 1795 are processed into sensed data 1796 and operatively coupled to processor 1790, which then adjusts the shape, direction and/or intensity of various low-beam, high-beam and/or extreme-high-beam portions of headlight beam 1743. In some embodiments, this sensing/controlling function is optionally activatable and deactivatable by the human driver (analogous to automobile “cruise control”).

FIG. 18A is a side-cross-sectional-view block diagram of an LED/laser-pumped-phosphor light source assembly 1801, according to some embodiments of the present invention. In some embodiments, assembly 1801 includes a blue-light LED 1822 affixed to heatsink 1823, a phosphor layer 1812 affixed to, or deposited on, blue-light LED 1822, a transparent heatsink window 1856 affixed to a heat-conductive surrounding wall 1853 that surrounds a perimeter of (but is separated by a gap from) blue-light LED 1822 and phosphor layer 1812, and a crystal phosphor plate 1855 that is smaller than phosphor layer 1812 and affixed to a portion of transparent heatsink layer 1856. In some embodiments, a laser beam 114 is directed onto crystal phosphor plate 1855. Besides phosphor layer 1812 on LED 1822, assembly 1801 has the additional layer of crystal phosphor 1855 affixed on top of a portion of transparent heatsink layer 1856, which covers blue-light LED 1822 and phosphor layer 1812. In some embodiments, assembly 1801 has heat-conductive surrounding wall 1853 that surrounds the entire perimeter of (but is separated by a gap from) blue-light LED 1822 and phosphor layer 1812, and is covered and sealed by transparent heatsink window 1856, thus sealing blue-light LED 1822 and phosphor layer 1812. In some embodiments, the additional crystal phosphor plate 1855 covers only a portion (in some embodiments, less than half) of the outer surface of phosphor layer 1812, from which it is separated by transparent heatsink window 1856. In some embodiments, transparent heatsink window 1856 is made of sapphire, quartz, or other suitable material, such that blockage of light emitted from the LED is minimized. In some embodiments, transparent heatsink 1855 is in turn mounted on heatsink wall 1853 around LED assembly 1822-1812, such that heat from phosphor plate 1856 is conducted away to LED heatsink 1823 through transparent heatsink window 1856. In some embodiments, transparent heatsink window 1856 is made of a transparent heatsink material such as synthetic diamond or aluminum oxynitride (AlON ceramic, such as ALON-brand by Surmet Corp., or such as described in U.S. Pat. No. 4,520,116 by Gentilman et al. titled “Transparent aluminum oxynitride and method of manufacture” or U.S. Pat. No. 4,686,070 by Maguire, et al. titled “Method of producing aluminum oxynitride having improved optical characteristics,” or the like). In other embodiments, where a sealed compartment is not required, transparent heatsink layer 1856 can use a perforated metal such as an aluminum honeycomb plate, or aluminum sheet having etched or punched holes therethrough, or the like. In some embodiments, LED/laser-pumped-phosphor light source assembly 1801 is substituted in place of any of the LEDs, diffusers, phosphor plates, or PLD structures described herein.

FIG. 18B is a plan-view block diagram of LED/laser-pumped-phosphor light source assembly 1801, according to some embodiments. In some embodiments, LED/laser-pumped-phosphor light source assembly 1801 is substituted in place of any of the LEDs, diffusers, phosphor plates, or PLD structures described herein. In some embodiments, laser beam 114 (see FIG. 18A) impinges on a center area of the phosphor layer 1855 to provide increased light intensity in that one center area of the phosphor layer 1855 such that the output intensity profile is not uniform, but now includes a “hot spot” (an area of higher light output intensity) within the illuminated area. In some embodiments, laser beam 114 is used to additionally pump the center portion of the phosphor 1812 of the LED 1822, producing an additional or alternative hot spot. In some embodiments, LED 1822 (e.g., in some embodiments, an LED that emits light of a blue color with a center wavelength in the range of about 420 nm to about 490 nm) is mounted to a heatsink 1823 that conducts heat away from LED 1822 and dissipates that heat to the local environment. In some embodiments, LED 1822 is covered by a phosphor layer 1812 that absorbs some of the light of the LED 1822 and re-emits light of a longer wavelength (e.g., in some embodiments, absorbing blue LED light in the range of about 420 nm to about 490 nm and re-emitting yellow light having a peak center wavelength in a range of about 520 nm to about 660 nm). The combination of some unconverted blue light and some light converted to yellow light produces a light that appears to the human eye as white light. Thus, LED assembly 1823 can be considered as a white-light-emitting LED (also called a white LED assembly 123).

As used herein, when diffuse light comes from a structure (such as a PLD structure), the structure can be considered as a “source” of the diffuse light, and the process can be considered as one in which the structure “outputs” the diffuse light, or “emanates” the diffuse light or, in the case where a phosphor is excited by a laser or LED source of pump light, the structure “emits” the diffuse light.

In some embodiments, the present invention provides a first apparatus (such as shown, for example, in FIG. 1A-1F, 2A-2D, 3A-3B, 4A-4D, 5A-5F, 6A-6D, 9A-9H, or 10A-10B) that includes: a light source having a diffuser having a first face and a second face opposite the first face, wherein the diffuser is arranged to receive and diffuse laser light at a first location on the first face of the diffuser; and a first reflector that has a curved concave face located facing the first face of the diffuser and configured to reflect at least some of the diffused laser light back toward the first location in order to increase a brightness of the diffused laser light.

Some embodiments of the first apparatus further include a heatsink (e.g., heatsink 111 of FIG. 1A) thermally coupled to the diffuser and configured to spread and dissipate heat from the laser light.

In some embodiments of the first apparatus (such as shown, for example, in FIGS. 4A-4D), the diffuser is a transmissive diffuser that outputs diffused light from the second face of the transmissive diffuser and wherein the curved concave face of the first reflector faces and is closer to the first face than the second face of the diffuser.

Some embodiments of the first apparatus further include a second reflector (e.g., reflector 436 of FIG. 4C) has a curved concave face located facing the second face and configured to reflect at least some of the diffused laser light back toward the first location, wherein the diffuser (e.g., diffuser 412 of FIG. 4C) is a transmissive diffuser that outputs diffused light from the second face of the transmissive diffuser, and wherein the curved concave face of the first reflector (e.g., reflector 416 of FIG. 4C) faces and is closer to the first face than the second face of the diffuser.

In some embodiments of the first apparatus, the diffuser is a transmissive diffuser that outputs diffused light from the second face of the transmissive diffuser and wherein the first reflector includes a spherical dome reflector (e.g., reflector 416 of FIG. 4A) that faces and is closer to the first face than the second face of the diffuser.

In some embodiments of the first apparatus, the diffuser is a transmissive diffuser that outputs diffused light from a second face of the transmissive diffuser opposite the first face and wherein the first reflector (e.g., reflector 426 of FIG. 4B) includes an orthogonal-parabolic light-recycling reflector that faces and is closer to the first face than the second face of the diffuser.

Some embodiments of the first apparatus further include a second reflector (e.g., reflector 436 of FIG. 4C) that is curved and located facing the second face and configured to reflect at least some of the diffused laser light back toward the first location, wherein the diffuser is a transmissive diffuser that outputs diffused light from the second face of the transmissive diffuser, wherein the first reflector includes a spherical dome reflector that faces and is closer to the first face than the second face of the diffuser, and wherein the second reflector includes a spherical dome reflector that faces and is closer to the second face than the first face of the diffuser.

Some embodiments of the first apparatus further include a second reflector (e.g., reflector 446 of FIG. 4D) that is curved and located facing the second face and configured to reflect at least some of the diffused laser light back toward the first location, wherein the diffuser is a transmissive diffuser that outputs diffused light from the second face of the transmissive diffuser, wherein the first reflector includes an orthogonal-parabolic light-recycling reflector that faces and is closer to the first face than the second face of the diffuser, and wherein the second reflector includes an orthogonal-parabolic light-recycling reflector that faces and is closer to the second face than the first face of the diffuser.

In some embodiments of the first apparatus (such as shown, for example, in FIG. 1A-1G, 2A-2D, 5C1-5F, 6A-6D, 9A-9H, or 10A-10B), the diffuser is a reflective diffuser that directs diffused light from the first face of the reflective diffuser and wherein the first curved reflector faces and is closer to the first face than the second face of the diffuser.

Some embodiments of the first apparatus (such as shown, for example, in FIGS. 5D2, 5E, 5F) further include at least a first laser that emits the laser light; a second reflector located and configured to reflect the laser light from the first laser toward the first location, wherein the diffuser is a reflective diffuser that outputs diffused light from the first face of the transmissive diffuser, and wherein the first reflector faces and is closer to the first face than the second face of the diffuser.

In some embodiments of the first apparatus (such as shown, for example, in FIGS. 5C1, 5C2, 5E, 10A), the diffuser is a reflective diffuser that outputs diffused light from the first face of the reflective diffuser, and the first reflector includes a spherical dome reflector that faces and is closer to the first face than the second face of the diffuser.

In some embodiments of the first apparatus (such as shown, for example, in FIGS. 5C1, 5C2, 5E, 9G), the diffuser is a reflective diffuser that outputs diffused light from the first face of the reflective diffuser, and wherein the first reflector includes an orthogonal-parabolic light-recycling reflector that faces and is closer to the first face than the second face of the diffuser.

Some embodiments of the first apparatus (such as shown, for example, in FIGS. 6A, 6B) further include: at least a first laser that emits the laser light; a second reflector that has a flat face located and configured to reflect light from the first reflector back toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIGS. 6A, 6B, 6C) further include: at least a first laser that emits at least a portion of the laser light; and a second reflector that has a flat face located and configured to reflect light from the first reflector back toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIGS. 6B, 6C) further include: a heatsink; a plurality of lasers mounted to the heatsink, wherein each one of plurality of lasers emits a portion of the laser light toward the first reflector; and a second reflector that has a flat face located and configured to reflect light from the first reflector back toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIG. 6C) further include: a heatsink; a plurality of lasers mounted to the heatsink, wherein each one of plurality of lasers emits a portion of the laser light toward the first reflector; a second reflector that has a flat face located and configured to reflect light from the first reflector back toward the first reflector; and a third reflector that has a concave parabolic reflective face; wherein the diffuser is a reflective diffuser that outputs diffused light from the first face of the diffuser, wherein the first reflector is a parabolic reflector that faces the second reflector and collimates light from the diffuser toward the second reflector and third reflector, and that receives reflected collimated light from the second reflector and focuses that light toward the diffuser, and wherein the first reflector also faces the third reflector and collimates light from the diffuser toward the third reflector that is located and configured to reflect and focus collimated light from the first reflector back toward an aperture in the first reflector.

Some embodiments of the first apparatus (such as shown, for example, in FIG. 9B) further include: a heatsink; a plurality of lasers mounted to the heatsink, wherein each one of plurality of lasers emits a portion of the laser light toward the first reflector; and a second reflector that has an inside conical reflective face located and configured to reflect light from the first reflector back toward the inside conical reflective face and then toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIG. 9C) further include: a heatsink; a plurality of lasers mounted to the heatsink, wherein each one of plurality of lasers emits a portion of the laser light toward the first reflector; a second reflector that has an inside conical reflective face located and configured to reflect light from the first reflector back toward the inside conical reflective face and then toward the first reflector; a collimating optical element located to receive light from an aperture in the first reflector and configured to collimate that light into a collimated intermediate beam; and a third reflector that rotates about at least one rotational axis and that is configured to reflect the collimated intermediate beam to form a scanned output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIG. 9E) further include: a scanning laser that outputs a scanning laser beam toward the diffuser; a second reflector that has an inside conical reflective face located and configured to reflect light from the first reflector back toward the inside conical reflective face and then toward the first reflector; and collimation optics located to receive light from an aperture in the first reflector and configured to collimate that light into a collimated intermediate output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIG. 9F) further include: a scanning laser that outputs a scanning laser beam toward the diffuser; and collimation optics located to receive light from an aperture in the first reflector, wherein the first reflector has an inside orthogonal-parabolic reflective face located and configured to reflect light from the diffuser across toward an opposite surface of the inside orthogonal-parabolic reflective face and then toward the diffuser, wherein the diffuser is a reflective diffuser that outputs diffused light from the first face of the diffuser, and wherein the collimation optics are configured to collimate light from the aperture in the first reflector into a scanned output beam.

Some embodiments of the first apparatus (such as shown, for example, in FIG. 9G) further include: a laser that outputs the laser light toward the diffuser; collimation optics located to receive light from an aperture in the first reflector and configured to form a collimated intermediate beam; and a second reflector that rotates about at least one rotational axis and that is configured to reflect the collimated intermediate beam to form a scanned output beam, wherein the first reflector has an inside orthogonal-parabolic reflective face located and configured to reflect light from the diffuser across toward an opposite surface of the inside orthogonal-parabolic reflective face and then toward the diffuser, wherein the diffuser is a reflective diffuser that outputs diffused light from the first face of the diffuser, and wherein the collimation optics are configured to collimate light from the aperture in the first reflector into a scanned output beam.

Some embodiments of the first apparatus (such as shown, for example, in FIG. 9H) further include: a heatsink; a plurality of lasers mounted to the heatsink, wherein each one of plurality of lasers emits a portion of the laser light toward the first reflector; a second reflector that has a flat face located and configured to reflect light from the first reflector back toward the first reflector; collimation optics located to receive light passing through an aperture in the first reflector and configured to form a collimated intermediate beam; a third reflector that rotates about at least one rotational axis and that is configured to reflect the collimated intermediate beam to form a scanned output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

Some embodiments of the first apparatus (such as shown, for example, in FIG. 10A) further include: collimation optics located to receive light passing through an aperture in the first reflector and configured to form a collimated intermediate beam; a second reflector that rotates about at least one rotational axis and that is configured to reflect the collimated intermediate beam to form a scanned output beam; and a laser that outputs the laser light, wherein the diffuser is a reflective diffuser that includes a phosphor and outputs emissive light from the phosphor from the first face of the reflective diffuser, and wherein the first reflector includes a spherical dome reflector that faces and is closer to the first face than the second face of the diffuser.

Some embodiments of the first apparatus (such as shown, for example, in FIG. 10B) further include: a heatsink; a plurality of lasers mounted to the heatsink, wherein each one of plurality of lasers emits a portion of the laser light toward the first reflector; a second reflector that has an inside conical reflective face located and configured to reflect light from the first reflector back toward the inside conical reflective face and then toward the first reflector; and a third reflector that has a concave parabolic reflective face, wherein the diffuser includes a phosphor plate mounted to the heatsink, wherein the phosphor plate outputs emissive light having wavelengths longer than the laser light, wherein the first reflector is a parabolic reflector that faces the second reflector and collimates light from the diffuser toward the second reflector and third reflector, and that receives reflected collimated light from the second reflector and focuses that light toward the diffuser, wherein the second reflector reflects collimated light from the first reflector toward an opposite inside surface of the second reflector that then reflects the light toward the first reflector, and wherein the first reflector also faces the third reflector and collimates light from the diffuser toward the third reflector that is located and configured to reflect and focus collimated light from the first reflector back toward an aperture in the first reflector.

Some embodiments of the first apparatus (such as shown, for example, in FIG. 10B) further include: a heatsink; a plurality of lasers mounted to the heatsink, wherein each one of plurality of lasers emits a portion of the laser light toward the first reflector; a second reflector that has an inside conical reflective face located and configured to reflect light from the first reflector back toward the inside conical reflective face and then toward the first reflector; a third reflector that has a concave parabolic reflective face; and a light guide operatively coupled to receive output light passed out through an output aperture in the first reflector, wherein the diffuser includes a phosphor plate mounted to the heatsink, wherein the phosphor plate outputs emissive light having wavelengths longer than the laser light, wherein the first reflector is a parabolic reflector that faces the second reflector and collimates light from the diffuser toward the second reflector and third reflector, and that receives reflected collimated light from the second reflector and focuses that light toward the diffuser, wherein the second reflector reflects collimated light from the first reflector toward an opposite inside surface of the second reflector that then reflects the light toward the first reflector, and wherein the first reflector also faces the third reflector and collimates light from the diffuser toward the third reflector that is located and configured to reflect and focus collimated light from the first reflector back toward the output aperture in the first reflector.

In some embodiments of the first apparatus (such as shown, for example, in FIGS. 1A-1G, 2A-2D), the diffuser includes a phosphor that outputs emissive light having wavelengths longer than the laser light.

Some embodiments of the first apparatus (such as shown, for example, in FIGS. 1A-1G, 2A-2D) further include: a heatsink; wherein the diffuser includes a phosphor plate mounted on the heatsink, wherein the phosphor plate outputs emissive light having wavelengths longer than the laser light.

Some embodiments of the first apparatus (such as shown, for example, in FIGS. 1A-1G, 2A-2D) further include: a heatsink; and a plurality of lasers mounted to the heatsink, wherein each of the plurality of lasers emit laser light of one or more first wavelengths, wherein the diffuser includes a phosphor plate mounted to the heatsink, wherein the phosphor plate outputs emissive light having wavelengths longer than the laser light, and wherein the first reflector is a parabolic reflector that faces the diffuser and that reflects laser light from the plurality of lasers toward the diffuser.

Some embodiments of the first apparatus (such as shown, for example, in FIGS. 1A-1G, 2A-2D) further include: a heatsink; and a plurality of lasers mounted to the heatsink, wherein each of the plurality of lasers emit laser light of one or more first wavelengths; and a second reflector that has a flat face facing the first reflector, wherein the diffuser includes a phosphor plate mounted to the heatsink, wherein the phosphor plate outputs emissive light having wavelengths longer than the laser light, and wherein the first reflector is a parabolic reflector that faces the diffuser, that reflects laser light from the plurality of lasers toward the diffuser, that collimates light from the phosphor plate toward the second reflector, and that focuses collimated light reflected from the second reflector toward the phosphor plate.

Some embodiments of the first apparatus (such as shown, for example, in FIG. 1A) further include: a heatsink; a plurality of lasers mounted to the heatsink, wherein each of the plurality of lasers emit laser light of one or more first wavelengths; and a second reflector that has a flat face facing the first reflector and that is mounted on the heatsink, wherein the diffuser includes a phosphor plate mounted to the heatsink, wherein the phosphor plate outputs emissive light having wavelengths longer than the laser light, and wherein the first reflector is a parabolic reflector that faces the diffuser, that reflects laser light from the plurality of lasers toward the diffuser, that collimates light from the phosphor plate toward the second reflector, and that focuses collimated light reflected from the second reflector toward the phosphor plate.

Some embodiments of the first apparatus (such as shown, for example, in FIG. 1A) further include: a heatsink; a plurality of lasers mounted to the heatsink, wherein each of the plurality of lasers emit laser light of one or more first wavelengths; a second reflector that has a flat face facing the first reflector; and a third reflector that has a concave parabolic reflective face, wherein the diffuser includes a phosphor plate mounted to the heatsink, wherein the phosphor plate outputs emissive light having wavelengths longer than the laser light, wherein the first reflector is a parabolic reflector that faces the second reflector and collimates light from the diffuser toward the second reflector and third reflector, and that receives reflected collimated light from the second reflector and focuses that light toward the diffuser, and wherein the first reflector also faces the third reflector and collimates light from the diffuser toward the third reflector that is located and configured to reflect and focus collimated light from the first reflector back toward an aperture in the first reflector.

Some embodiments of the first apparatus (such as shown, for example, in FIGS. 7A, 7B, 17) further include: a vehicle, wherein the light source is mounted to the vehicle and provides headlight illumination for the vehicle.

Some embodiments of the first apparatus (such as shown, for example, in FIGS. 7A, 7B) further include: an entertainment system, wherein the light source is mounted to the entertainment system and provides illumination for the entertainment system.

In some embodiments, the present invention provides a second apparatus (such as shown, for example, in FIG. 11A, 11B, or 11C) that includes: a diffuser having a first face and a second face opposite the first face, wherein the diffuser is arranged to receive and diffuse laser light at a first location on the first face of the diffuser; a first reflector that has a flat face located facing the first face of the diffuser; and a second reflector that has a curved concave face located facing the first reflector, wherein the first and second reflector together are configured to reflect at least some of the diffused laser light back toward the first location in order to increase a brightness of the diffused laser light. Some embodiments of the second apparatus further include: a heatsink thermally coupled to the diffuser and configured to spread and dissipate heat from the laser light at the first location. In some embodiments, the second reflector is a parabolic reflector. In some embodiments, wherein the second reflector is a spherical reflector.

In some embodiments, the present invention provides a third apparatus (such as shown, for example, in FIG. 12A, 12C, 12D, 12E, or 12F) that includes: a first laser that emits laser light; a first phosphor plate having a first face and a second face opposite the first face, wherein the first phosphor plate is arranged to receive the laser light from the first laser and to emit wavelength-converted emissive light from the first face of the first phosphor plate; a first reflector that has a specular reflective surface; and a second reflector that has a curved concave face located facing the first face of the phosphor plate and configured to reflect at least some of the emissive light back toward the first reflector, wherein the first reflector is located proximal to the first phosphor plate and on an opposite side of a central axis of the second reflector relative to the first phosphor plate and wherein light reflected from the first reflector is collected by the second reflector and focused back toward the first phosphor plate in order to increase a brightness of the emissive light.

Some embodiments of the third apparatus further include a heatsink thermally coupled to the phosphor plate and the first reflector and configured to spread and dissipate heat from the phosphor plate. Some embodiments of the third apparatus (such as shown, for example, in FIG. 12C or 12D) further include a heatsink thermally coupled to the phosphor plate and the first reflector and configured to spread and dissipate heat from the laser light at the first location, wherein the first phosphor plate is a reflective plate and the laser impinges on the first face of the phosphor plate. Some embodiments of the third apparatus (such as shown, for example, in FIG. 12E) further include a heatsink thermally coupled to the diffuser and the first reflector and configured to spread and dissipate heat from the laser light at the first location, wherein the first phosphor plate is a transmissive plate and the laser impinges on the second face of the first phosphor plate. Some embodiments of the third apparatus (such as shown, for example, in FIG. 12F) further include: a second laser that emits laser light; a second phosphor plate having a first face and a second face opposite the first face, wherein the second phosphor plate is arranged to receive the laser light from the second laser and to emit wavelength-converted emissive light from the first face of the second phosphor plate; and a third reflector that has a specular reflective surface, wherein the third reflector is located proximal to the second phosphor plate and on an opposite side of the central axis of the second reflector relative to the second phosphor plate.

In some embodiments, the present invention provides a fourth apparatus (such as shown, for example, in FIG. 13A, 13B, 13C, 14A, 14B, 14C, 15A, or 15B) that includes: a first LED that emits a first color of LED light; a first reflector that has a specular reflective surface; and a second reflector that has a curved concave face located facing the first face of the diffuser and configured to reflect at least some of the LED light back toward the first reflector, wherein the first reflector is located proximal to the first LED and on an opposite side of a central axis of the second reflector and wherein light reflected from the first reflector is collected by the second reflector and focused back toward the first location on the first LED in order to increase a brightness of the diffused laser light.

Some embodiments of the fourth apparatus (such as shown, for example, in FIG. 13A) further include a heatsink thermally coupled to the first LED and the first reflector and configured to spread and dissipate heat from the first LED at the first location.

Some embodiments of the fourth apparatus (such as shown, for example, in FIG. 14A) further include: a second LED that emits a second color of LED light; and a third reflector that has a specular reflective surface, wherein the third reflector is located proximal to the second LED and on an opposite side of the central axis of the second reflector relative to the second LED.

Some embodiments of the fourth apparatus (such as shown, for example, in FIG. 14A or 14C) further include: a second LED that emits a second color of LED light; and a third reflector that has a specular reflective surface, wherein the third reflector is located proximal to the second LED and on an opposite side of the central axis of the second reflector relative to the second LED; a third LED that emits a third color of LED light; and a fourth reflector that has a specular reflective surface, wherein the fourth reflector is located proximal to the third LED and on an opposite side of the central axis of the second reflector relative to the third LED.

Some embodiments of the fourth apparatus (such as shown, for example, in FIG. 14A) further include: a second LED that emits a second color of LED light; a third LED that emits a third color of LED light, wherein the first reflector is located proximal to the first, second and third LEDs and on an opposite side of the central axis of the second reflector relative to the first, second and third LEDs.

Some embodiments of the fourth apparatus (such as shown, for example, in FIG. 14C) further include: a second LED that emits a second color of LED light; a third reflector that has a specular reflective surface, wherein the third reflector is located proximal to the second LED and on an opposite side of the central axis of the second reflector relative to the second LED; a third LED that emits a third color of LED light; and a fourth reflector that has a specular reflective surface, wherein the fourth reflector is located proximal to the third LED and on an opposite side of the central axis of the second reflector relative to the third LED, and wherein the first reflector is located between the second LED and the third LED, and the first LED is located between the third reflector and the fourth reflector.

Some embodiments of the fourth apparatus (such as shown, for example, in FIG. 15A or 15B) further include: a second LED that emits a second color of LED light; a third LED that emits a third color of LED light, wherein the first reflector is located proximal to the first, second and third LEDs and on an opposite side of the central axis of the second reflector relative to the first, second and third LEDs; and an X-cube beam combiner and a plurality of reflective surfaces, wherein light from the first, second and third LEDs is reflected by the plurality of reflective surfaces into the X-cube beam combiner which then outputs a combined beam containing light from the first, second and third LEDs.

Some embodiments of the fourth apparatus (such as shown, for example, in FIG. 15A or 15B) further include: a second LED that emits a second color of LED light; a third LED that emits a third color of LED light, wherein the first reflector is located proximal to the first, second and third LEDs and on an opposite side of the central axis of the second reflector relative to the first, second and third LEDs; and an X-cube beam combiner and a plurality of reflective surfaces, wherein light from the first, second and third LEDs is reflected by the plurality of reflective surfaces into the X-cube beam combiner which then outputs a combined beam containing light from the first, second and third LEDs, and wherein path lengths from each of the first, second and third LEDs to the X-cube beam combiner are equal to one another.

In some embodiments, the present invention provides a fifth apparatus (such as shown, for example, in FIG. 16A or 16B) that includes: a first pump-light emitter that emits pump light; a first phosphor plate having a first face and a second face opposite the first face, wherein the first phosphor plate is arranged to receive the pump light from the first pump-light emitter and to emit wavelength-converted emissive light from the first face of the first phosphor plate; a first reflector that has a specular reflective surface; and a second reflector that has a curved concave face located facing the first face of the phosphor plate and configured to reflect at least some of the emissive light back toward the first reflector, wherein the first reflector is located proximal to the first phosphor plate and on an opposite side of a central axis of the second reflector relative to the first phosphor plate and wherein light reflected from the first reflector is collected by the second reflector and focused back toward the first location on the first phosphor plate in order to increase a brightness of the emissive light. Some embodiments of the fifth apparatus further include: a heatsink thermally coupled to the phosphor plate and the first reflector and configured to spread and dissipate heat from the phosphor plate. In some embodiments of the fifth apparatus (such as shown, for example, in FIG. 16A), the first pump-light emitter includes an LED. In some embodiments of the fifth apparatus (such as shown, for example, in FIG. 16B), the first pump-light emitter includes a laser. In some embodiments, the curved concave face of the second reflector is parabolic. In some embodiments, the specular reflective surface of the first reflector is planar.

In some embodiments, the present invention provides a sixth apparatus (such as shown, for example, in FIGS. 1A-1G, 2A-2D) that includes: a light source having a heatsink; a phosphor plate mounted on the heatsink; a plurality of lasers, wherein each of the plurality of lasers emit laser light of one or more first wavelengths; and a first parabolic reflector arranged to reflect the light from the plurality of lasers toward the phosphor plate to excite a phosphor in the phosphor plate to convert laser light of the one or more first wavelengths into emissive light of one or more second wavelengths that are longer than the one or more first wavelengths. In some embodiments, the phosphor plate is placed proximally to a focus of the first parabolic reflector. In some embodiments, each of the plurality of lasers is mounted to a respective opening in the heatsink, and wherein each of the plurality of lasers emits its laser light through a respective opening in the heatsink toward the first parabolic reflector.

Some embodiments of the sixth apparatus (such as shown, for example, in FIG. 1A or 1G) further include: a planar reflector facing the first parabolic reflector, wherein the first parabolic reflector further includes an aperture opposite the phosphor plate, wherein the excited phosphor emits emissive light in many directions toward the first parabolic reflector, wherein a lower-angle portion of the emissive light from the phosphor plate exits through the aperture, contributing to output light of the light source, wherein a higher-angle portion of the emissive light from the phosphor plate and any unconverted laser light is collected by the first parabolic reflector and collimated back towards the planar reflector, and wherein the planar reflector reflects light from the first parabolic reflector back to the first parabolic reflector to be focused back to the phosphor plate by the first parabolic reflector, completing a light-recycling process.

Some embodiments of the sixth apparatus (such as shown, for example, in FIG. 1A or 1G) further include: a planar reflector facing the first parabolic reflector and mounted to the heatsink, wherein the first parabolic reflector further includes an aperture opposite the phosphor plate, wherein the excited phosphor emits emissive light in many directions toward the first parabolic reflector, wherein a lower-angle portion of the emissive light from the phosphor plate exits through the aperture, contributing to output light of the light source, wherein a higher-angle portion of the emissive light from the phosphor plate and any unconverted laser light is collected by the first parabolic reflector and collimated back towards the planar reflector; and wherein the planar reflector reflects light from the first parabolic reflector back to the first parabolic reflector to be focused back to the phosphor plate by the first parabolic reflector, completing a light-recycling process.

Some embodiments of the sixth apparatus (such as shown, for example, in FIG. 1F) further include: a wavelength-selective planar reflector facing the first parabolic reflector, wherein each of the plurality of lasers is mounted to a respective opening in the heatsink, wherein each of the plurality of lasers emits their laser light through a respective opening in the heatsink toward the first parabolic reflector, wherein the wavelength-selective planar reflector covers the respective openings in the heatsink and is configured to transmit the laser light of one or more first wavelengths and to reflect other wavelengths of light, wherein the first parabolic reflector further includes an aperture opposite the phosphor plate, wherein the excited phosphor emits emissive light in many directions toward the first parabolic reflector, wherein a lower-angle portion of the emissive light from the phosphor plate exits through the aperture, contributing to output light of the light source, wherein a higher-angle portion of the emissive light from the phosphor plate and any unconverted laser light is collected by the first parabolic reflector and collimated back towards the planar reflector, and wherein the planar reflector reflects light from the first parabolic reflector back to the first parabolic reflector to be focused back to the phosphor plate by the first parabolic reflector, completing a light-recycling process.

Some embodiments of the sixth apparatus (such as shown, for example, in FIG. 1G) further include: a planar reflector facing the first parabolic reflector; a second parabolic reflector having a reflective surface that at least partially surrounds the phosphor plate, wherein the first parabolic reflector further includes an aperture opposite the phosphor plate, wherein the excited phosphor emits emissive light in many directions toward the first parabolic reflector, wherein a lower-angle portion of the emissive light from the phosphor plate exits through the aperture, contributing to output light of the light source, wherein the second parabolic reflector and the first parabolic reflector together form an image of the phosphor plate at the aperture in the first parabolic reflector, wherein a higher-angle portion of the emissive light from the phosphor plate and any unconverted laser light is collected by the first parabolic reflector and collimated back towards the planar reflector, and wherein the light from the first parabolic reflector is then reflected by the planar reflector back to the first parabolic reflector and focused back to the phosphor plate by the first parabolic reflector, completing a light-recycling process.

Some embodiments of the sixth apparatus (such as shown, for example, in FIG. 1G) further include: a planar reflector facing the first parabolic reflector; an optical waveguide having an light-entry face proximal to an aperture in the first parabolic reflector that is opposite the phosphor plate; and a second parabolic reflector having a reflective surface that at least partially surrounds the phosphor plate, wherein the excited phosphor emits emissive light in many directions toward the first parabolic reflector, wherein a lower-angle portion of the emissive light from the phosphor plate exits through the aperture, contributing to output light of the light source, wherein the second parabolic reflector and the first parabolic reflector together form an image of the phosphor plate at the aperture in the first parabolic reflector, wherein a higher-angle portion of the emissive light from the phosphor plate and any unconverted laser light is collected by the first parabolic reflector and collimated back towards the planar reflector, and wherein the light from the first parabolic reflector is then reflected by the planar reflector back to the first parabolic reflector and focused back to the phosphor plate by the first parabolic reflector, completing a light-recycling process.

In some embodiments, the present invention provides a seventh apparatus (such as shown, for example, in FIGS. 1A-1G, 2A-2D) that includes: a heatsink; a plurality of lasers, each mounted to a respective opening in the heatsink, wherein each of the plurality of lasers emit laser light of one or more first wavelengths through their respective opening in the heatsink; a reflective phosphor plate mounted on a surface of the heatsink; a parabolic reflector arranged to reflect the light from the plurality of lasers toward the phosphor plate mounted on the heatsink. In some embodiments, the phosphor plate is placed proximally to a focus of the parabolic reflector. In some embodiments, the phosphor plate converts the laser light of one or more first wavelengths to a set of one or more second wavelengths that are longer than the one or more first wavelengths. In some embodiments, the parabolic reflector further includes an aperture opposite the phosphor, the heatsink further includes a planar reflector facing the parabolic reflector, the excited phosphor emits light in many directions toward the parabolic reflector, lower-angle light exits through the aperture, contributing to output of the light source, a high-angle portion of the light from the phosphor and any unconverted laser light is collected by the parabolic reflector and collimated back towards the planar reflector, and the light from the parabolic reflector is then reflected by the planar reflector back to the parabolic reflector and focused back to the phosphor plate by the parabolic reflector, completing a light-recycling process.

In some embodiments, the present invention provides an eighth apparatus (such as shown, for example, in FIGS. 4A-4D, 5A-5F, 6A-6C) that includes: a diffuser arranged to receive and diffuse laser light at a first location on the diffuser; and a first curved reflector located and configured to reflect at least some of the diffused laser back toward the first location in order to preserve a brightness of the diffused laser light. Some embodiments further include a heatsink thermally connected to the diffuser and configured to spread and dissipate heat from the laser light. In some embodiments of the eighth apparatus (such as shown, for example, in FIGS. 4A-4D), the diffuser is a transmissive diffuser. In some embodiments of the eighth apparatus (such as shown, for example, in FIGS. 5A-5F, 6A-6C), the diffuser is a reflective diffuser. In some embodiments of the eighth apparatus (such as shown, for example, in FIGS. 6A-6C), the first curved reflector is a parabolic reflector. Some embodiments of the eighth apparatus further include a vibration actuator operatively coupled to vibrate the diffuser. In some such embodiments, the vibration actuator is operatively coupled to vibrate the first curved reflector.

Some embodiments of the eighth apparatus further include: a vibration actuator operatively coupled to vibrate the diffuser; a plurality of lasers, wherein laser beams from the plurality of lasers are directed toward the first location; a projector system configured to receive light from the diffuser and to project the light in an output pattern toward a desired location; and a controller operatively coupled to control the plurality of lasers. Some embodiments of the eighth apparatus further include: a vibration actuator operatively coupled to vibrate at least one of the diffuser and the first curved reflector; a plurality of lasers, wherein laser beams from the plurality of lasers are directed toward the first location, a projector system configured to receive light from the diffuser and to project the light in an output pattern toward a desired location; a controller operatively coupled to control the plurality of lasers; and a vehicle, wherein the diffuser, the first curved reflector, the plurality of lasers, and the projector system are mounted on the vehicle to provide a functional light output useful for an operation of the vehicle.

In some embodiments, the present invention provides a ninth apparatus (such as shown, for example, in FIGS. 4A-4D, 5A-5F, 6A-6C) that includes: a first light-diffuser structure; a first laser that generates a first laser beam having a first wavelength, wherein the first laser beam is directed toward the first light-diffuser structure; and a light-recycling reflector assembly, wherein the light-recycling reflector assembly includes an exit aperture through which output light from the light-diffuser structure is emitted, and wherein light-recycling reflector assembly reflects, back toward the first light-diffuser structure, at least some light from the first light-diffuser structure that does not exit through the exit aperture.

Some embodiments of the ninth apparatus further include: a vibration actuator operatively coupled to impart a vibration to at least one of the first light-diffuser structure, the first laser and the light-recycling reflector assembly. Some embodiments of the ninth apparatus further include: a linear-motion actuator operatively coupled to impart a linear motion to at least one of the first light-diffuser structure, the first laser and the light-recycling reflector assembly. Some embodiments of the ninth apparatus further include: a curvilinear-motion actuator operatively coupled to impart a curvilinear motion to at least one of the first light-diffuser structure, the first laser and the light-recycling reflector assembly. Some embodiments of the ninth apparatus further include: a rotary-motion actuator operatively coupled to impart a rotary motion to at least one of the first light-diffuser structure, the first laser and the light-recycling reflector assembly.

Some embodiments of the ninth apparatus further include: a heatsink thermally coupled to at least one of the first light-diffuser structure, the first laser and the light-recycling reflector assembly. Some embodiments of the ninth apparatus further include: a second light-diffuser structure; and a second laser that generates a second laser beam having a second wavelength that is different than the first wavelength, wherein the second laser beam is directed toward the second light-diffuser structure. Some embodiments of the ninth apparatus further include: a second laser that generates a second laser beam having a second wavelength that is different than the first wavelength, wherein the second laser beam is directed toward the first light-diffuser structure. Some embodiments of the ninth apparatus further include: a second laser that generates a second laser beam having the first wavelength, wherein the second laser beam is directed toward the first light-diffuser structure.

In some embodiments of the ninth apparatus, the first light-diffuser structure includes a ceramic light diffuser. In some embodiments of the ninth apparatus, the first light-diffuser structure includes a plurality of spaced-apart light-diffusing layers.

In some embodiments of the ninth apparatus, the first light-diffuser structure includes an LED assembly that includes a phosphor wavelength-conversion layer. In some embodiments of the ninth apparatus, the first light-diffuser structure includes a transmissive phosphor plate. In some embodiments of the ninth apparatus, the first light-diffuser structure includes a reflective phosphor plate.

In some embodiments of the ninth apparatus, the light-recycling reflector assembly includes a flat reflector, and a first parabolic reflector facing the flat reflector.

In some embodiments of the ninth apparatus, the light-recycling reflector assembly includes a flat reflector, a first parabolic reflector facing the flat reflector, and a second parabolic reflector facing the first parabolic reflector.

In some embodiments of the ninth apparatus, the light-recycling reflector assembly includes a conical reflector, and a first parabolic reflector facing the conical reflector. In some embodiments of the ninth apparatus, the light-recycling reflector assembly includes a conical reflector, a first parabolic reflector facing the conical reflector, and a second parabolic reflector facing the first parabolic reflector.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1.-3. (canceled)

4. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light; and
a second reflector has a curved concave face located facing the second face and configured to reflect at least some of the diffused laser light back toward the first location, wherein the diffuser is a transmissive diffuser that outputs diffused light from the second face of the transmissive diffuser, and wherein the curved concave face of the first reflector faces and is closer to the first face than the second face of the diffuser.

5.-6. (canceled)

7. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light; and
a second reflector that is curved and located facing the second face and configured to reflect at least some of the diffused laser light back toward the first location, wherein the diffuser is a transmissive diffuser that outputs diffused light from the second face of the transmissive diffuser, wherein the first reflector includes a spherical dome reflector that faces and is closer to the first face than the second face of the diffuser, and wherein the second reflector includes a spherical dome reflector that faces and is closer to the second face than the first face of the diffuser.

8. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light; and
a second reflector that is curved and located facing the second face and configured to reflect at least some of the diffused laser light back toward the first location, wherein the diffuser is a transmissive diffuser that outputs diffused light from the second face of the transmissive diffuser, wherein the first reflector includes an orthogonal-parabolic light-recycling reflector that faces and is closer to the first face than the second face of the diffuser, and wherein the second reflector includes an orthogonal-parabolic light-recycling reflector that faces and is closer to the second face than the first face of the diffuser.

9. (canceled)

10. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
at least a first laser that emits the laser light; and
a second reflector located and configured to reflect the laser light from the first laser toward the first location, wherein the diffuser is a reflective diffuser that outputs diffused light from the first face of the transmissive diffuser, and wherein the first reflector faces and is closer to the first face than the second face of the diffuser.

11.-12. (canceled)

13. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
at least a first laser that emits the laser light; and
a second reflector that has a flat face located and configured to reflect light from the first reflector back toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

14. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
at least a first laser that emits at least a portion of the laser light; and
a second reflector that has a flat face located and configured to reflect light from the first reflector hack toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

15. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector; and
a second reflector that has a flat face located and configured to reflect light from the first reflector back toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

16. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector;
a second reflector that has a flat face located and configured to reflect light from the first reflector back toward the first reflector; and
a third reflector that has a concave parabolic reflective face; wherein the diffuser is a reflective diffuser that outputs diffused light from the first face of the diffuser, wherein the first reflector is a parabolic reflector that faces the second reflector and collimates light from the diffuser toward the second reflector and third reflector, and that receives reflected collimated light from the second reflector and focuses that light toward the diffuser, and wherein the first reflector also faces the third reflector and collimates light from the diffuser toward the third reflector that is located and configured to reflect and focus collimated light from the first reflector back toward an aperture in the first reflector.

17. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector; and
a second reflector that has an inside conical reflective face located and configured to reflect light from the first reflector hack toward the inside conical reflective face and then toward the first reflector, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

18. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector;
a second reflector that has an inside conical reflective face located and configured to reflect light from the first reflector back toward the inside conical reflective face and then toward the first reflector;
a collimating optical element located to receive light from an aperture in the first reflector and configured to collimate that light into a collimated intermediate beam; and
a third reflector that rotates about at least one rotational axis and that is configured to reflect the collimated intermediate beam to form a scanned output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

19. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a scanning laser that outputs a scanning laser beam toward the diffuser;
a second reflector that has an inside conical reflective face located and configured to reflect light from the first reflector back toward the inside conical reflective face and then toward the first reflector; and
collimation optics located to receive light from an aperture in the first reflector and configured to collimate that light into a collimated intermediate output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

20. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a scanning laser that outputs a scanning laser beam toward the diffuser; and
collimation optics located to receive light from an aperture in the first reflector, wherein the first reflector has an inside orthogonal-parabolic reflective face located and configured to reflect light from the diffuser across toward an opposite surface of the inside orthogonal-parabolic reflective face and then toward the diffuser, wherein the diffuser is a reflective diffuser that outputs diffused light from the first face of the diffuser, and wherein the collimation optics are configured to collimate light from the aperture in the first reflector into a scanned output beam.

21. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a laser that outputs the laser light toward the diffuser;
collimation optics located to receive light from an aperture in the first reflector and configured to form a collimated intermediate beam; and
a second reflector that rotates about at least one rotational axis and that is configured to reflect the collimated intermediate beam to form a scanned output beam, wherein the first reflector has an inside orthogonal-parabolic reflective face located and configured to reflect light from the diffuser across toward an opposite surface of the inside orthogonal-parabolic reflective face and then toward the diffuser, wherein the diffuser is a reflective diffuser that outputs diffused light from the first face of the diffuser, and wherein the collimation optics are configured to collimate light from the aperture in the first reflector into a scanned output beam.

22. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector;
a second reflector that has a flat face located and configured to reflect light from the first reflector back toward the first reflector;
collimation optics located to receive light passing through an aperture in the first reflector and configured to form a collimated intermediate beam; and
a third reflector that rotates about at least one rotational axis and that is configured to reflect the collimated intermediate beam to form a scanned output beam, wherein the diffuser is a reflective diffuser that outputs diffused light from the first face of the diffuser, and wherein the first reflector is a parabolic reflector that faces the second reflector and collimates light from the diffuser toward the second reflector and that receives reflected collimated light from the second reflector and focuses that light toward the diffuser.

23. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
collimation optics located to receive light passing through an aperture in the first reflector and configured to form a collimated intermediate beam;
a second reflector that rotates about at least one rotational axis and that is configured to reflect the collimated intermediate beam to form a scanned output beam; and
a laser that outputs the laser light, wherein the diffuser is a reflective diffuser that includes a phosphor and outputs emissive light from the phosphor from the first face of the reflective diffuser, and wherein the first reflector includes a spherical dome reflector that faces and is closer to the first face than the second face of the diffuser.

24. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector;
a second reflector that has an inside conical reflective face located and configured to reflect light from the first reflector back toward the inside conical reflective face and then toward the first reflector; and
a third reflector that has a concave parabolic reflective face, wherein the diffuser includes a phosphor plate mounted to the heatsink, wherein the phosphor plate outputs emissive light having wavelengths longer than the laser light, wherein the first reflector is a parabolic reflector that faces the second reflector and collimates light from the diffuser toward the second reflector and third reflector, and that receives reflected collimated light from the second reflector and focuses that light toward the diffuser, wherein the second reflector reflects collimated light from the first reflector toward an opposite inside surface of the second reflector that then reflects the light toward the first reflector, and wherein the first reflector also faces the third reflector and collimates light from the diffuser toward the third reflector that is located and configured to reflect and focus collimated light from the first reflector back toward an aperture in the first reflector.

25. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each one of plurality of lasers emits a portion of the laser light toward the first reflector;
a second reflector that has an inside conical reflective face located and configured to reflect light from the first reflector back toward the inside conical reflective face and then toward the first reflector;
a third reflector that has a concave parabolic reflective face; and
a light guide operatively coupled to receive output light passed out through an output aperture in the first reflector, wherein the diffuser includes a phosphor plate mounted to the heatsink, wherein the phosphor plate outputs emissive light having wavelengths longer than the laser light, and wherein the first reflector is a parabolic reflector that faces the second reflector and collimates light from the diffuser toward the second reflector and third reflector, and that receives reflected collimated light from the second reflector and focuses that light toward the diffuser, wherein the second reflector reflects collimated light from the first reflector toward an opposite inside surface of the second reflector that then reflects the light toward the first reflector, and wherein the first reflector also faces the third reflector and collimates light from the diffuser toward the third reflector that is located and configured to reflect and focus collimated light from the first reflector back toward the output aperture in the first reflector.

26.-28. (canceled)

29. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each of the plurality of lasers emit laser light of one or more first wavelengths; and
a second reflector that has a flat face facing the first reflector, wherein the diffuser includes a phosphor plate mounted to the heatsink, wherein the phosphor plate outputs emissive light having wavelengths longer than the laser light, and wherein the first reflector is a parabolic reflector that faces the diffuser, that reflects laser light from the plurality of lasers toward the diffuser, that collimates light from the phosphor plate toward the second reflector, and that focuses collimated light reflected from the second reflector toward the phosphor plate.

30. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each of the plurality of lasers emit laser light of one or more first wavelengths; and
a second reflector that has a flat face facing the first reflector and that is mounted on the heatsink, wherein the diffuser includes a phosphor plate mounted to the heatsink, wherein the phosphor plate outputs emissive light having wavelengths longer than the laser light, and wherein the first reflector is a parabolic reflector that faces the diffuser, that reflects laser light from the plurality of lasers toward the diffuser, that collimates light from the phosphor plate toward the second reflector, and that focuses collimated light reflected from the second reflector toward the phosphor plate.

31. An apparatus comprising:
a light source that includes:
a diffuser having a first face and a second face opposite the first face, wherein the diffuser is arranged to receive and diffuse laser light at a first location on the first face of the diffuser, and
a first reflector that has a curved concave face located facing the first face of the diffuser and configured to reflect at least some of the diffused laser light back toward the first location in order to increase a brightness of the diffused laser light;
a heatsink;
a plurality of lasers mounted to the heatsink, wherein each of the plurality of lasers emit laser light of one or more first wavelengths;
a second reflector that has a flat face facing the first reflector; and
a third reflector that has a concave parabolic reflective face, wherein the diffuser includes a phosphor plate mounted to the heatsink, wherein the phosphor plate outputs emissive light having wavelengths longer than the laser light, wherein the first reflector is a parabolic reflector that faces the second reflector and collimates light from the diffuser toward the second reflector and third reflector, and that receives reflected collimated light from the second reflector and focuses that light toward the diffuser, and wherein the first reflector also faces the third reflector and collimates light from the diffuser toward the third reflector that is located and configured to reflect and focus collimated light from the first reflector back toward an aperture in the first reflector.

32. The apparatus of claim 4, further comprising:
a vehicle, wherein the light source is mounted to the vehicle and provides headlight illumination for the vehicle.

33. The apparatus of claim 4, further comprising:
an entertainment system, wherein the light source is mounted to the entertainment system and provides illumination for the entertainment system.

34. An apparatus comprising:
a diffuser having a first face and a second face opposite the first face, wherein the diffuser is arranged to receive and diffuse laser light at a first location on the first face of the diffuser;
a first reflector that has a flat face located facing the first face of the diffuser; and
a second reflector that has a curved concave face located facing the first reflector, wherein the first and second reflector together are configured to reflect at least some of the diffused laser light back toward the first location in order to increase a brightness of the diffused laser light.

35. The apparatus of claim 34, further comprising:
a heatsink thermally coupled to the diffuser and configured to spread and dissipate heat from the laser light at the first location.

36. The apparatus of claim 34, wherein the second reflector is a parabolic reflector.

37. The apparatus of claim 34, wherein the second reflector is a spherical reflector.

38.-86. (canceled)

87. An apparatus comprising:
a first light-diffuser structure;
a first laser that generates a first laser beam having a first wavelength, wherein the first laser beam is directed toward the first light-diffuser structure;
a light-recycling reflector assembly, wherein the light-recycling reflector assembly includes an exit aperture through which output light from the light-diffuser structure is emitted, and wherein light-recycling reflector assembly reflects, back toward the first light-diffuser structure, at least some light from the first light-diffuser structure that does not exit through the exit aperture;
a second light-diffuser structure; and
a second laser that generates a second laser beam having a second wavelength that is different than the first wavelength, wherein the second laser beam is directed toward the second light-diffuser structure.

88.-95. (canceled)

96. An apparatus comprising:
a first light-diffuser structure;
a first laser that generates a first laser beam having a first wavelength, wherein the first laser beam is directed toward the first light-diffuser structure; and
a light-recycling reflector assembly, wherein the light-recycling reflector assembly includes an exit aperture through which output light from the light-diffuser structure is emitted, and wherein light-recycling reflector assembly reflects, back toward the first light-diffuser structure, at least some light from the first light-diffuser structure that does not exit through the exit aperture, wherein the light-recycling reflector assembly includes a flat reflector, a first parabolic reflector facing the flat reflector, and a second parabolic reflector facing the first parabolic reflector.

97. (canceled)

98. An apparatus comprising:
a first light-diffuser structure;
a first laser that generates a first laser beam having a first wavelength, wherein the first laser beam is directed toward the first light-diffuser structure; and
a light-recycling reflector assembly, wherein the light-recycling reflector assembly includes an exit aperture through which output light from the light-diffuser structure is emitted, and wherein light-recycling reflector assembly reflects, back toward the first light-diffuser structure, at least some light from the first light-diffuser structure that does not exit through the exit aperture, wherein the light-recycling reflector assembly includes a conical reflector, a first parabolic reflector facing the conical reflector, and a second parabolic reflector facing the first parabolic reflector.
